(19) United States
(12) Patent Application Publication
(10) Pub. No.: US 2025/0303938 A1
(43) Pub. Date: Oct. 2, 2025

(54) VEHICLE SEAT AIR-CONDITIONING DEVICE

(71) Applicant: Panasonic Automotive Systems Co., Ltd., Kanagawa (JP)

(72) Inventors: Tatehiko INOUE, Osaka (JP); Yuki MAKITA, Kanagawa (JP); Atsushi SUEYOSHI, Kanagawa (JP)

(21) Appl. No.: 19/091,481

(22) Filed: Mar. 26, 2025

(30) Foreign Application Priority Data
Mar. 29, 2024 (JP) 2024-057157
Mar. 29, 2024 (JP) 2024-057159
Mar. 29, 2024 (JP) 2024-057355

(51) Int. Cl. B60N 2/56; F24F 7/08; F24F 110/10

(52) U.S. Cl. CPC B60N 2/5635; B60N 2/565; B60N 2/5657; F24F 7/08; F24F 2110/10

(57) ABSTRACT

A vehicle seat air-conditioning device includes: a blower; a first ventilation path to be connected to a first vent hole provided in a front surface of a seat backrest; a second ventilation path to be connected to a second vent hole provided in a front surface of a seat facing a person seated in the seat; and a ventilation path switch that selects, from among the first and second ventilation paths, a ventilation path through which air led by the blower is drawn in and a ventilation path through which air is blown out. The ventilation path switch has: a first mode in which air drawn in by the blower from the first vent hole is led to the first ventilation path; and a second mode in which air drawn in by the blower from the second vent hole is led to the second ventilation path, and when a mode is selected between the first and second modes, the ventilation path switch performs switching to the mode selected.

### CROSS REFERENCE TO RELATED APPLICATION

The present application is based on and claims priority of Japanese Patent Application No. 2024-057157 filed on Mar. 29, 2024, Japanese Patent Application No. 2024-057159 filed on Mar. 29, 2024, and Japanese Patent Application No. 2024-057355 filed on Mar. 29, 2024. The entire disclosures of the above-identified applications, including the specification, drawings, and claims are incorporated herein by reference in their entirety.

### FIELD

The present disclosure relates to a vehicle seat air-conditioning device that blows air to a person seated in a seat.

### BACKGROUND

Recently, a seat air-conditioning device that blows out conditioned air from a seat to an occupant has been known. A seat air-conditioning device according to conventional technology can improve comfortability by blowing air differently in a transition stage that is an initial cooling stage and in a stable stage in which an indoor temperature is close to a target temperature.

For example, a vehicle seat air-conditioning device according to Patent Literature (PTL) 1 blows air onto the neck and blows air onto the back of an occupant by a control device controlling a first on-off valve, a second on-off valve, and a third on-off valve.

### CITATION LIST

### Patent Literature

PTL 1: Japanese Unexamined Patent Application Publication No. 2020-199990

### SUMMARY

The above vehicle seat air-conditioning device according to PTL 1 stated above is susceptible of further improvement.

In view of this, the present disclosure can achieve further improvement.

A vehicle seat air-conditioning device according to an aspect of the present disclosure is a vehicle seat air-conditioning device that is to be disposed in a vehicle, for use in a seat that includes a seat backrest and a seating portion, the vehicle seat air-conditioning device including: a blower; a first ventilation path to be connected to a first vent hole provided in a front surface of the seat backrest that faces a person seated in the seat; a second ventilation path to be connected to a second vent hole provided in a front surface of the seat that faces a person seated in the seat, the second ventilation path being different from the first ventilation path; and a ventilation path switch that selects, from among the first ventilation path and the second ventilation path, a ventilation path through which air led by the blower is drawn in and a ventilation path through which air is blown out. The ventilation path switch has: a first mode in which air drawn in by the blower from the first vent hole is led to the first ventilation path; and a second mode in which air drawn in by the blower from the second vent hole is led to the second ventilation path, and when a mode is selected between the first mode and the second mode, the ventilation path switch performs switching to the mode selected.

The vehicle seat air-conditioning device according to the present disclosure can achieve further improvement.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1A is a perspective view illustrating an appearance of a vehicle seat air-conditioning device according to Embodiment 1.

FIG. 1B is a front view illustrating the vehicle seat air-conditioning device according to Embodiment 1.

FIG. 2 is a block diagram illustrating the vehicle seat air-conditioning device according to Embodiment 1.

FIG. 3 is a schematic diagram illustrating a ventilation path selection switch device, a first seat ventilation path, and a second seat ventilation path of the vehicle seat air-conditioning device according to Embodiment 1.

FIG. 4A is a cross-sectional view illustrating the ventilation path selection switch device taken along line A-A in FIG. 1B when the ventilation path switch is in a first mode.

FIG. 4B is a cross-sectional view illustrating the ventilation path selection switch device taken along line B-B in FIG. 1B when the ventilation path switch is in the first mode.

FIG. 5A is a cross-sectional view illustrating the ventilation path selection switch device taken along line C-C in FIG. 1B when the ventilation path switch is in the first mode.

FIG. 5B is a cross-sectional view illustrating the ventilation path selection switch device taken along line D-D in FIG. 1B when the ventilation path switch is in the first mode.

FIG. 6A is a cross-sectional view illustrating the ventilation path selection switch device taken along line A-A in FIG. 1B when the ventilation path switch is in a second mode.

FIG. 6B is a cross-sectional view illustrating the ventilation path selection switch device taken along line B-B in FIG. 1B when the ventilation path switch is in the second mode.

FIG. 7A is a cross-sectional view illustrating the ventilation path selection switch device taken along line C-C in FIG. 1B when the ventilation path switch is in the second mode.

FIG. 7B is a cross-sectional view illustrating the ventilation path selection switch device taken along line D-D in FIG. 1B when the ventilation path switch is in the second mode.

FIG. 8 is an explanatory drawing illustrating flow paths when the ventilation path switch is in the first mode and the second mode.

FIG. 9 is a perspective view illustrating a first gear and a second gear of the vehicle seat air-conditioning device.

FIG. 10A is a perspective view illustrating an appearance of a vehicle seat air-conditioning device that can also draw air into or blow out air from a seating portion.

FIG. 10B is a schematic diagram illustrating the ventilation path selection switch device of the vehicle seat air-conditioning device that can draw air into or blow out air also from seating portion 11, the first seat ventilation path provided in a seat backrest, and the second seat ventilation path provided in the seating portion and the seat backrest.

FIG. 11 is an explanatory drawing illustrating flows of air when the ventilation path switch of the vehicle seat air-conditioning device that can draw into and blow out air also from the seating portion is in the first mode and the second mode.

FIG. 12A is a perspective view illustrating an appearance of a vehicle seat air-conditioning device that can switch where to draw in air between the front surface of the seat backrest and the lateral surface of a seat.

FIG. 12B is a block diagram illustrating the vehicle seat air-conditioning device that can switch where to draw in air between the front surface of the seat backrest and the lateral surface of the seat.

FIG. 13 includes explanatory drawings illustrating flows of air when the ventilation path switch of the vehicle seat air-conditioning device that can switch where to draw in air between the front surface of the seat backrest and the lateral surface of the seat is in the first mode and the second mode.

FIG. 14 is a perspective view illustrating an appearance of a vehicle seat air-conditioning device that can switch where to draw in air between the front surface of the seat and the lateral surface of the seat.

FIG. 15 includes explanatory drawings illustrating flows of air when the ventilation path switch of the vehicle seat air-conditioning device that can switch where to draw in air between the front surface of the seat and the lateral surface of the seat is in the first mode and the second mode.

FIG. 16 includes explanatory drawings illustrating flows of air when the ventilation path switch of a vehicle seat air-conditioning device that can draw in air from the lateral surface of the seat and blow out air from the front surface of the seat backrest is in the first mode and the second mode.

FIG. 17 includes explanatory drawings illustrating flows of air when the ventilation path switch of a vehicle seat air-conditioning device that can draw in air from the lateral surface of the seat and blow out air from the front surface of the seat is in the first mode and the second mode.

FIG. 18 includes explanatory drawings illustrating flows of air when the ventilation path switch of a vehicle seat air-conditioning device that can switch where to draw in air between the front surface of the seat and the lateral surface of the seat and can blow out air from the front surface of the seat backrest is in the first mode and the second mode.

FIG. 19 is a view from the back of a vehicle seat air-conditioning device according to Embodiment 2.

FIG. 20 is a view from the side of the vehicle seat air-conditioning device according to Embodiment 2.

FIG. 21 is a schematic diagram illustrating ventilation paths, for instance, of the vehicle seat air-conditioning device according to Embodiment 2.

FIG. 22A is a perspective view illustrating the vehicle seat air-conditioning device according to Embodiment 2.

FIG. 22B is a perspective view illustrating the ventilation path selection switch device in a direction different from the view in FIG. 22A.

FIG. 23 illustrates a switch of the ventilation path selection switch device according to Embodiment 2.

FIG. 24 illustrates flows of air in the vehicle seat air-conditioning device according to Embodiment 2 in a first mode and flows of air therein in a second mode.

FIG. 25A is a perspective view illustrating an appearance of a vehicle seat air-conditioning device according to Variation 1 of Embodiment 2.

FIG. 25B illustrates a view illustrating the vehicle seat air-conditioning device according to Variation 1 of Embodiment 2 from obliquely behind.

FIG. 26 is a schematic diagram illustrating ventilation paths, for instance, of the vehicle seat air-conditioning device according to Variation 1 of Embodiment 2.

FIG. 27 is a perspective view illustrating a blower of the vehicle seat air-conditioning device according to Variation 1 of Embodiment 2.

FIG. 28 illustrates flows of air in the vehicle seat air-conditioning device according to Variation 1 of Embodiment 2 in the first mode and flows of air therein in the second mode.

FIG. 29 is a perspective view illustrating an appearance of a vehicle seat air-conditioning device according to Variation 2 of Embodiment 2.

FIG. 30 is a schematic diagram illustrating ventilation paths, for instance, of the vehicle seat air-conditioning device according to Variation 2 of Embodiment 2.

FIG. 31 illustrates flows of air in the vehicle seat air-conditioning device according to Variation 2 of Embodiment 2 in the first mode and flows of air therein in the second mode.

FIG. 32 is a schematic diagram illustrating ventilation paths, for instance, of a vehicle seat air-conditioning device according to Variation 3 of Embodiment 2.

FIG. 33 illustrates flows of air in the vehicle seat air-conditioning device according to Variation 3 of Embodiment 2 in the first mode and flows of air therein in the second mode.

FIG. 34 is a view from the back of a vehicle seat air-conditioning device according to Variation 4 of Embodiment 2.

FIG. 35 is a view from the side of the vehicle seat air-conditioning device according to Variation 4 of Embodiment 2.

### DESCRIPTION OF EMBODIMENTS

Note that the embodiments explained below each show a general or specific example. The numerical values, shapes, materials, elements, the arrangement and connection of the elements shown in the following embodiments are mere examples, and thus are not intended to limit the present disclosure. Among the elements in the following embodiments, elements not recited in the independent claim are explained as optional elements.

In addition, the drawings are schematic diagrams, and do not necessarily provide strictly accurate illustration. Further, the same numeral is given to the same structural member throughout the drawings.

In the following embodiments, expressions such as a plate shape, an X-axis direction, and being substantially quadrilateral are used. For example, the plate shape, the X-axis direction, and being substantially quadrilateral not only mean a complete plate shape, the complete X-axis direction, and being completely quadrilateral, respectively, but also mean a substantial plate shape, a substantial X-axis direction, and being substantially quadrilateral, respectively, or stated differently also mean that an error of about several percent is included. Furthermore, a plate shape, the X-axis direction, and being substantially quadrilateral mean a plate shape, the X-axis direction, and being substantially quadrilateral in a scope in which effects yielded by the present disclosure can be achieved. The same also applies to other expressions that include “shape”, “direction”, and “substantially”.

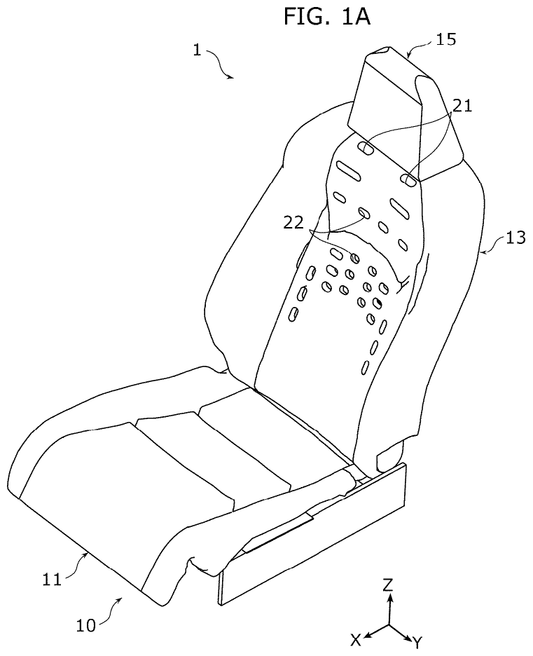

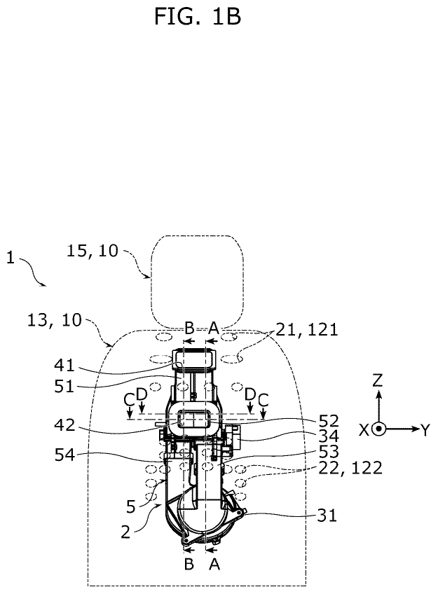

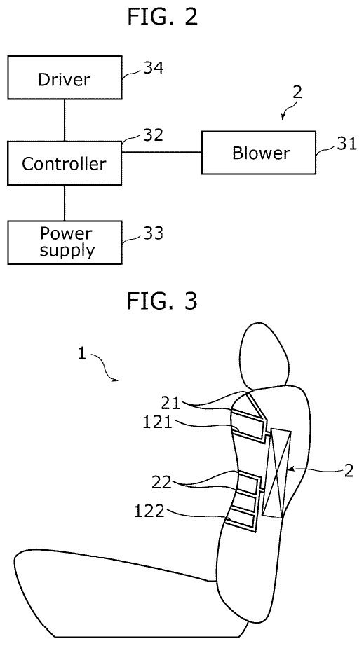

In the explanation below, the front-and-rear direction of a seat is referred to as the X-axis direction, and the up-and-down direction of the seat is referred to as the Z-axis direction. Furthermore, the right-and-left direction of the seat, that is, a direction perpendicular to the X-axis direction and the Z-axis direction is referred to as the Y-axis direction. The front side of the seat in the X-axis direction is referred to as a positive side, and the rear side of the seat in the X-axis direction is referred to as a negative side. The right side in the Y-axis direction in FIG. 1B is referred to as a positive side, and the opposite side (the left side) therefrom in the Y-axis direction is referred to as a negative side. The left side in FIG. 1B is the right of a person with respect to a travel direction of a vehicle when the person is seated in the seat, and is a negative Y-axis side. Moreover, the right side in FIG. 1B is the left of a person with respect to the travel direction of the vehicle when the person is seated in the seat, and is a positive Y-axis side. The upper side of the seat in the Z-axis direction is referred to as a positive side, and the lower side of the seat in the Z-axis direction is referred to as a negative side. The same may apply to FIG. 2 and the drawings thereafter.

Hereinafter, embodiments are specifically described with reference to the drawings.

### Embodiment 1

### [Configuration and Function]

First, a configuration of ventilation path selection switch device 2 and vehicle seat air-conditioning device 1 according to the present embodiment is described with reference to FIG. 1A to FIG. 9.

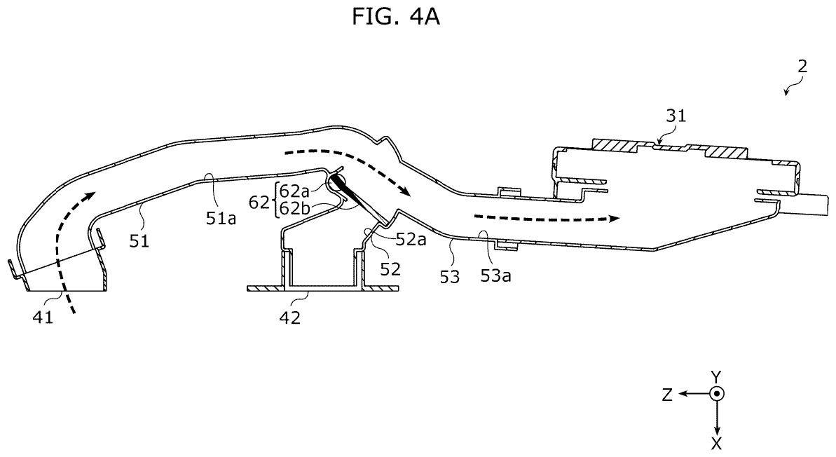

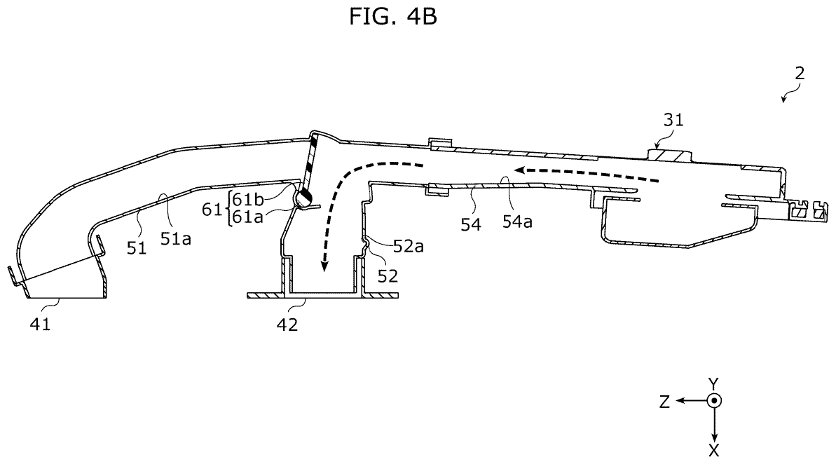

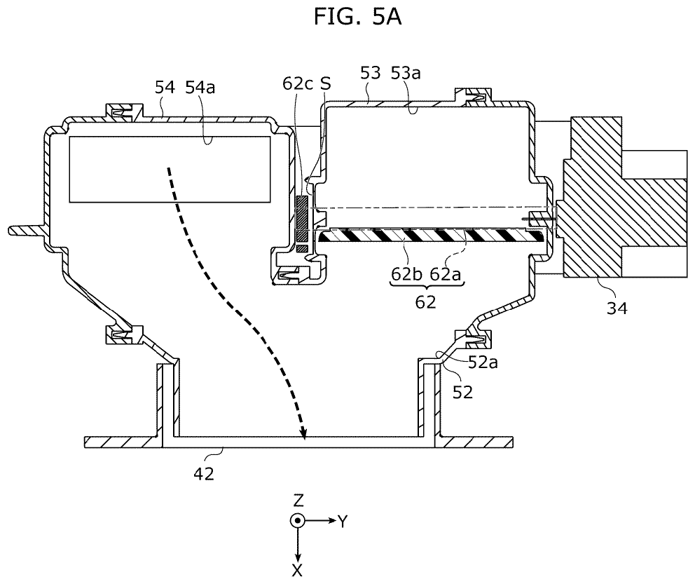

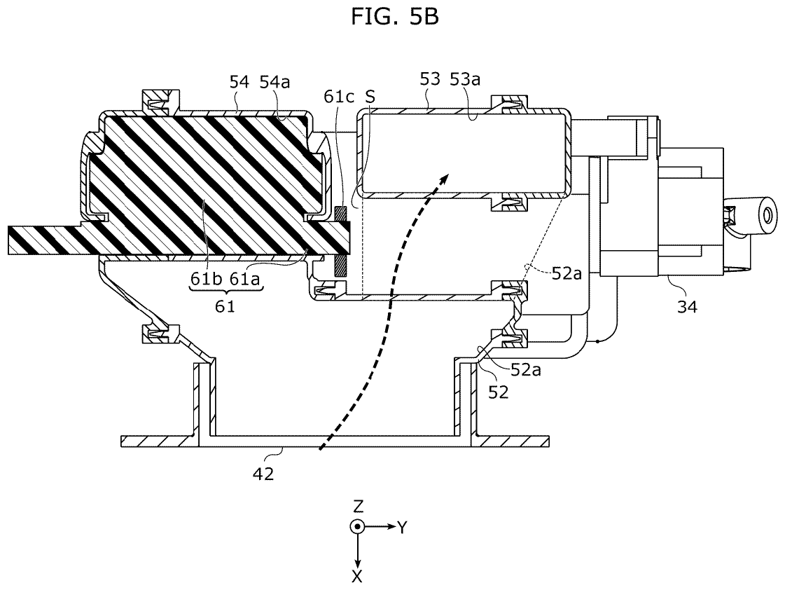

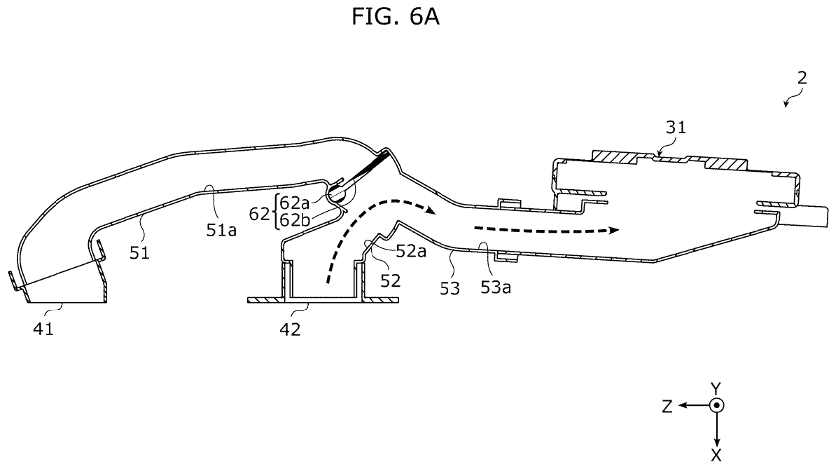

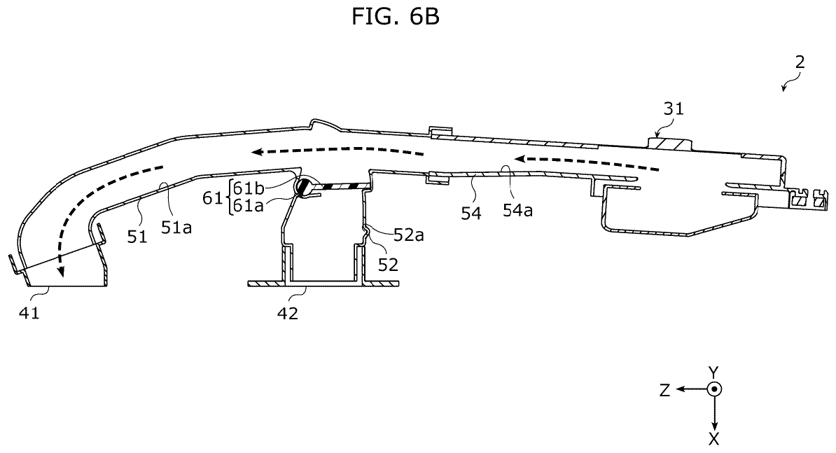

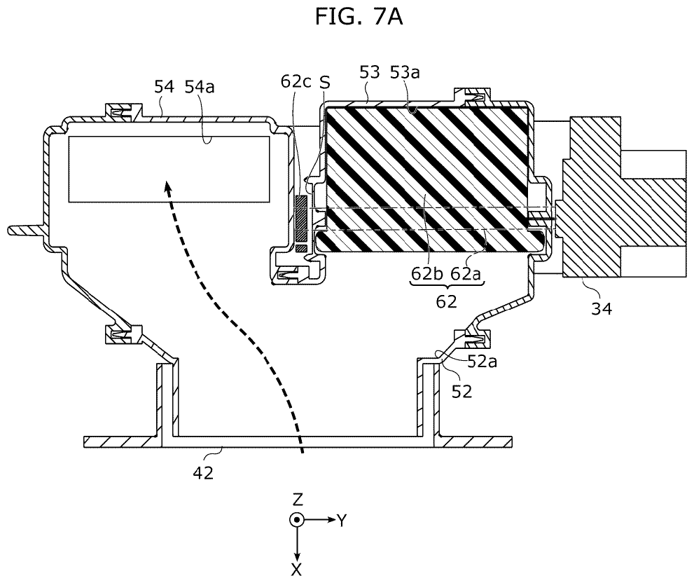

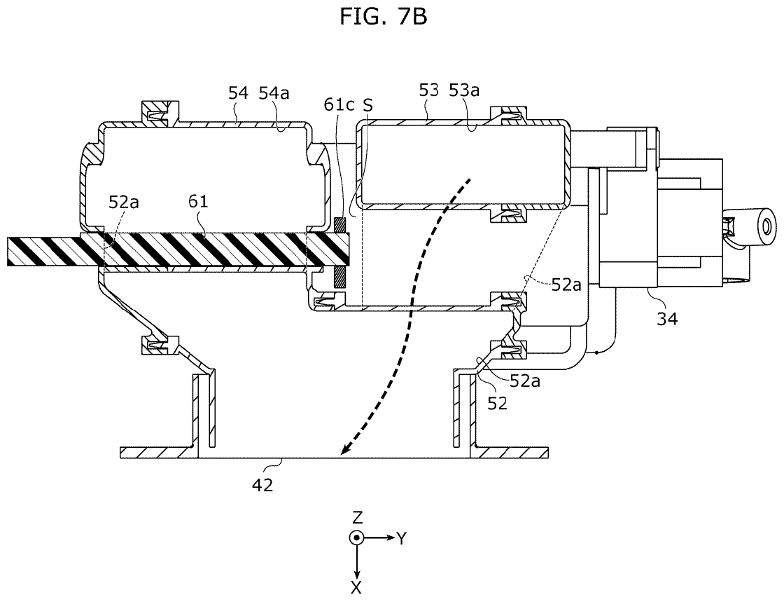

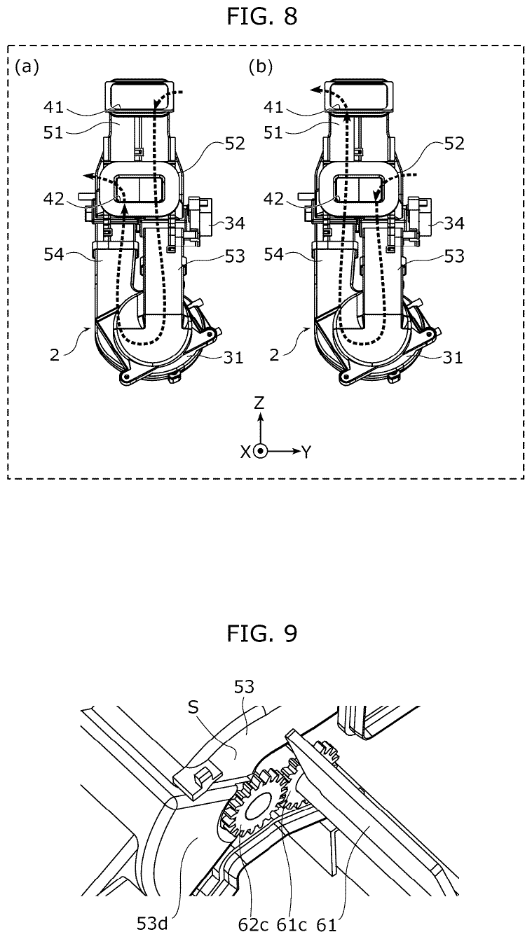

FIG. 1A is a perspective view illustrating an appearance of vehicle seat air-conditioning device 1 according to Embodiment 1. FIG. 1B is a front view illustrating vehicle seat air-conditioning device 1 according to Embodiment 1. FIG. 2 is a block diagram illustrating vehicle seat air-conditioning device 1 according to Embodiment 1. FIG. 3 is a schematic diagram illustrating ventilation path selection switch device 2, first seat ventilation path 121, and second seat ventilation path 122 of vehicle seat air-conditioning device 1 according to Embodiment 1. FIG. 3 gives a simplified illustration with no hatching, in order to avoid the drawing being complicated. Similarly, the subsequent drawings may give simplified illustrations with no hatching. FIG. 4A is a cross-sectional view illustrating ventilation path selection switch device 2 taken along line A-A in FIG. 1B when a ventilation path switch is in a first mode. FIG. 4B is a cross-sectional view illustrating ventilation path selection switch device 2 taken along line B-B in FIG. 1B when the ventilation path switch is in the first mode. FIG. 5A is a cross-sectional view illustrating ventilation path selection switch device 2 taken along line C-C in FIG. 1B when the ventilation path switch is in the first mode. FIG. 5B is a cross-sectional view illustrating ventilation path selection switch device 2 taken along line D-D in FIG. 1B when the ventilation path switch is in the first mode. FIG. 6A is a cross-sectional view illustrating ventilation path selection switch device 2 taken along line A-A in FIG. 1B when the ventilation path switch is in a second mode. FIG. 6B is a cross-sectional view illustrating ventilation path selection switch device 2 taken along line B-B in FIG. 1B when the ventilation path switch is in the second mode. FIG. 7A is a cross-sectional view illustrating ventilation path selection switch device 2 taken along line C-C in FIG. 1B when the ventilation path switch is in the second mode. FIG. 7B is a cross-sectional view illustrating ventilation path selection switch device 2 taken along line D-D in FIG. 1B when the ventilation path switch is in the second mode. FIG. 8 is an explanatory drawing illustrating flow paths when the ventilation path switch is in the first mode and the second mode. Part (a) of FIG. 8 illustrates a flow path when the ventilation path switch is in the first mode. Part (b) of FIG. 8 illustrates a flow path when the ventilation path switch is in the second mode. FIG. 9 is a perspective view illustrating first gear 61c and second gear 62c of vehicle seat air-conditioning device 1. In FIG. 9, illustration of outlet duct 54 is omitted so that first gear 61c and second gear 62c are visible.

Note that the orientation of seat backrest 13 of seat 10 changes, and thus in the present embodiment, it is assumed that seat backrest 13 is in an upright orientation in the Z-axis direction with respect to seating portion 11.

As illustrated in FIG. 1A, for example, vehicle seat air-conditioning device 1 provided in, for instance, a vehicle can cool and warm a person seated in seat 10 by blowing air toward the upper half of the body of the person seated in seat 10 from behind. Specifically, vehicle seat air-conditioning device 1 can cool and warm the body of a person seated in seat 10 by drawing in air in the cabin and blowing the air drawn in onto the head, the neck, the shoulders, and the back, for instance, that are the upper body of the person.

Such vehicle seat air-conditioning device 1 includes seat 10, ventilation path selection switch device 2, blower 31, controller 32, and power supply 33. Note that blower 31 may be an element of ventilation path selection switch device 2.

Seat 10 includes seating portion 11 for a person to sit, seat backrest 13, and headrest 15.

Seating portion 11 is a seat cushion that supports, for instance, buttocks and thighs of a person seated in seat 10. Seating portion 11 includes a first seat pad that corresponds to a cushion material, and a first seat cover that covers the first seat pad.

The first seat pad is made of a cushion material such as, for example, urethane foam. The first seat pad is in a substantially quadrilateral plate shape having a thickness, and is disposed in an orientation in which the first seat pad tilts a predetermined angle with respect to the X-Y plane. The first seat cover covers the first seat pad. The first seat cover is a leather cover or a fabric cover, for example.

Seat backrest 13 is a backrest portion against which a person seated in seat 10 leans and that supports the shoulders, the back, and the waist of the person. Seat backrest 13 is elongated in the Z-axis direction, and disposed rising from seating portion 11. Seat backrest 13 can adjust the backrest angle by rotating about the Y axis according to the posture of a person. Seat backrest 13 includes a second seat pad that corresponds to a cushion material, and a second seat cover that covers the second seat pad.

The second seat pad is made of a cushion material such as, for example, urethane foam. The second seat pad is in a substantially quadrilateral plate shape having a thickness. The second seat cover covers the second seat pad. The second seat cover is a leather cover or a fabric cover, for example.

Seat backrest 13 is provided with a plurality of ventilation paths for leading air when ventilation path selection switch device 2 draws in air in the cabin and blows out the air drawn in from seat 10. The plurality of ventilation paths include first seat ventilation path 121 and second seat ventilation path 122.

First seat ventilation path 121 includes a plurality of first vent holes 21 provided in a front surface of seat backrest 13, that is, a front surface of seat 10 on the side where a person is seated. First seat ventilation path 121 is a flow path from first vent holes 21 to ventilation path selection switch device 2.

First vent holes 21 are provided in an upper portion of seat backrest 13 of seat 10. Specifically, first vent holes 21 are provided above the central axis that bisects the longer direction (on the Z-axis positive side) when seat backrest 13 is viewed from the side surface (viewed in the Y-axis direction). First vent holes 21 are provided for the upper body of a person seated in seat 10. The upper body of a person includes the neck, the head, and the shoulders of the person, for example.

Second seat ventilation path 122 includes a plurality of second vent holes 22 provided in the front surface of seat backrest 13, that is, the front surface of seat 10 on the side where a person is seated. Second seat ventilation path 122 is a flow path from second vent holes 22 to ventilation path selection switch device 2.

Second vent holes 22 are provided below first vent holes 21 in the vertical direction. In the present embodiment, second vent holes 22 are provided below first vent holes 21 in the vertical direction and in a center portion of seat backrest 13. Second vent holes 22 are provided for the back of a person seated in seat 10.

Ventilation path selection switch device 2, blower 31, controller 32, and power supply 33 are provided on the back surface side of seat backrest 13 (on the X-axis negative side). Ventilation path selection switch device 2 includes blower 31, and ventilation path selection switch device 2 and blower 31 are housed in seat backrest 13.

Vehicle seat air-conditioning device 2 is provided in vehicle seat air-conditioning device 1 disposed in a vehicle, for use in seat 10. Ventilation path selection switch device 2 includes casing 5, the ventilation path switch, and a drive mechanism.

Casing 5 includes inlet duct 53, outlet duct 54, first duct 51, and second duct 52.

Inlet duct 53 can lead air drawn in by blower 31 and defines inlet ventilation path 53a inside. Inlet duct 53 is disposed on the X-axis negative side of seat backrest 13. Inlet duct 53 is connected to blower 31, extends in the Z-axis positive direction from blower 31, and is connected to first duct 51 and second duct 52.

Air drawn in by blower 31 and led through inlet ventilation path 53a can be blown out through outlet duct 54, and outlet duct 54 defines outlet ventilation path 54a inside. Outlet duct 54 is disposed on the X-axis negative side of seat backrest 13, side by side with inlet duct 53. Outlet duct 54 is connected to blower 31, extends in the Z-axis positive direction from blower 31, and is connected to first duct 51 and second duct 52.

Outlet duct 54 is connected to inlet duct 53 via first duct 51, connected to inlet duct 53 via second duct 52, and connected to inlet duct 53 via blower 31.

First duct 51 is connected to inlet duct 53 and outlet duct 54, and defines first ventilation path 51a inside. First duct 51 further extends in the Z-axis positive direction from an end portion of inlet duct 53 on the Z-axis positive side and an end portion of outlet duct 54 on the Z-axis positive side, and defines first opening 41 at the tip. Thus, first duct 51 includes first opening 41 and is continuous from the end portion of inlet duct 53 on the Z-axis positive side and the end portion of outlet duct 54 on the Z-axis positive side up to first opening 41. Accordingly, first ventilation path 51a is connected to inlet ventilation path 53a and outlet ventilation path 54a. First opening 41 is connected to first seat ventilation path 121 of seat 10 and is connected to first vent holes 21. First opening 41 is provided in a position corresponding to first vent holes 21 of seat 10.

Second duct 52 is independent and different from first duct 51, is connected to inlet duct 53 and outlet duct 54, and defines second ventilation path 52a inside. Second duct 52 extends from a middle portion of inlet duct 53 in the Z-axis direction and in the X-axis positive direction and also extends from a middle portion of outlet duct 54 in the Z-axis direction and in the X-axis positive direction, and defines second opening 42 at the tip. Thus, second duct 52 includes second opening 42, and is continuous from the middle portion of inlet duct 53 in the Z-axis direction and the middle portion of outlet duct 54 in the Z-axis direction up to second opening 42. Accordingly, second ventilation path 52a is different from first ventilation path 51a, and is connected to inlet ventilation path 53a and outlet ventilation path 54a. Second opening 42 is connected to second seat ventilation path 122 of seat 10 and is connected to second vent holes 22. Second opening 42 is provided below first opening 41 in the vertical direction. In the present embodiment, second opening 42 is provided below first opening 41 in the vertical direction and in a center portion of ventilation path selection switch device 2. Second opening 42 is provided in a position corresponding to second vent holes 22 of seat 10.

The ventilation path switch includes first movable plate 61 and second movable plate 62.

First movable plate 61 is disposed to close and open a flow path that connects outlet ventilation path 54a and first ventilation path 51a. First movable plate 61 may be disposed in outlet duct 54, may be disposed in first duct 51, or may be disposed between outlet duct 54 and first duct 51. In the present embodiment, first movable plate 61 is axially and rotationally supported by outlet duct 54. Accordingly, outlet duct 54 has a space in which first movable plate 61 can rotate. Outlet duct 54 is provided with a restricting portion that stops first movable plate 61 by abutting against first movable plate 61 to restrict rotation thereof by a predetermined amount or more.

First movable plate 61 includes first rotation shaft 61a and first rotation plate 61b coupled to first rotation shaft 61a.

First rotation shaft 61a extends in the Y-axis direction and is axially and rotatably supported by casing 5. In the present embodiment, first rotation shaft 61a is axially and rotationally supported by outlet duct 54.

First rotation plate 61b is disposed in an orientation in which the flow path that connects outlet ventilation path 54a and first ventilation path 51a is closed and opened according to rotation of first rotation shaft 61a, and is disposed in an orientation in which the flow path that connects outlet ventilation path 54a and second ventilation path 52a is closed and opened according to rotation of first rotation shaft 61a.

Second movable plate 62 is disposed to close and open the flow path that connects inlet ventilation path 53a and second ventilation path 52a. Second movable plate 62 may be disposed in inlet duct 53, may be provided in second duct 52, or may be provided between inlet duct 53 and second duct 52. In the present embodiment, second movable plate 62 is axially and rotationally supported by inlet duct 53. Accordingly, inlet duct 53 has a space in which second movable plate 62 can be rotated. Inlet duct 53 is provided with a restricting portion that stops second movable plate 62 by abutting against second movable plate 62 to restrict rotation thereof by a predetermined amount or more.

Second movable plate 62 includes second rotation shaft 62a and second rotation plate 62b coupled to second rotation shaft 62a.

Second rotation shaft 62a extends in the Y-axis direction and axially and rotatably supported by casing 5. In the present embodiment, second rotation shaft 62a is axially and rotationally supported by inlet duct 53.

Second rotation plate 62b is disposed in an orientation in which the flow path that connects inlet ventilation path 53a and second ventilation path 52a is closed and opened according to rotation of second rotation shaft 62a, and is disposed in an orientation in which the flow path that connects inlet ventilation path 53a and first ventilation path 51a is closed and opened according to rotation of second rotation shaft 62a.

The drive mechanism includes first gear 61c that rotates first movable plate 61, second gear 62c that rotates second movable plate 62 by meshing with first gear 61c, and driver 34 that rotates first gear 61c and second gear 62c in conjunction with each other.

Specifically, second rotation shaft 62a of second movable plate 62 passes through inlet duct 53 in the Y-axis direction. Driver 34 is coupled to an end of second rotation shaft 62a on the Y-axis positive side, and is disposed outside inlet duct 53. Second gear 62c is coupled to another end of second rotation shaft 62a on the Y-axis negative side, and is disposed outside inlet duct 53.

First rotation shaft 61a of first movable plate 61 passes through outlet duct 54 in the Y-axis direction. An end of first rotation shaft 61a on the Y-axis negative side is axially supported by outlet duct 54. First gear 61c is coupled to an end of first rotation shaft 61a on the Y-axis positive side, and is disposed outside outlet duct 54.

Space S extending in the Z-axis direction is provided between outlet duct 54 and inlet duct 53, and first gear 61c and second gear 62c are disposed in space S between outlet duct 54 and inlet duct 53.

First gear 61c and second gear 62c are disposed between outlet duct 54, inlet duct 53, and second duct 52, but space S is provided between outlet duct 54 and inlet duct 53. Accordingly, ventilation path selection switch device 2 is disposed on the X-axis negative side of seat backrest 13, and thus it is considered to be preferable to reduce entry of an object such as dust into space S from behind seat 10. In view of this, in the present embodiment, inlet duct 53 is provided with protrusion 53d on a peripheral side of first gear 61c or second gear 62c, and protrusion 53d is an expanding portion of inlet duct 53 which approaches outlet duct 54 to expand into space S. Note that instead of providing inlet duct 53 with protrusion 53d, outlet duct 54 may be provided with a protrusion on a peripheral side of first gear 61c or second gear 62c, and the protrusion may be an expanding portion of outlet duct 54 which approaches inlet duct 53 to expand into space S.

Since first gear 61c and second gear 62c mesh with each other, when driver 34 rotates second rotation shaft 62a of second movable plate 62, second gear 62c rotates and its rotational force rotates first gear 61c, whereby first rotation shaft 61a rotates. Thus, when driver 34 rotates second movable plate 62, first movable plate 61 rotates in conjunction with the rotation of second movable plate 62.

Driver 34 is an electric motor, for example. Driver 34 can rotate second rotation shaft 62a of second movable plate 62 by being controlled by controller 32. Specifically, by being controlled by controller 32, driver 34 can rotate second movable plate 62 to close the flow path that connects second ventilation path 52a and inlet ventilation path 53a and open the flow path that connects first ventilation path 51a and inlet ventilation path 53a as illustrated in FIG. 4A, and can rotate first movable plate 61 in conjunction with second movable plate 62 to close the flow path that connects outlet ventilation path 54a and first ventilation path 51a and open the flow path that connects outlet ventilation path 54a and second ventilation path 52a as illustrated in FIG. 4B. Furthermore, by being controlled by controller 32, driver 34 can rotate second movable plate 62 to close the flow path that connects first ventilation path 51a and inlet ventilation path 53a and open the flow path that connects second ventilation path 52a and inlet ventilation path 53a as illustrated in FIG. 6A, and can rotate first movable plate 61 in conjunction with second movable plate 62 to close the flow path that connects outlet ventilation path 54a and second ventilation path 52a and open the flow path that connects outlet ventilation path 54a and first ventilation path 51a as illustrated in FIG. 6B. Blower 31 is connected to inlet duct 53 and outlet duct 54.

Blower 31 draws in air from first opening 41 or second opening 42 connected to inlet duct 53, leads the air drawn into inlet duct 53 to outlet duct 54, and blows out the air from second opening 42 or first opening 41 connected to outlet duct 54. Specifically, by being controlled by controller 32, as illustrated in (a) of FIG. 8, blower 31 can draw in air from first opening 41, lead the air to inlet duct 53 via first duct 51, lead the air led to inlet duct 53 to outlet duct 54, and blow out the air from second opening 42 via second duct 52 connected to outlet duct 54. Furthermore, by being controlled by controller 32, as illustrated in (b) of FIG. 8, blower 31 can draw in air from second opening 42, lead the air to inlet duct 53 via second duct 52, lead the air led to inlet duct 53 to outlet duct 54, and blow out the air from first opening 41 via first duct 51 connected to outlet duct 54.

Controller 32 can control operation of blower 31 and control operation of the ventilation path switch.

Controller 32 can control the amount air to be drawn into inlet duct 53 and the amount of air (the air volume) to be blown out through outlet duct 54, by controlling blower 31. For example, controller 32 may control the amount of air drawn into inlet duct 53 and the amount of air blown out through outlet duct 54 by controlling blower 31, based on at least one of the temperature in a cabin in which seat 10 is disposed, the temperature of a person present in the cabin, or a control instruction given to an air-conditioning device provided in the vehicle. In this case, controller 32 may obtain, from a sensor provided in the cabin, the temperature in the cabin and the temperature of a person present in the cabin, and control blower 31. Controller 32 may estimate the temperature in the cabin and the temperature of a person present in the cabin by obtaining an operation period from when the operation of an air-conditioning device provided in the vehicle starts, and control blower 31.

Controller 32 can control driver 34 and the ventilation path switch (execute the first mode), to rotate second movable plate 62 to close the flow path that connects second ventilation path 52a and inlet ventilation path 53a and open the flow path that connects first ventilation path 51a and inlet ventilation path 53a as illustrated in FIG. 4A, and rotate first movable plate 61 in conjunction with second movable plate 62 to close the flow path that connects outlet ventilation path 54a and first ventilation path 51a and open the flow path that connects outlet ventilation path 54a and second ventilation path 52a as illustrated in FIG. 4B. Furthermore, controller 32 can control driver 34 and the ventilation path switch (execute the second mode) to rotate second movable plate 62 to close the flow path that connects first ventilation path 51a and inlet ventilation path 53a and open the flow path that connects second ventilation path 52a and inlet ventilation path 53a as illustrated in FIG. 6A, and rotate first movable plate 61 in conjunction with second movable plate 62 to close the flow path that connects outlet ventilation path 54a and second ventilation path 52a and open the flow path that connects outlet ventilation path 54a and first ventilation path 51a as illustrated in FIG. 6B.

Accordingly, controller 32 can control whether to use first opening 41 as an inlet or an outlet and can control whether to use second opening 42 as an inlet or an outlet, by controlling blower 31 and driver 34.

Power supply 33 is a power supply circuit that supplies power to controller 32, blower 31, and driver 34 of the ventilation path switch. Power supply 33 can obtain power from a battery not illustrated. Power supply 33 can adjust current to be supplied to blower 31 and current to be supplied to driver 34, by being controlled by controller 32. Power supply 33 is provided in the vehicle, and may be or may not be included in the elements of vehicle seat air-conditioning device 1.

Next, functions of ventilation path selection switch device 2 and vehicle seat air-conditioning device 1 according to the present embodiment are described.

The ventilation path switch has the first mode and the second mode. When the mode is selected between the first mode and the second mode, the ventilation path switch can switch the mode to the selected mode. Specifically, driver 34 rotates first movable plate 61 and second movable plate 62 by being controlled by controller 32, and thus the ventilation path switch can switch between the modes.

More specifically, the ventilation path switch can execute the selected first mode by controller 32 controlling driver 34. In the first mode, air drawn into first ventilation path 51a by blower 31 can be led to inlet ventilation path 53a, and air led to outlet ventilation path 54a by blower 31 can be led to second ventilation path 52a. Specifically, in the first mode, second movable plate 62 opens the flow path from first ventilation path 51a to inlet ventilation path 53a while closing the flow path from second ventilation path 52a to inlet ventilation path 53a, whereas first movable plate 61 opens the flow path from outlet ventilation path 54a to second ventilation path 52a while closing the flow path from outlet ventilation path 54a to first ventilation path 51a (refer to FIG. 4A and FIG. 4B).

When controller 32 executes the first mode and a predetermined condition is satisfied, controller 32 can switch from the first mode to the second mode and execute the second mode.

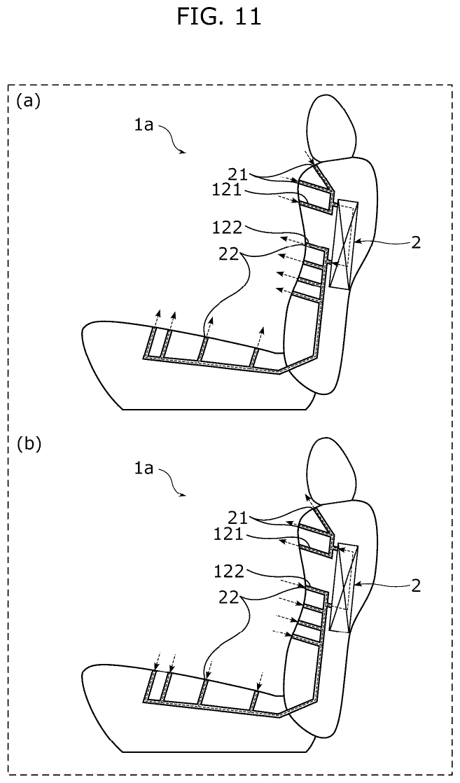

When the predetermined condition is satisfied is when a predetermined time has elapsed. For example, in an initial cooling stage in which the ignition of the vehicle is turned on and execution of the first mode has started, as illustrated in (a) of FIG. 11, air is blown out from second vent holes 22 so that a person seated in seat 10 does not feel hot on and around the neck sensitive to the temperature. As the predetermined time has elapsed, the temperature in the cabin of the vehicle lowers, and thus controller 32 switches from the first mode to the second mode. Accordingly, as illustrated in (b) of FIG. 11, the person can feel flows of air drawn into second vent holes 22 on the back of the person, and at the same time, can feel flows of air being blown out from first vent holes 21 onto the upper body of the person. Hence, the person seated in seat 10 can be cooled. The predetermined time is a preset time, and is a time estimated to be taken for the temperature in the cabin to lower. The predetermined time is several minutes such as five minutes, for example. The predetermined time may be changed optionally. Note that (a) and (b) of FIG. 11 are described later in detail.

When the predetermined condition is satisfied is when the temperature in the cabin (a representative temperature in the cabin or the temperature of air drawn in from seat 10) has lowered. For example, in an initial cooling stage in which the ignition of the vehicle is turned on and execution of the first mode has started, as illustrated in (a) of FIG. 11, air is blown out from second vent holes 22 so that a person seated in seat 10 does not feel hot on and around the neck sensitive to the temperature. When the temperature in the cabin of the vehicle is detected by a temperature sensor, a decrease in temperature in the cabin of the vehicle can be detected. When a decrease in temperature is detected, controller 32 switches from the first mode to the second mode. A decrease in temperature indicates that the temperature decreases to the predetermined temperature or lower, such as the temperature decreasing to 35 degrees Celsius, for example. Accordingly, as illustrated in (b) of FIG. 11, a person can feel flows of air drawn into second vent holes 22 on the back of the person, and at the same time, can feel air being blown out from first vent holes 21 onto the upper body of the person. Accordingly, the person seated in seat 10 can be cooled.

Note that the temperature of air drawn in from seat 10 may be detected by a temperature sensor provided inside seat 10 or may be estimated by a temperature sensor of an air-conditioning device provided in the vehicle.

Accordingly, in the first mode, blower 31 can cause air to flow into first seat ventilation path 121 from first vent holes 21 of seat 10 and air to be drawn into inlet ventilation path 53a through first ventilation path 51a from first opening 41. Air can be led through inlet ventilation path 53a and reach blower 31. Air can be led by blower 31 to outlet ventilation path 54a, and pass through second ventilation path 52a and second opening 42. Then, air can be blown out from second vent holes 22 through second seat ventilation path 122. Since first vent holes 21 are provided for the upper body of a person seated in seat 10, a person can feel flows of air drawn into first vent holes 21 on the upper body of the person, and can also feel air being blown out from second vent holes 22 onto the back of the person since second vent holes 22 are provided for the back of a person seated in seat 10.

More specifically, the ventilation path switch can execute the selected second mode by controller 32 controlling driver 34. In the second mode, air drawn into second ventilation path 52a by blower 31 can be led to inlet ventilation path 53a, and air led to outlet ventilation path 54a by blower 31 can be led to first ventilation path 51a. Specifically, in the second mode, second movable plate 62 opens the flow path from second ventilation path 52a to inlet ventilation path 53a while closing the flow path from first ventilation path 51a to inlet ventilation path 53a, whereas first movable plate 61 opens the flow path from outlet ventilation path 54a to first ventilation path 51a while closing the flow path from outlet ventilation path 54a to second ventilation path 52a.

Accordingly, in the second mode, by blower 31, air can be caused to flow into second seat ventilation path 122 from second vent holes 22 of seat 10, can be drawn into inlet ventilation path 53a through second ventilation path 52a from second opening 42, and can be led through inlet ventilation path 53a to reach blower 31. By blower 31, air can be led into outlet ventilation path 54a, can be caused to pass through first ventilation path 51a and first opening 41, and can be blown out from first vent holes 21 through first seat ventilation path 121. Since second vent holes 22 are provided for the back of a person seated in seat 10, the person can feel flows of air drawn into second vent holes 22 on the back of the person, and can also feel flows of air being blown out from first vent holes 21 onto the upper body of the person since first vent holes 21 are provided for the upper body of a person seated in seat 10.

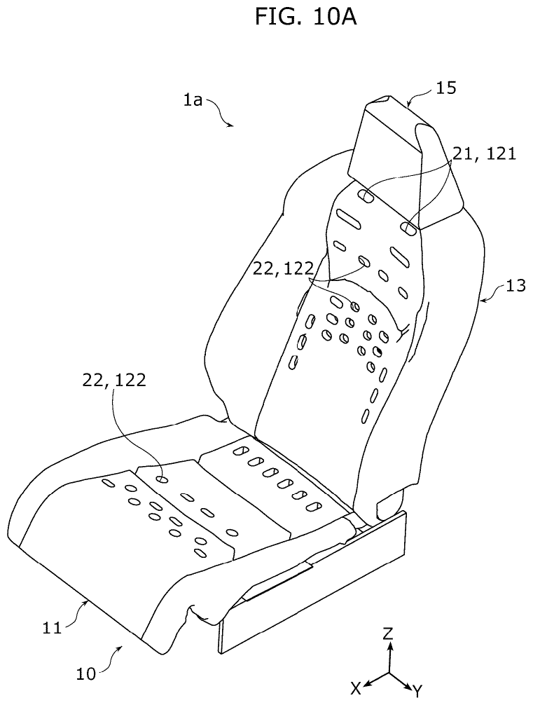

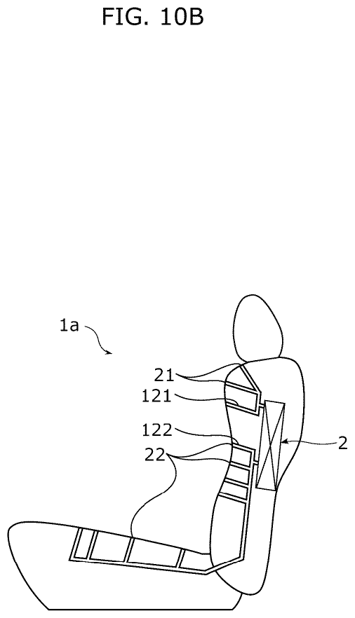

Furthermore, in the present embodiment, as illustrated in FIG. 10A to FIG. 11, second vent holes 22 may be provided in seating portion 11 of seat 10. In this case, air can be drawn in or blown out also from second vent holes 22 provided in seating portion 11. Note that when elements of ventilation path selection switch device 2 in FIG. 10A to FIG. 11 are the same as the elements of ventilation path selection switch device 2 described with reference to FIG. 1A to FIG. 9, the same reference numerals as the reference numerals used for the above description with reference to FIG. 1A to FIG. 9 are given, and the description is omitted appropriately.

FIG. 10A is a perspective view illustrating an appearance of vehicle seat air-conditioning device 1a that can also draw air into or blow air out from seating portion 11. FIG. 10B is a schematic diagram illustrating ventilation path selection switch device 2 of vehicle seat air-conditioning device 1a that can draw air into or blow air out also from seating portion 11, first seat ventilation path 121 provided in seat backrest 13, and second seat ventilation path 122 provided in seating portion 11 and seat backrest 13. FIG. 11 is an explanatory drawing illustrating flows of air when the ventilation path switch of vehicle seat air-conditioning device 1a that can draw into and blow out air also from seating portion 11 is in the first mode and the second mode. Part (a) of FIG. 11 illustrates flows of air when the ventilation path switch is executing the first mode. Part (b) of FIG. 11 illustrates flows of air when the ventilation path switch is executing the second mode.

Second seat ventilation path 122 of seat 10 is connected to second opening 42 of ventilation path selection switch device 2 provided in seat backrest 13, and includes second vent holes 22 provided in the front surface of seat backrest 13 and second vent holes provided in the front surface of seat 10 of seating portion 11 on the side where a person is seated. Second seat ventilation path 122 extends up to second vent holes 22 provided in the front surface of seat backrest 13 from second opening 42 of ventilation path selection switch device 2, and also reaches seating portion 11 from second opening 42 of ventilation path selection switch device 2 through seat backrest 13 and extends up to second vent holes 22 provided in the front surface of seating portion 11. Second vent holes 22 provided in the front surface of seating portion 11 are provided for buttocks and thighs of a person seated in seat 10.

Here, functions of ventilation path selection switch device 2 and vehicle seat air-conditioning device 1a according to the present embodiment are described.

The ventilation path switch can execute the selected first mode by controller 32 controlling driver 34. In the first mode, blower 31 can cause air to flow into first seat ventilation path 121 from first vent holes 21 of seat 10 and air to be drawn into inlet ventilation path 53a through first ventilation path 51a from first opening 41. Air can be led through inlet ventilation path 53a and reach blower 31. Air can be led to outlet ventilation path 54a by blower 31, and pass through second ventilation path 52a and second opening 42. Then, air can be blown out from second vent holes 22 through second seat ventilation path 122. Since first vent holes 21 are provided for the upper body of a person seated in seat 10, the person can feel flows of air drawn into first vent holes 21 on the upper body of the person, and can also feel air being blown out from second vent holes 22 onto the back, buttocks, and thighs of the person since second vent holes 22 are provided for the back, buttocks, and thighs of a person seated in seat 10.

The ventilation path switch can execute the selected second mode by controller 32 controlling driver 34. In the second mode, by blower 31, air can be caused to flow into second seat ventilation path 122 from second vent holes 22 of seat 10, can be drawn into inlet ventilation path 53a through second ventilation path 52a from second opening 42, and can be led through inlet ventilation path 53a to reach blower 31. By blower 31, air can be led to outlet ventilation path 54a, can be caused to pass through first ventilation path 51a and first opening 41, and can be blown out from first vent holes 21 through first seat ventilation path 121. Since second vent holes 22 are provided for the back, buttocks, and thighs of a person seated in seat 10, the person can feel flows of air drawn into second vent holes 22 on the back, buttocks, and thighs of the person, and can also feel flows of air being blown out from first vent holes 21 onto the upper body of the person since first vent holes 21 are provided for the upper body of a person seated in seat 10.

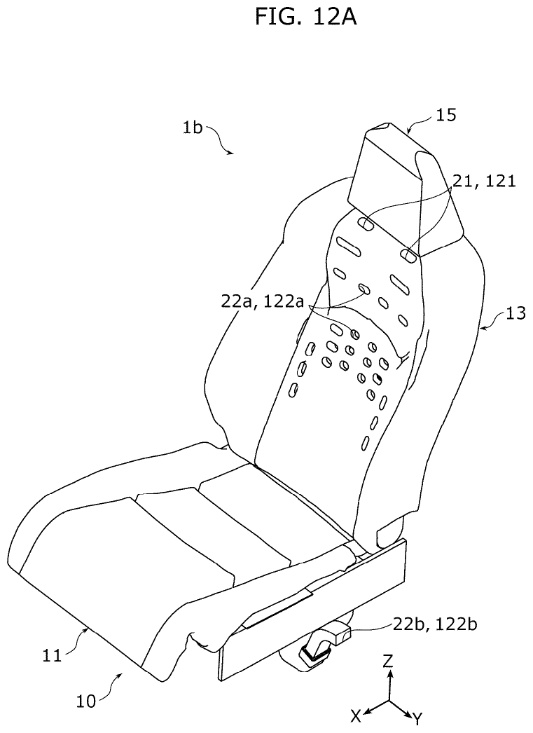

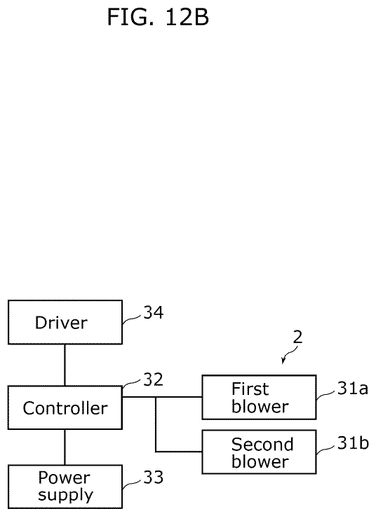

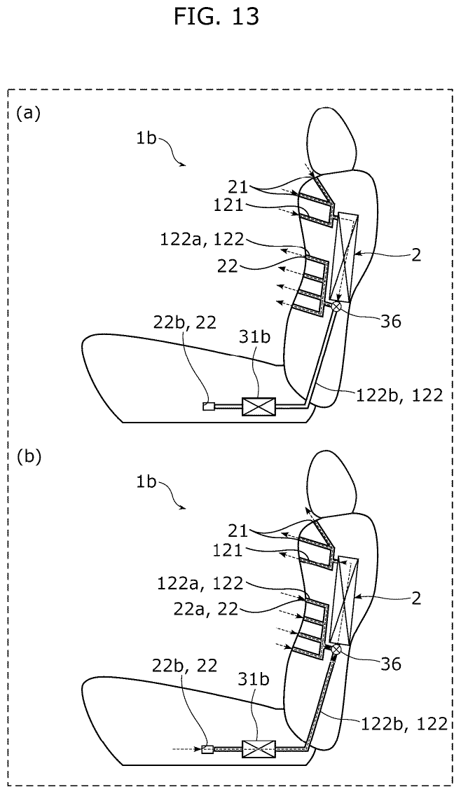

Furthermore, in the present embodiment, as illustrated in FIG. 12A to FIG. 13, vehicle seat air-conditioning device 1b may include first blower 31a, second blower 31b, and valve 36. Stated differently, blower 31 may be included in first blower 31a and second blower 31b. Note that when elements of ventilation path selection switch device 2 in FIG. 12A to FIG. 13 are the same as the elements of ventilation path selection switch device 2 described with reference to FIG. 1A to FIG. 9, the same reference numerals as the reference numerals used for the above description with reference to FIG. 1A to FIG. 9 are given, and the description is omitted appropriately.

FIG. 12A is a perspective view illustrating an appearance of vehicle seat air-conditioning device 1b that can switch where to draw in air between the front surface of seat backrest 13 and the lateral surface of seat 10. FIG. 12B is a block diagram illustrating vehicle seat air-conditioning device 1b that can switch where to draw in air between the front surface of seat backrest 13 and the lateral surface of seat 10. FIG. 13 includes explanatory drawings illustrating flows of air when the ventilation path switch of vehicle seat air-conditioning device 1b that can switch where to draw in air between the front surface of seat backrest 13 and the lateral surface of seat 10 is in the first mode and the second mode. Part (a) of FIG. 13 illustrates flows of air when the ventilation path switch is executing the first mode. Part (b) of FIG. 13 illustrates flows of air when the ventilation path switch is executing the second mode. Note that FIG. 13 omits illustration of valve 36 in a first connected state and valve 36 in a second connected state when the ventilation path switch is in the second mode.

First blower 31a is disposed on the back surface side of seat backrest 13 (on the X-axis negative side). Second blower 31b is provided on the Z-axis negative side of seating portion 11. Note that a position in which second blower 31b is disposed is not limited in particular.

Second vent holes 22 include front-surface vent holes 22a provided in the front surface of seat 10 and other-surface vent hole 22b provided in a surface of seat 10 other than the front surface. In the present embodiment, other-surface vent hole 22b is provided on the Z-axis negative side of seating portion 11 of seat 10, and air in the cabin in the vicinity can be drawn in therefrom. Cooled air blown out by the air-conditioning device provided in the vehicle can be drawn in from other-surface vent hole 22b.

Second seat ventilation path 122 includes front-surface side ventilation path 122a that extends from front-surface vent holes 22a provided in seat backrest 13 up to ventilation path selection switch device 2, and other-surface side ventilation path 122b that reaches seat backrest 13 from other-surface vent hole 22b provided in another surface other than the front surface of seating portion 11 and extends up to ventilation path selection switch device 2. Thus, front-surface vent holes 22a are connected to first blower 31a via front-surface side ventilation path 122a, second opening 42 of ventilation path selection switch device 2, second duct 52, inlet duct 53, and valve 36. Other-surface vent hole 22b is connected to first blower 31a via other-surface side ventilation path 122b and valve 36.

Valve 36 is disposed in the flow path from front-surface vent holes 22a to first blower 31a and in the flow path from other-surface vent hole 22b to first blower 31a. For example, valve 36 may be disposed in second duct 52 disposed in seat backrest 13, may be disposed in inlet duct 53 disposed in seat backrest 13, or may be disposed between inlet duct 53 and first blower 31a. Thus, valve 36 may be disposed in second ventilation path 52a or inlet ventilation path 53a or between inlet ventilation path 53a and first blower 31a.

Valve 36 is an electric valve controlled by controller 32, for example. By being controlled by controller 32, valve 36 is switched between the first connected state in which air passes through front-surface vent holes 22a, the second connected stated in which air is drawn in from other-surface vent hole 22b, and a third connected state in which air is drawn in from front-surface vent holes 22a and other-surface vent hole 22b. Specifically, by being controlled by controller 32, valve 36 can be switched to the first connected state in which the flow path that connects other-surface vent hole 22b and ventilation path selection switch device 2 is closed and the flow path that connects front-surface vent holes 22a and ventilation path selection switch device 2 is connected. In addition, by being controlled by controller 32, valve 36 can be switched to the second connected state in which the flow path that connects front-surface vent holes 22a and ventilation path selection switch device 2 is closed and the flow path that connects other-surface vent hole 22b and ventilation path selection switch device 2 is connected. Furthermore, by being controlled by controller 32, valve 36 can be switched to the third connected state in which the flow path that connects front-surface vent holes 22a and ventilation path selection switch device 2 is connected and the flow path that connects other-surface vent hole 22b and ventilation path selection switch device 2 is connected. Accordingly, controller 32 can switch between the first connected state, the second connected state, and the third connected state by controlling valve 36.

Controller 32 may be able to switch between the first connected state, the second connected state, and the third connected state by controlling valve 36, after a predetermined time has elapsed. Controller 32 may be able to switch between the first connected state, the second connected state, and the third connected state by controlling valve 36 when an onboard sensor detects that a person is seated in seat 10 and leans against seat backrest 13. By a person operating an onboard terminal device, controller 32 may be able to control valve 36 according to a human operation and switch between the first connected state, the second connected state, and the third connected state. Valve 36 may be switched between the first connected state, the second connected state, and the third connected state by a person operating manually.

Here, functions of ventilation path selection switch device 2 and vehicle seat air-conditioning device 1b according to the present embodiment are described.

The ventilation path switch can execute the selected first mode by controller 32 controlling driver 34. In the first mode, controller 32 controls valve 36 to place valve 36 in the first connected state. In the first mode, by first blower 31a, air can be caused to flow into first seat ventilation path 121 from first vent holes 21 of seat 10, can be drawn into inlet ventilation path 53a through first ventilation path 51a from first opening 41, and can be led through inlet ventilation path 53a to reach first blower 31a. By first blower 31a, air can be led to outlet ventilation path 54a, can be caused to pass through second ventilation path 52a and second opening 42, and can be blown out from front-surface vent holes 22a of seat backrest 13 through front-surface side ventilation path 122a (refer to (a) of FIG. 13). Since first vent holes 21 are provided for the upper body of a person seated in seat 10, a person can feel flows of air drawn into first vent holes 21 on the upper body of the person, and can also feel flows of air being blown out from front-surface vent holes 22a of seat backrest 13 onto the back of the person since front-surface vent holes 22a of seat backrest 13 are provided for the back of a person seated in seat 10.

The ventilation path switch can execute the selected second mode by controller 32 controlling driver 34. Furthermore, valve 36 is switched to any of the first connected state, the second connected state, and the third connected state by controller 32 controlling valve 36.

In the second mode, when valve 36 is in the first connected state, air drawn in from front-surface vent holes 22a by first blower 31a can be led to second ventilation path 52a, and the air led to second ventilation path 52a can be blown out by first blower 31a from first vent holes 21 via first ventilation path 51a. Specifically, in the second mode, by first blower 31a, air can be caused to flow into front-surface side ventilation path 122a from front-surface vent holes 22a of seat 10, and can be led to inlet ventilation path 53a through second ventilation path 52a from second opening 42 to reach first blower 31a. By first blower 31a, air can be led to outlet ventilation path 54a, can be caused to pass through first ventilation path 51a and first opening 41, and can be blown out from first vent holes 21 of seat backrest 13 through first seat ventilation path 121. Since front-surface vent holes 22a are provided for the back of a person seated in seat 10, the person can feel flows of air drawn into front-surface vent holes 22a on the back of the person, and can also feel flows of air being blown out from first vent holes 21 onto the upper body of the person since first vent holes 21 are provided for the upper body of a person seated in seat 10.

In the second mode, when valve 36 is in the second connected state, air drawn in from other-surface vent hole 22b by second blower 31b can be led to first blower 31a, and can be blown out by first blower 31a from first vent holes 21 via first ventilation path 51a. Specifically, in the second mode, by second blower 31b, air can be caused to flow into other-surface side ventilation path 122b from other-surface vent holes 22b of seat 10 to reach first blower 31a, and by first blower 31a, air can be led to outlet ventilation path 54a, can be caused to pass through first ventilation path 51a and first opening 41, and can be blown out from first vent holes 21 of seat backrest 13 through first seat ventilation path 121. First vent holes 21 are provided for the upper body of a person seated in seat 10, and thus the person can feel flows of air in the cabin drawn in from other-surface vent hole 22b being blown out from first vent holes 21 onto the upper body of the person. At this time, both second blower 31b and first blower 31a can draw in the air that flows into from other-surface side ventilation path 122b, and thus the flow rate of air drawn into other-surface side ventilation path 122b is made higher than the flow rate of air drawn in from front-surface side ventilation path 122a when valve 36 is in the first connected state, and air having the higher flow rate can be blown out from first vent holes 21.

In the second mode, when valve 36 is in the third connected state, air drawn in from front-surface vent holes 22a by first blower 31a can be led to first blower 31a via second ventilation path 52a, and at the same time, air drawn in from other-surface vent hole 22b by second blower 31b can be led to first blower 31a and can be blown out by first blower 31a from first vent holes 21 via first ventilation path 51a. Specifically, in the second mode, by first blower 31a, air can be caused to flow into front-surface side ventilation path 122a from front-surface vent holes 22a of seat 10 and can be led to inlet ventilation path 53a through second ventilation path 52a from second opening 42 to reach first blower 31a. At the same time, air can be caused to flow into other-surface side ventilation path 122b from other-surface vent hole 22b of seat 10 by second blower 31b to reach first blower 31a. By first blower 31a, air can be led to outlet ventilation path 54a, can be caused to pass through first ventilation path 51a and first opening 41, and can be blown out from first vent holes 21 of seat backrest 13 through first seat ventilation path 121 (refer to (b) of FIG. 13). Since front-surface vent holes 22a are provided for the back of a person seated in seat 10, the person feels the flows of air drawn into front-surface vent holes 22a on the back of the person. Furthermore, since first blower 31a and second blower 31b are being operated, a person seated in seat 10 can feel flows of air being blown out from first vent holes 21 provided for the upper body of the person, strongly onto the upper body of the person.

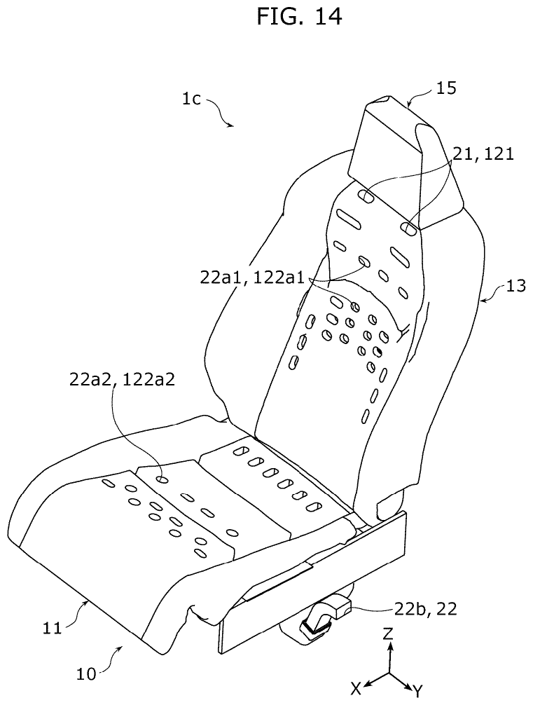

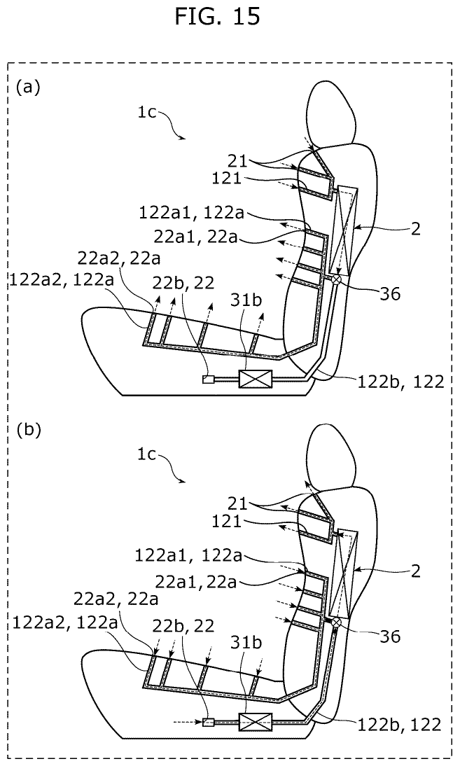

Furthermore, in the present embodiment, second vent holes 22 may also be provided in seating portion 11 of seat 10 in vehicle seat air-conditioning device 1c, as illustrated in FIG. 14 and FIG. 15. In this case, air can be drawn in or blown out also from second vent holes 22 provided in seating portion 11. Note that when elements of ventilation path selection switch device 2 in FIG. 14 and FIG. 15 are the same as the elements of ventilation path selection switch device 2 described with reference to FIG. 1A to FIG. 9, the same reference numerals as the reference numerals used for the above description with reference to FIG. 1A to FIG. 9 are given, and the description is omitted appropriately.

FIG. 14 is a perspective view illustrating an appearance of vehicle seat air-conditioning device 1c that can switch where to draw in air between the front surface of seat 10 and the lateral surface of seat 10. FIG. 15 includes explanatory drawings illustrating flows of air when the ventilation path switch of vehicle seat air-conditioning device 1c that can switch where to draw in air between the front surface of seat 10 and the lateral surface of seat 10 is in the first mode and the second mode. Part (a) of FIG. 15 illustrates flows of air when the ventilation path switch is executing the first mode. Part (b) of FIG. 15 illustrates flows of air when the ventilation path switch is executing the second mode. Note that FIG. 15 omits illustration of valve 36 in the first connected state and valve 36 in the second connected state when the ventilation path switch is in the second mode.

Front-surface side ventilation path 122a includes backrest ventilation path 122a1 that extends from backrest vent holes 22a1 provided in seat backrest 13 up to ventilation path selection switch device 2, and seating-portion ventilation path 122a2 that extends from seating-surface vent holes 22a2 provided in the front surface of seating portion 11 up to ventilation path selection switch device 2. Thus, backrest vent holes 22a1 are connected to first blower 31a via backrest ventilation path 122a1, second opening 42 of ventilation path selection switch device 2, second duct 52, inlet duct 53, and valve 36. Thus, seating-surface vent holes 22a2 are connected to first blower 31a via seating surface ventilation path 122a2, second opening 42 of ventilation path selection switch device 2, second duct 52, inlet duct 53, and valve 36.

Front-surface vent holes 22a include backrest vent holes 22a1 and seating-surface vent holes 22a2. Note that backrest vent holes 22a1 and seating-surface vent holes 22a2 may be collectively referred to as front-surface vent holes 22a.

Here, functions of ventilation path selection switch device 2 and vehicle seat air-conditioning device 1c according to the present embodiment are described.

In the first mode, controller 32 controls valve 36 to place valve 36 in the first connected state. In the first mode, by first blower 31a, air can be caused to flow into first seat ventilation path 121 from first vent holes 21 of seat 10, can be drawn into inlet ventilation path 53a through first ventilation path 51a from first opening 41, and can be led through inlet ventilation path 53a to reach first blower 31a. By first blower 31a, air can be led to outlet ventilation path 54a, can be caused to pass through second ventilation path 52a and second opening 42, and can be blown out from backrest vent holes 22a1 through backrest ventilation path 122a1, and at the same time, air can be blown out from seating-surface vent holes 22a2 via seating-portion ventilation path 122a2. Since first vent holes 21 are provided for the upper body of a person seated in seat 10, a person can feel flows of air drawn into first vent holes 21 on the upper body of the person. At the same time, since backrest vent holes 22a1 of seat backrest 13 are provided for the back of a person seated in seat 10 and seating-surface vent holes 22a2 of seating portion 11 are provided for the buttocks and thighs of a person seated in seat 10, a person can feel flows of air being blown out from front-surface vent holes 22a of seat 10 onto the back, buttocks, and thighs of the person.

In the second mode, when valve 36 is in the first connected state, air drawn in from backrest vent holes 22a1 and seating-surface vent holes 22a2 by first blower 31a can be led to second ventilation path 52a, and the air led to second ventilation path 52a can be blown out by first blower 31a from first vent holes 21 via first ventilation path 51a. Specifically, in the second mode, air can be caused by first blower 31a to flow into backrest ventilation path 122a1 from backrest vent holes 22a1 of seat 10, and at the same time, by first blower 31a, air can be caused to flow into seating-portion ventilation path 122a2 from seating-surface vent holes 22a2, and can be led to inlet ventilation path 53a through second ventilation path 52a from second opening 42 to reach first blower 31a. By first blower 31a, air can be led to outlet ventilation path 54a, and can be caused to pass through first ventilation path 51a and first opening 41, and can be blown out from first vent holes 21 of seat backrest 13 through first seat ventilation path 121. Since backrest vent holes 22a1 are provided for the back of a person seated in seat 10 and seating-surface vent holes 22a2 are provided for the buttocks and thighs of a person seated in seat 10, a person can feel flows of air drawn into front-surface vent holes 22a on the back, buttocks, and thighs of the person, and can also feel flows of air being blown out from first vent holes 21 onto the upper body of the person since first vent holes 21 are provided for the upper body of a person seated in seat 10.

In the second mode, when valve 36 is in the second connected state, air drawn in from other-surface vent hole 22b by second blower 31b can be led to other-surface side ventilation path 122b, and the air led to other-surface side ventilation path 122b can be blown out by first blower 31a from first vent holes 21 via first ventilation path 51a. Specifically, in the second mode, air can be caused by second blower 31b to flow into other-surface side ventilation path 122b from other-surface vent hole 22b of seat 10 to reach first blower 31a. By first blower 31a, air can be led to outlet ventilation path 54a, can be caused to pass through first ventilation path 51a and first opening 41, and can be blown out from first vent holes 21 of seat backrest 13 through first seat ventilation path 121. First vent holes 21 are provided for the upper body of a person seated in seat 10, and thus a person can feel flows of air in the cabin drawn in from other-surface vent hole 22b being blown out from first vent holes 21 onto the upper body of the person. At this time, both second blower 31b and first blower 31a can draw in the air that flows into from other-surface side ventilation path 122b, and thus the flow rate of air drawn into other-surface side ventilation path 122b is made higher than the flow rate of air drawn in from front-surface side ventilation path 122a when valve 36 is in the first connected state, and air having the higher flow rate can be blown out from first vent holes 21.

In the second mode, when valve 36 is in the third connected state, air drawn in from front-surface vent holes 22a by first blower 31a can be led to first blower 31a via second ventilation path 52a, and at the same time, air drawn in from other-surface vent hole 22b by second blower 31b can be led to first blower 31a and can be blown out by first blower 31a from first vent holes 21 via first ventilation path 51a. Specifically, in the second mode, by first blower 31a, air can be caused to flow into backrest ventilation path 122a1 from backrest vent holes 22a1 of seat 10 and at the same time, can be caused to flow into seating-portion ventilation path 122a2 from seating-surface vent holes 22a2, and can be led to inlet ventilation path 53a through second ventilation path 52a from second opening 42 to reach first blower 31a. At the same time, air can be caused to flow into other-surface side ventilation path 122b from other-surface vent hole 22b of seat 10 by second blower 31b to reach first blower 31a. By first blower 31a, air can be led to outlet ventilation path 54a, can be caused to pass through first ventilation path 51a and first opening 41, and can be blown out from first vent holes 21 of seat backrest 13 through first seat ventilation path 121 (refer to (b) of FIG. 15). Since backrest vent holes 22a1 are provided for the back of a person seated in seat 10 and seating-surface vent holes 22a2 are provided for the buttocks and thighs of a person seated in seat 10, a person can feel flows of air drawn into front-surface vent holes 22a on the back, buttocks, and thighs of the person. Furthermore, since first blower 31a and second blower 31b are being operated, a person seated in seat 10 can feel flows of air being blown out from first vent holes 21 provided for the upper body of a person, strongly onto the upper body of the person.

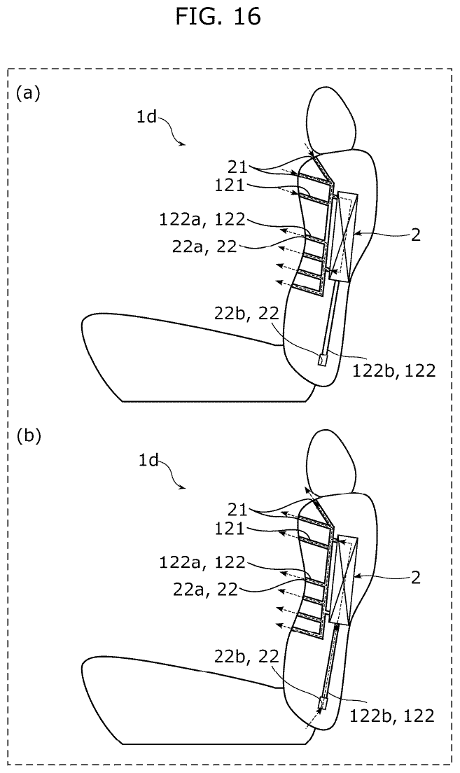

Furthermore, in the present embodiment, as illustrated in FIG. 16, in vehicle seat air-conditioning device 1d, second vent holes 22 of vehicle seat air-conditioning device 1d may include front-surface vent holes 22a provided in the front surface of seat backrest 13 and other-surface vent holes 22b provided in a surface other than the front surface of seat 10. Note that when elements of ventilation path selection switch device 2 in FIG. 16 are the same as the elements of ventilation path selection switch device 2 described with reference to FIG. 1A to FIG. 9, the same reference numerals as the reference numerals used for the above description with reference to FIG. 1A to FIG. 9 are given, and the description is omitted appropriately. For example, blower 31 of ventilation path selection switch device 2 in FIG. 16 is the same as blower 31 in FIG. 1A to FIG. 9.

FIG. 16 includes explanatory drawings illustrating flows of air when the ventilation path switch of vehicle seat air-conditioning device 1d that can draw in air from the lateral surface of seat 10 and blow out air from the front surface of seat backrest 13 is in the first mode and the second mode. Part (a) of FIG. 16 illustrates flows of air when the ventilation path switch is executing the first mode. Part (b) of FIG. 16 illustrates flows of air when the ventilation path switch is executing the second mode.

In this case, second seat ventilation path 122 includes front-surface side ventilation path 122a that extends from front-surface vent holes 22a provided in seat backrest 13 up to ventilation path selection switch device 2, and other-surface side ventilation path 122b that extends from other-surface vent hole 22b provided in another surface other than the front surface of seat 10. Thus, front-surface vent holes 22a are connected to blower 31 via front-surface side ventilation path 122a, second opening portion 42 of ventilation path selection switch device 2, second duct 52, and inlet duct 53. Other-surface vent hole 22b is connected to blower 31 via other-surface side ventilation path 122b.

First seat ventilation path 121 and second seat ventilation path 122 may be connected to each other. Thus, first opening 41 of ventilation path selection switch device 2 may be connected to first seat ventilation path 121 and second seat ventilation path 122, and second opening 42 of ventilation path selection switch device 2 may also be connected to first seat ventilation path 121 and second seat ventilation path 122. In this case, first opening 41 is provided in a position closer to first seat ventilation path 121 than to second seat ventilation path 122 and second opening 42 is provided in a position closer to second seat ventilation path 122 than to first seat ventilation path 121, and thus in the first mode, air drawn in mainly from first vent holes 21 passes through first seat ventilation path 121 and air to be blown out from second vent holes 22 passes through second seat ventilation path 122. In the second mode, air is drawn in mainly from other-surface vent hole 22b having less intake resistance, and thus air blown out from first opening 41 passes through first seat ventilation path 121 and is blown out from first vent holes 21, and at the same time, passes through front-surface side ventilation path 122a and is blown out from front-surface vent holes 22a. Note that other-surface vent hole 22b has a larger diameter than that of front-surface vent holes 22a, and thus has less intake resistance than that of front-surface vent holes 22a.

Here, functions of ventilation path selection switch device 2 and vehicle seat air-conditioning device 1d according to the present embodiment are described.

In the first mode, air drawn in by blower 31 from first vent holes 21 is led to first ventilation path 51a and is blown out from front-surface vent holes 22a via front-surface side ventilation path 122a. Specifically, in the first mode, blower 31 can cause air to flow into first seat ventilation path 121 (provided in a position close to first opening 41) from first vent holes 21 of seat 10 and air to be drawn into inlet ventilation path 53a through first ventilation path 51a from first opening 41. Air can be led through inlet ventilation path 53a and reach blower 31. Air can be led by blower 31 to outlet ventilation path 54a, and pass through second ventilation path 52a and second opening 42. Then, air can be blown out from front-surface vent holes 22a through front-surface side ventilation path 122a provided in a position close to second opening 42.

The ventilation path switch can execute the selected second mode by controller 32 controlling driver 34. In the second mode, air drawn in by blower 31 from other-surface vent hole 22b having less intake resistance can be led to other-surface side ventilation path 122b, and the air led to other-surface side ventilation path 122b can be blown out by blower 31 from front-surface vent holes 22a via front-surface side ventilation path 122a while being blown out by blower 31 from first vent holes 21 via first ventilation path 51a. Specifically, in the second mode, air can be caused by blower 31 to flow into other-surface side ventilation path 122b from other-surface vent hole 22b of seat 10 to reach blower 31. By blower 31, air can be led to outlet ventilation path 54a, can be caused to pass through first ventilation path 51a and first opening 41, and can be blown out from front-surface vent holes 22a via front-surface side ventilation path 122a while being blown out by blower 31 from first vent holes 21 through first seat ventilation path 121. First vent holes 21 are provided for the upper body of a person seated in seat 10, and thus a person can feel flows of air being blown out from first vent holes 21 onto the upper body. Furthermore, front-surface vent holes 22a are provided for the back of a person seated in seat 10, and thus a person can feel flows of air being blown out from front-surface vent holes 22a onto the back of the person.

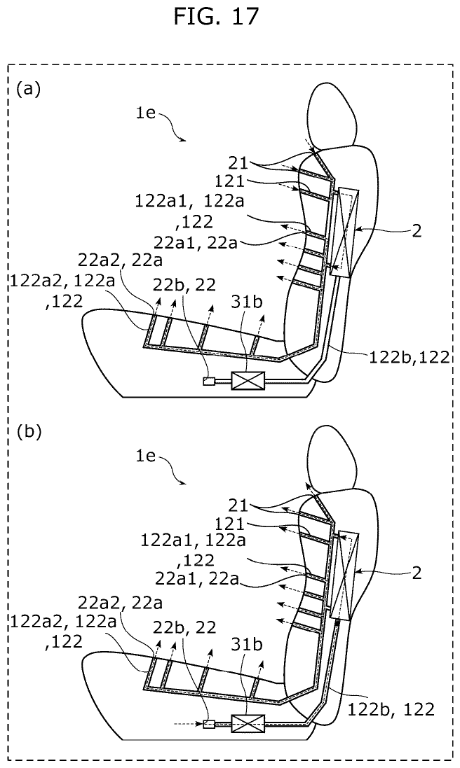

Furthermore, in the present embodiment, vehicle seat air-conditioning device 1e in FIG. 17 may be vehicle seat air-conditioning device 1d in FIG. 16 having a configuration in which blower 31 includes first blower 31a and second blower 31b. When elements of ventilation path selection switch device 2 in FIG. 17 are the same as the elements of ventilation path selection switch device 2 described with reference to FIG. 1A to FIG. 9, the same reference numerals as the reference numerals used for the above description with reference to FIG. 1A to FIG. 9 are given, and the description is omitted appropriately.

FIG. 17 includes explanatory drawings illustrating flows of air when the ventilation path switch of vehicle seat air-conditioning device 1e that can draw in air from the lateral surface of seat 10 and blow out air from the front surface of seat 10 is in the first mode and the second mode. Part (a) of FIG. 17 illustrates flows of air when the ventilation path switch is executing the first mode. Part (b) of FIG. 17 illustrates flows of air when the ventilation path switch is executing the second mode.

First blower 31a is disposed on the back surface side of seat backrest 13 (on the X-axis negative side). Second blower 31b is provided on the Z-axis negative side of seating portion 11. Note that a position in which second blower 31b is disposed is not limited in particular.

Plural second vent holes 22 may be provided in seating portion 11 of seat 10. In this case, air can also be blown out from second vent holes 22 provided in seating portion 11.

Second vent holes 22 include front-surface vent holes 22a provided in the front surface of seat 10 and other-surface vent hole 22b provided in a surface of seat 10 other than the front surface. In the present embodiment, other-surface vent hole 22b is provided on the Z-axis negative side of seating portion 11 of seat 10, and air in the cabin in the vicinity can be drawn in therefrom.

Second seat ventilation path 122 includes front-surface side ventilation path 122a that extends from front-surface vent holes 22a provided in seat backrest 13 up to ventilation path selection switch device 2, and other-surface side ventilation path 122b that reaches seat backrest 13 from other-surface vent hole 22b provided in a surface other than the front surface of seating portion 11. Thus, front-surface vent holes 22a are connected to first blower 31a via front-surface side ventilation path 122a, second opening 42 of ventilation path selection switch device 2, second duct 52, and inlet duct 53. Other-surface vent hole 22b is connected to first blower 31a included in ventilation path selection switch device 2 via other-surface side ventilation path 122b.

Front-surface side ventilation path 122a includes backrest ventilation path 122a1 that extends from backrest vent holes 22a1 provided in seat backrest 13 up to ventilation path selection switch device 2, and seating-portion ventilation path 122a2 that extends from seating-surface vent holes 22a2 provided in the front surface of seating portion 11 up to ventilation path selection switch device 2. Thus, backrest vent holes 22a1 are connected to first blower 31a via backrest ventilation path 122a1, second opening portion 42 of ventilation path selection switch device 2, second duct 52, and inlet duct 53. Thus, seating-surface vent holes 22a2 are connected to first blower 31a via seating-portion ventilation path 122a2, second opening portion 42 of ventilation path selection switch device 2, second duct 52, and inlet duct 53.

Front-surface vent holes 22a include backrest vent holes 22a1 and seating-surface vent holes 22a2. Note that backrest vent holes 22a1 and seating-surface vent holes 22a2 may be collectively referred to as front-surface vent holes 22a.

Here, functions of ventilation path selection switch device 2 and vehicle seat air-conditioning device 1e according to the present embodiment are described.

In the first mode, air drawn in from first vent holes 21 by first blower 31a can be led to first ventilation path 51a and can be blown out from front-surface vent holes 22a via front-surface side ventilation path 122a. Specifically, in the first mode, by first blower 31a, air can be caused to flow into first seat ventilation path 121 (provided in a position close to first opening 41) from first vent holes 21 of seat 10, can be drawn into inlet ventilation path 53a through first ventilation path 51a from first opening 41, and can be led through inlet ventilation path 53a to reach first blower 31a. By first blower 31a, air can be led to outlet ventilation path 54a, can be caused to pass through second ventilation path 52a and second opening 42, and can be blown out from backrest vent holes 22a1 in seat backrest 13 and seating-surface vent holes 22a2 in seating portion 11 through front-surface side ventilation path 122a provided in a position close to second opening 42. At this time, since second blower 31b is stopped, second blower 31b itself serves as a resistor of the flow of air in other-surface side ventilation path 122b, and thus hardly no air is blown out from other-surface vent hole 22b. Since first vent holes 21 are provided for the upper body of a person seated in seat 10, a person feels flows of air drawn into first vent holes 21 on the upper body of the person. Since backrest vent holes 22a1 of seat backrest 13 are provided for the back of a person seated in seat 10 and seating surface vent holes 22a2 of seating portion 11 are provided for the buttocks and thighs of a person seated in seat 10, a person can feel flows of air being blown out from front-surface vent holes 22a of seat 10 onto the back, buttocks, and thighs of the person.

In the second mode, air drawn in by second blower 31b from other-surface vent hole 22b is led to other-surface side ventilation path 122b, and the air led to other-surface side ventilation path 122b can be blown out by first blower 31a from front-surface vent holes 22a via front-surface side ventilation path 122a while being blown out by first blower 31a from first vent holes 21 via first ventilation path 51a. Specifically, in the second mode, air can be caused by second blower 31b to flow into other-surface side ventilation path 122b from other-surface vent hole 22b of seat 10 to reach first blower 31a, and by first blower 31a, air can be led to outlet ventilation path 54a, can be caused to pass through first ventilation path 51a and first opening 41, can be blown out from first vent holes 21 of seat backrest 13 via first seat ventilation path 121, and at the same time, can be blown out from backrest vent holes 22a1 of seat backrest 13 via backrest ventilation path 122a1, and also at the same time, can be blown out from seating-surface vent holes 22a2 further via seating-portion ventilation path 122a2. This is because air having a high flow rate is drawn in by both second blower 31b and first blower 31a from other-surface vent hole 22b, and thus blowing out air from first vent holes 21, backrest vent holes 22a1, and seating-surface vent holes 22a2 is more dominant than drawing in air therefrom. First vent holes 21 are provided for the upper body of a person seated in seat 10, and thus a person can feel flows of air being blown out from first vent holes 21 onto the upper body of the person. Since backrest vent holes 22a1 are provided for the back of a person seated in seat 10 and seating surface vent holes 22a2 are provided for the buttocks and thighs of a person seated in seat 10, a person can feel flows of air being blown out from backrest vent holes 22a1 and seating-surface vent holes 22a2 onto the back, buttocks, and thighs of the person.

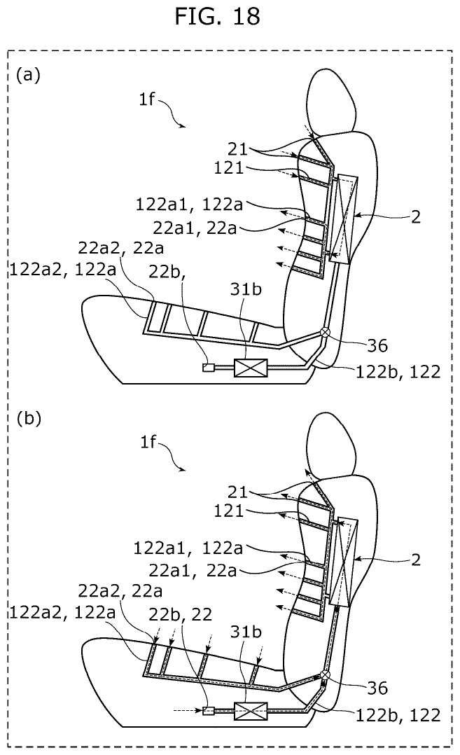

Furthermore, in the present embodiment, vehicle seat air-conditioning device 1f in FIG. 18 may be vehicle seat air-conditioning device 1e in FIG. 17 that further includes valve 36. Note that when elements of ventilation path selection switch device 2 in FIG. 18 are the same as the elements of ventilation path selection switch device 2 described with reference to FIG. 1A to FIG. 9, the same reference numerals as the reference numerals used for the above description with reference to FIG. 1A to FIG. 9 are given, and the description is omitted appropriately.

FIG. 18 includes explanatory drawings illustrating flows of air when the ventilation path switch of vehicle seat air-conditioning device 1f that can switch where to draw in air between the front surface of seat 10 and the lateral surface of seat 10 and can blow out air from the front surface of seat backrest 13 is in the first mode and the second mode. Part (a) of FIG. 18 illustrates flows of air when the ventilation path switch is executing the first mode. Part (b) of FIG. 18 illustrates flows of air when the ventilation path switch is executing the second mode. Note that FIG. 18 omits illustration of valve 36 in a fifth connected state and valve 36 in a sixth connected state when the ventilation path switch is in the second mode.

Valve 36 is disposed in a flow path from seating-surface vent holes 22a2 up to ventilation path selection switch device 2 and in a flow path from other-surface vent holes 22b up to ventilation path selection switch device 2. For example, valve 36 may be provided separately from ventilation path selection switch device 2. Note that valve 36 may be provided in ventilation path selection switch device 2. For example, valve 36 may be provided in second duct 52 disposed in seat backrest 13, may be provided in inlet duct 53 disposed in seat backrest 13, or may be provided between inlet duct 53 and first blower 31a.

Also in vehicle seat air-conditioning device 1f, second vent holes 22 include backrest vent holes 22a1 provided in the front surface of seat backrest 13, seating-surface vent holes 22a2 provided in the front surface of seating portion 11, and other-surface vent hole 22b provided in a surface of seat 10 other than the front surface.

Second ventilation path 52a includes backrest ventilation path 122a1 connected to backrest vent holes 22a1, seating-portion ventilation path 122a2 connected to seating-surface vent holes 22a2, and other-surface side ventilation path 122b connected to other-surface vent hole 22b.

Valve 36 is an electric valve controlled by controller 32, for example. By being controlled by controller 32, valve 36 is switched between a fourth connected state in which air is not drawn in from seating-surface vent holes 22a2 or other-surface vent hole 22b and air is drawn in from first vent holes 21, the fifth connected state in which air is drawn in from seating-surface vent holes 22a2, the sixth connected state in which air is drawn in from other-surface vent hole 22b, and a seventh connected state in which air is drawn in from seating-surface vent holes 22a2 and other-surface vent hole 22b. Specifically, by being controlled by controller 32, valve 36 can be switched to the fourth connected state in which the flow path that connects seating-surface vent holes 22a2 and ventilation path selection switch device 2 is closed, the flow path that connects other-surface vent hole 22b and ventilation path selection switch device 2 is closed, and air flows from first vent holes 21 to ventilation path selection switch device 2. Furthermore, by being controlled by controller 32, valve 36 can be switched to the fifth connected state in which the flow path that connects other-surface vent hole 22b and ventilation path selection switch device 2 is closed and the flow path that connects seating-surface vent holes 22a2 and ventilation path selection switch device 2 is connected. By being controlled by controller 32, valve 36 can be switched to the sixth connected state in which the flow path that connects seating-surface vent holes 22a2 and ventilation path selection switch device 2 is closed and the flow path that connects other-surface vent hole 22b and ventilation path selection switch device 2 is connected. Furthermore, by being controlled by controller 32, valve 36 can be switched to the seventh connected state in which the flow path that connects seating-surface vent holes 22a2 and ventilation path selection switch device 2 is connected and the flow path that connects other-surface vent hole 22b and ventilation path selection switch device 2 is connected. Accordingly, controller 32 can switch between the fourth connected state, the fifth connected state, the sixth connected state, and the seventh connected state by controlling valve 36.

Here, functions of ventilation path selection switch device 2 and vehicle seat air-conditioning device 1f according to the present embodiment are to be described.

In the first mode, controller 32 controls valve 36 to place valve 36 in the fourth connected state. In the first mode, air drawn in by first blower 31a from first vent holes 21 is led to first ventilation path 51a and blown out from backrest vent holes 22a1 via backrest ventilation path 122a1. Specifically, in the first mode, by first blower 31a, air can be caused to flow into first seat ventilation path 121 from first vent holes 21 of seat 10, can be drawn into inlet ventilation path 53a through first ventilation path 51a from first opening 41, and can be led through inlet ventilation path 53a to reach first blower 31a. By first blower 31a, air can be led to outlet ventilation path 54a, can be caused to pass through second ventilation path 52a and second opening 42, and can be blown out from backrest vent holes 22a1 through backrest ventilation path 122a1. Since first vent holes 21 are provided for the upper body of a person seated in seat 10, a person can feel flows of air drawn into first vent holes 21 on the upper body of the person, and can also feel flows of air being blown out from front-surface vent holes 22a of seat backrest 13 onto the back of the person since front-surface vent holes 22a of seat backrest 13 are provided for the back of a person seated in seat 10.

In the second mode, when valve 36 is in the fifth connected state, air drawn in from seating surface vent holes 22a2 by first blower 31a can be led to seating-portion ventilation path 122a2, and the air led to seating-portion ventilation path 122a2 can be blown out by first blower 31a from backrest vent holes 22a1 via backrest ventilation path 122a1 while being blown out by first blower 31a from first vent holes 21 via first ventilation path 51a. Specifically, in the second mode, air can be caused by first blower 31a to flow into seating-portion ventilation path 122a2 from seating-surface vent holes 22a2 to reach first blower 31a. By first blower 31a, the air can be led to outlet ventilation path 54a, can be caused to pass through first ventilation path 51a and first opening 41, can be blown out from first vent holes 21 of seat backrest 13 through first seat ventilation path 121, and can be blown out from backrest vent holes 22a1 of seat backrest 13 through backrest ventilation path 122a1. Note that as is clear from, for example, FIG. 14, seating-surface vent holes 22a2 provided are greater in number than backrest vent holes 22a1. Thus, a total area of seating-surface vent holes 22a2 (a total opening area of seating-surface vent holes 22a2) is larger than the total area of backrest vent holes 22a1, and thus air is mainly drawn in from seating-surface vent holes 22a2. On the other hand, backrest vent holes 22a1 are closer to first seat ventilation path 121 than to seating-portion ventilation path 122a2, and thus the amount of air from first seat ventilation path 121 that reaches backrest ventilation path 122a1 is larger than the amount of air drawn in from backrest vent holes 22a1. As a result, air is blown out from backrest vent holes 22a1. Since seating-surface vent holes 22a2 are provided for the buttocks and thighs of a person seated in seat 10, a person can feel flows of air drawn into seating-surface vent holes 22a2 on the buttocks and thighs of the person, and can also feel flows of air being blown out from first vent holes 21 and backrest vent holes 22a1 onto the upper body and back of the person since first vent holes 21 are provided for the upper body of a person seated in seat 10 and backrest vent holes 22a1 are provided for the back of a person seated in seat 10.

In the second mode, when valve 36 is in the sixth connected state, air drawn in by second blower 31b from other-surface vent hole 22b can be led to other-surface side ventilation path 122b, and the air led to other-surface side ventilation path 122b can be blown out by first blower 31a from backrest vent holes 22a1 via backrest ventilation path 122a1 while being blown out by first blower 31a from first vent holes 21 via first ventilation path 51a. Specifically, in the second mode, by second blower 31b, air can be caused to flow into other-surface side ventilation path 122b from other-surface vent hole 22b to reach first blower 31a, and by first blower 31a, air can be led to outlet ventilation path 54a, can be caused to pass through first ventilation path 51a and first opening 41, can be blown out from first vent holes 21 of seat backrest 13 through first seat ventilation path 121, and can be blown out from backrest vent holes 22a1 of seat backrest 13 via backrest ventilation path 122a1. Since seating-surface vent holes 22a2 are provided for the buttocks and thighs of a person seated in seat 10, a person can feel flows of air drawn into seating-surface vent holes 22a2 on the buttocks and thighs of the person, and can also feel flows of air being blown out from first vent holes 21 and backrest vent holes 22a1 onto the upper body and the back of the person, since first vent holes 21 are provided for the upper body of a person seated in seat 10 and backrest vent holes 22a1 are provided for the back of a person seated in seat 10.

In the second mode, when valve 36 is in the seventh connected state, air drawn in by second blower 31b from other-surface vent hole 22b can be led to other-surface side ventilation path 122b while air drawn in by first blower 31a from seating-surface vent holes 22a2 is led to seating-portion ventilation path 122a2, and the air led to seating-portion ventilation path 122a2 and the air led to other-surface side ventilation path 122b can be blown out by first blower 31a from backrest vent holes 22a1 via backrest ventilation path 122a1 while being blown out by first blower 31a from first vent holes 21 via first ventilation path 51a (refer to (b) of FIG. 18). Specifically, in the second mode, air can be caused by first blower 31a to flow into seating-portion ventilation path 122a2 from seating-surface vent holes 22a2 to reach first blower 31a, and at the same time, air can be caused by second blower 31b to flow into other-surface side ventilation path 122b from other-surface vent hole 22b to reach first blower 31a. By first blower 31a, air can be led to outlet ventilation path 54a, can be caused to pass through first ventilation path 51a and first opening 41, can be blown out from first vent holes 21 of seat backrest 13 through first seat ventilation path 121, and can be blown out from backrest vent holes 22a1 of seat backrest 13 through backrest ventilation path 122a1. Since seating-surface vent holes 22a2 are provided for the buttocks and thighs of a person seated in seat 10, a person can feel flows of air drawn into seating-surface vent holes 22a2 on the buttocks and thighs of the person. First vent holes 21 are provided for the upper body of a person seated in seat 10, backrest vent holes 22a1 are provided for the back of a person seated in seat 10, and thus when first blower 31a and second blower 31b are operating, a person can feel flows of air being blown out from first vent holes 21 and backrest vent holes 22a1, strongly onto the upper body and the back of the person.

### Embodiment 2

### [Configuration of Vehicle Seat Air-Conditioning Device]

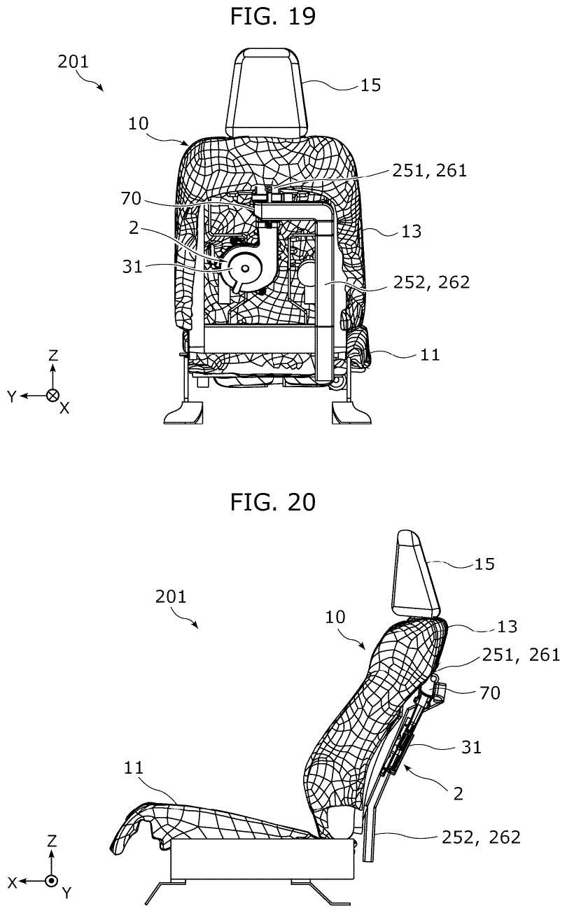

First, a configuration of vehicle seat air-conditioning device 201 according to the present embodiment is to be described with reference to FIG. 19 to FIG. 23.

FIG. 19 is a view from the back of vehicle seat air-conditioning device 201. FIG. 20 is a view from the side of vehicle seat air-conditioning device 201.

Vehicle seat air-conditioning device 201 provided in, for instance, a vehicle can cool and warm a person seated in seat 10 by blowing air toward the upper half of the body of the person from behind. Specifically, vehicle seat air-conditioning device 201 can cool and warm the body of a person seated in seat 10 by drawing in air in the cabin and blowing the air drawn in toward the head, neck, shoulders, and back, for instance, that are the upper body of the person.

Vehicle seat air-conditioning device 201 illustrated in FIG. 19 and FIG. 20 includes seat 10 and ventilation path selection switch device 2 that selects a ventilation path through which air passes.

Seat 10 includes seating portion 11 for a person to sit, seat backrest 13, and headrest 15.

Seating portion 11 is a seat cushion that supports, for instance, buttocks and thighs of a person seated in seat 10. Seating portion 11 includes a first seat pad that corresponds to a cushion material, and a first seat cover that covers the first seat pad.

The first seat pad is made of a cushion material such as, for example, urethane foam. The first seat pad is in a substantially quadrilateral plate shape having a thickness, and is disposed in an orientation in which the first seat pad tilts with respect to the X-Y plane at a predetermined angle. The first seat cover covers the first seat pad. The first seat cover is a leather cover or a fabric cover, for example.

Seat backrest 13 is a backrest portion against which a person seated in seat 10 leans and that supports the shoulders, the back, and the waist of the person. Seat backrest 13 is elongated in the Z-axis direction, and disposed rising from seating portion 11. Seat backrest 13 can adjust the backrest angle by rotating about the Y axis according to the posture of the person. Seat backrest 13 includes a second seat pad that corresponds to a cushion material, and a second seat cover that covers the second seat pad.

The second seat pad is made of a cushion material such as, for example, urethane foam. The second seat pad is in a substantially quadrilateral plate shape having a thickness. The second seat cover covers the second seat pad. The second seat cover is a leather cover or a fabric cover, for example.

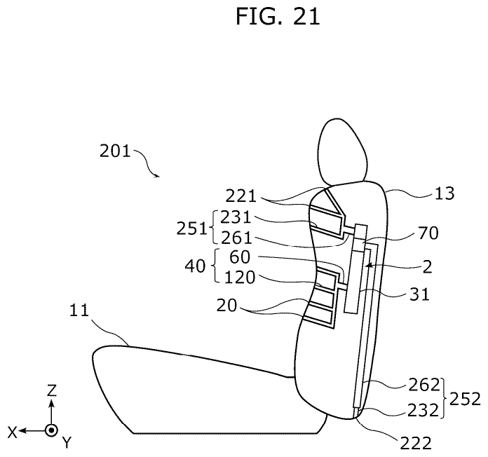

Note that the orientation of seat backrest 13 of seat 10 changes and, for example, the orientation that tilts approximately 20 degrees with respect to the Z-axis direction is a normal position. But, in the present embodiment, a description is given assuming the case in which seat backrest 13 is substantially upright in the Z-axis direction with respect to seating portion 11 is assumed as illustrated in FIG. 21 later described.

FIG. 21 is a schematic diagram illustrating ventilation paths, for instance, of vehicle seat air-conditioning device 201.

As illustrated in FIG. 21, inlets 20, first outlets 221, and second outlet 222 are provided in seat 10 of a vehicle. FIG. 21 illustrates an example in which plural inlets 20 and plural first outlets 221 are provided in seat 10.

Inlets 20 are openings through which air in the vehicle is drawn in. Inlets 20 are provided below first outlets 221 later described, or stated differently, provided below first outlets 221 in the vertical direction. Inlets 20 are provided in a center portion of seat backrest 13, which is a region for the back of a person seated in seat 10. Inlets 20 in this example are provided in the front surface of seat backrest 13 of the vehicle.

First outlets 221 are outlets through which air is blown out onto a person seated in seat 10 to cool and warm the body of the person. First outlets 221 are provided in an upper portion of seat backrest 13. Specifically, first outlets 221 are provided above the central axis that bisects the longer direction (on the Z-axis positive side) when seat backrest 13 is viewed from the side surface (viewed in the Y-axis direction). First outlets 221 are provided in a region for the upper body of a person seated in seat 10. The upper body of a person includes the neck, the head, and the shoulders of the person, for example. First outlets 221 in this example are provided in the front surface and the upper surface of seat backrest 13 that are examples of the surface of seat 10.

Second outlet 222 is an outlet through which air warmed while passing through the inside of seat 10 in an initial operation stage in which cooling is insufficient is blown out without giving discomfort to a person in a front seat and to a person in a rear seat, for example. Second outlet 222 is provided more rearward than the back surface of seat backrest 13 or seating portion 11. Note that being more rearward than seating portion 11 means when coordinates are compared in the front-and-rear direction (the X-axis direction), coordinates are on the X-axis negative side with respect to the coordinates of seating portion 11, so that the rear side behind seat backrest 13 is included, for example. Second outlet 222 in this example is provided in the back surface of seat backrest 13 that is an example of the surface of seat 10.

Second outlet 222 is provided in a lower position than first outlets 221. Second outlet 222 in this example is provided in a lower position than the upper surface of seating portion 11.

As illustrated in FIG. 19 and FIG. 20, ventilation path selection switch device 2 is provided on the back surface side (the X-axis negative side) of seat backrest 13. Ventilation path selection switch device 2 is housed in a recessed portion on the back surface side of seat backrest 13.

As illustrated in FIG. 21, seat 10 includes inlet seat ventilation path 120 connected to inlets 20, first seat ventilation path 231 connected to first outlets 221, and second seat ventilation path 232 connected to second outlet 222. Inlet seat ventilation path 120 is a flow path from inlets 20 to ventilation path selection switch device 2. First seat ventilation path 231 is a flow path from first outlets 221 to ventilation path selection switch device 2. Second seat ventilation path 232 is a flow path from second outlet 222 to ventilation path selection switch device 2.

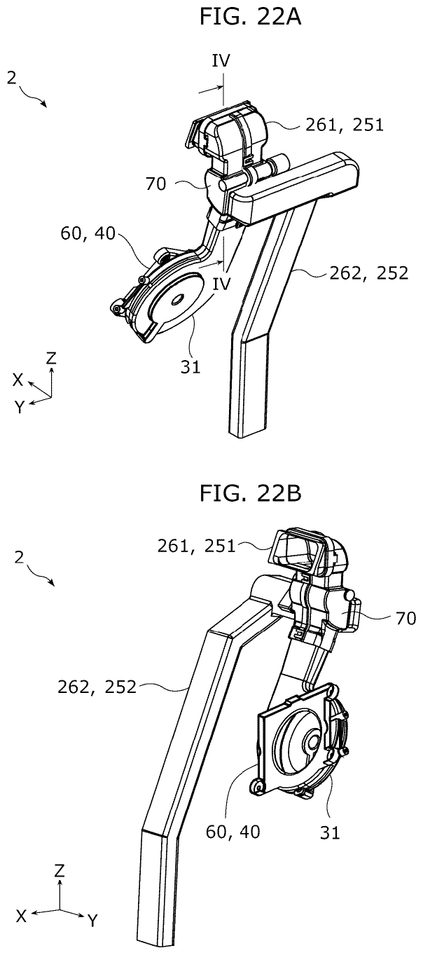

FIG. 22A is a perspective view illustrating ventilation path selection switch device 2 of vehicle seat air-conditioning device 201. FIG. 22B is a perspective view illustrating ventilation path selection switch device 2 in a direction different from the view in FIG. 22A.

As illustrated in FIG. 22A and FIG. 22B, ventilation path selection switch device 2 includes blower 31, inlet duct ventilation path 60 connected to an intake port of blower 31, switch 70 connected to an exhaust port of blower 31, and first duct ventilation path 261 and second duct ventilation path 262 that are connected to switch 70.

As illustrated in FIG. 21, inlet duct ventilation path 60 is connected to inlet seat ventilation path 120 described above, first duct ventilation path 261 is connected to first seat ventilation path 231 described above, and second duct ventilation path 262 is connected to second seat ventilation path 232 described above.

In the following, a ventilation path that includes inlet seat ventilation path 120 and inlet duct ventilation path 60 is referred to as inlet ventilation path 40. A ventilation path that includes first seat ventilation path 231 and first duct ventilation path 261 is referred to as first duct 251, and a ventilation path that includes second seat ventilation path 232 and second duct ventilation path 262 is referred to as second duct 252. Note that when second duct 252 includes only second duct ventilation path 262 without second seat ventilation path 232 being provided, a tip of second duct ventilation path 262 may be directly connected to second outlet 222.

Inlet ventilation path 40 is an airway that connects inlets 20 and blower 31, and is provided between inlets 20 in the front surface of seat backrest 13 and the intake port of blower 31. With the operation of blower 31, inlet ventilation path 40 leads air drawn in from inlets 20 in the vehicle to blower 31.

Blower 31 is a device for intake and emission of air. The intake port of blower 31 is connected to inlet ventilation path 40, and the exhaust port of blower 31 is connected to switch 70. Blower 31 draws in air via inlet ventilation path 40, and sends out the air drawn in to switch 70.

Note that when inlet ventilation path 40 includes only inlet seat ventilation path 120 without inlet duct ventilation path 60 being provided, the intake port of blower 31 may be directly connected to inlet seat ventilation path 120. Blower 31 and switch 70 are not necessarily directly connected to each other, and another duct-shaped ventilation path may be provided between blower 31 and switch 70.

Switch 70 switches the destination of air sent out from blower 31 to first duct 251 or to second duct 252. Switch 70 is disposed between the exhaust port of blower 31 and first duct 251 and between the exhaust port of blower 31 and second duct 252.

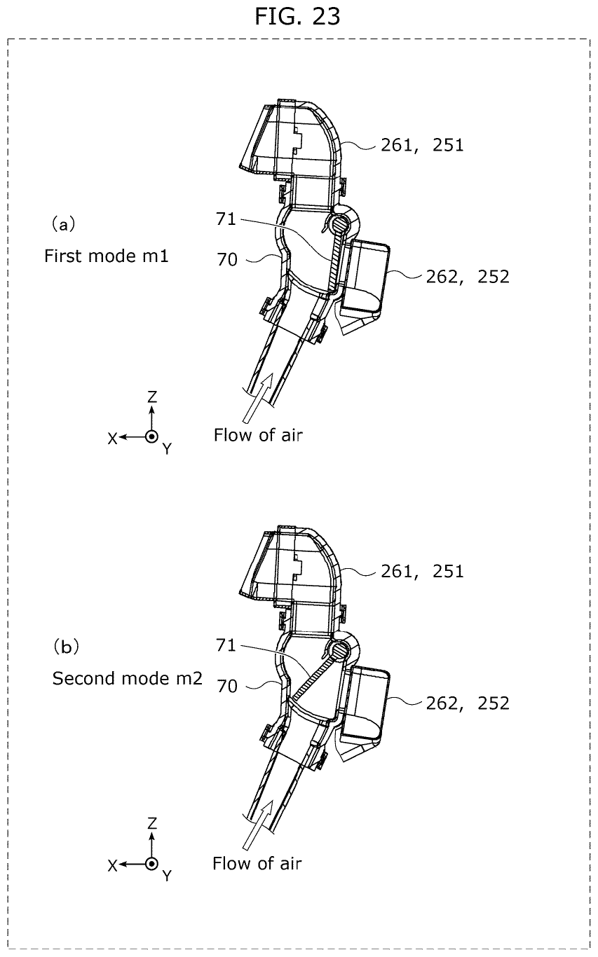

FIG. 23 illustrates switch 70 of ventilation path selection switch device 2. FIG. 23 illustrates cross sections of switch 70 taken along line IV-IV in FIG. 22A.

Part (a) of FIG. 23 illustrates a state in which first duct 251 is open and second duct 252 is closed. Part (b) of FIG. 23 illustrates a state in which second duct 252 is open and first duct 251 is closed.

Switch 70 includes movable plate 71 that opens and closes first duct 251 and second duct 252. Movable plate 71 is rotatably supported around a rotation axis extending in the lateral direction of the vehicle. Movable plate 71 closes the opening of first duct 251 and opens the opening of second duct 252, to introduce air sent out from blower 31 to second duct 252. Movable plate 71 closes the opening of second duct 252 and opens the opening of first duct 251, to introduce air sent out from blower 31 to first duct 251.

Note that when first duct 251 is to be opened, movable plate 71 is in a state of retracting from the air-sending route along first duct 251 to avoid overlapping the air-sending route along first duct 251. In the retracting state, movable plate 71 is disposed along the inner wall of a duct that defines first duct 251. In such a manner, switch 70 switches the destination for sending air between first duct 251 and second duct 252, based on a control command from a controller.

As illustrated in FIG. 2, for instance, vehicle seat air-conditioning device 201 includes blower 31, controller 32, power supply 33, and driver 34. Blower 31, driver 34, and power supply 33 are connected to controller 32. Blower 31 is a portion of the configuration of ventilation path selection switch device 2 described above.

Power supply 33 is a power supply circuit that supplies power to controller 32, blower 31, and driver 34. Power supply 33 adjusts current to be supplied to blower 31 and current to be supplied to driver 34, by being controlled by controller 32.

Controller 32 is a device that controls the operation of blower 31 and the operation of switch 70. Controller 32 controls the amount air drawn in and the amount of air blown out (the air volume), by controlling blower 31. Controller 32 controls operation of switch 70 by controlling driver 34.

Driver 34 is an electric motor, for example, and is connected to movable plate 71 of switch 70. Driver 34 rotates movable plate 71 and opens and closes first duct 251 and second duct 252, by being controlled by controller 32.

In vehicle seat air-conditioning device 201, controller 32 causes driver 34 to operate to switch the destination of air sent out by blower 31 between first duct 251 and second duct 252.

First duct 251 is an airway that connects switch 70 and first outlets 221. One end of first duct 251 that is the root is connected to switch 70 and other ends thereof that are the tips are connected to first outlets 221. First duct 251 leads air sent out from blower 31 via switch 70 to first outlets 221.

Through first duct 251, air sent out from blower 31 via switch 70 is blown out in at least one of a forward direction or an obliquely forward direction of seat 10 from first outlets 221. In this example, first seat ventilation path 231 is disposed obliquely upward. Accordingly, air blown out from first outlets 221 is blown out in an obliquely forward direction between the forward direction and the upward direction. Note that air blown out from first outlets 221 may be blown out in an obliquely forward direction between the forward direction and the downward direction. The direction in which air is blown out from first outlets 221 may include forward vector components.

Second duct 252 is an airway that connects switch 70 and second outlet 222. One end of second duct 252 that is the root is connected to switch 70 and another end thereof that is the tip is connected to second outlet 222. Second duct 252 extends along a side surface closer to the outside of the vehicle among two side surfaces of seat backrest 13, from the upper portion of seat backrest 13 to the lower portion thereof. Second duct 252 leads air sent out from blower 31 via switch 70 to second outlet 222.

Through second duct 252, air sent out from blower 31 via switch 70 is blown out from second outlet 222 in a direction different from a rearward direction of seat 10. Second duct 252 in this example extends from the upper portion to the lower portion, and causes air introduced to second duct 252 to be blown out downward from second outlet 222. Note that air blown out from second outlet 222 may be blown out in an obliquely forward direction between the downward direction and the forward direction. The direction in which air is blown out from second outlet 222 may not include rearward vector components.

### [Operation of Vehicle Seat Air-Conditioning Device]

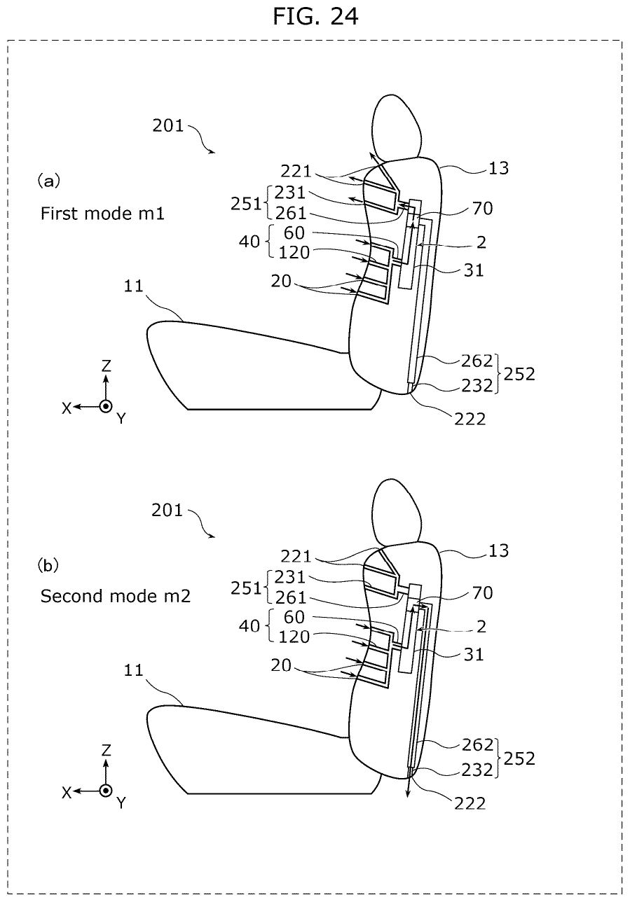

Operation of vehicle seat air-conditioning device 201 is described with reference to FIG. 24.

FIG. 24 illustrates flows of air in vehicle seat air-conditioning device 201 in first mode m1 and flows of air therein in second mode m2. FIG. 24 illustrates flows of air with arrows.

In first mode m1 illustrated in (a) of FIG. 24 is a mode in which air is blown out from first outlets 221 via first duct 251. In first mode m1, vehicle seat air-conditioning device 201 takes air drawn in from inlet 20 into blower 31 via inlet ventilation path 40, and blows out the air sent out from blower 31 from first outlets 221 via switch 70 and first duct 251.

Second mode m2 illustrated in (b) of FIG. 24 is a mode in which air is blown out from second outlet 222 via second duct 252. In second mode m2, vehicle seat air-conditioning device 201 takes air drawn in from inlets 20 into blower 31 via inlet ventilation path 40, and blows out the air sent out from blower 31 from second outlet 222 via switch 70 and second duct 252.

Vehicle seat air-conditioning device 201 has such first mode m1 and second mode m2. Controller 32 controls switch 70 to switch between first mode m1 and second mode m2. For example, controller 32 moves movable plate 71 of switch 70 to switch between first mode m1 and second mode m2. Controller 32 retracts movable plate 71 from the air-sending route along first duct 251 in first mode m1 (refer to (a) of FIG. 23).

In the following, an example is described in which second mode m2 is executed when the ignition of the vehicle is turned on, and thereafter first mode m1 is executed. When controller 32 executes second mode m2 and a predetermined condition is satisfied, controller 32 switches from second mode m2 to first mode m1 and executes first mode m1.

When the predetermined condition is satisfied is when a predetermined time has elapsed, for example. Controller 32 sets the mode to second mode m2 when operation of blower 31 starts, and sets the mode to first mode m1 after the predetermined time has elapsed after the start of operation of blower 31. Controller 32 may control blower 31 to make the air volume in second mode m2 greater than the air volume in first mode m1.

Specifically, vehicle seat air-conditioning device 201 blows out air in the maximum air volume from second outlet 222 in the initial cooling stage in which the ignition of the vehicle is turned on and execution of second mode m2 has started. When the predetermined time has elapsed and the temperature in the vehicle has decreased, controller 32 switches second mode m2 to first mode m1. In switched first mode m1, controller 32 causes air to be blown out from first outlets 221 in a normal air volume that is less than the maximum air volume.

When the predetermined condition is satisfied is when the temperature in the vehicle has reached a predetermined temperature. Controller 32 sets the mode to second mode m2 when operation of blower 31 starts, and when the temperature inside the vehicle has reached the predetermined temperature after setting the mode to second mode m2, changes second mode m2 to first mode m1. For example, controller 32 sets the mode to second mode m2 when the temperature inside the vehicle is higher than a first temperature, and changes second mode m2 to first mode m1 when the temperature inside the vehicle has become a second temperature, which is lower than the first temperature, or less after setting the mode to second mode m2. Controller 32 may control blower 31 to make the air volume in second mode m2 greater than the air volume in first mode m1.

Specifically, vehicle seat air-conditioning device 201 blows out air in the maximum air volume from second outlet 222 in the initial cooling stage in which the ignition of the vehicle is turned on and execution of second mode m2 has started. Controller 32 obtains information on a temperature inside the vehicle using a temperature sensor, for instance. The temperature inside the vehicle is a temperature inside the cabin, a temperature inside a seat, and a temperature in the vicinity of a seat, for example. The temperature inside the vehicle may be information indicating whether the temperature of a component inside the vehicle has reached a high temperature more than necessary. When a decrease in temperature is detected, controller 32 switches from second mode m2 to first mode m1. In switched first mode m1, controller 32 causes air to be blown out from first outlets 221 in the normal air volume that is less than the maximum air volume.

When a person is present in a rear seat behind seat 10, controller 32 may control blower 31 to decrease the amount of air to be blown out from second outlet 222, as compared to the case where no person is present in the rear seat. Controller 32 obtains information as to whether a person is present in a rear seat by using, for example, an occupant detection unit, a camera inside the vehicle, or a seat sensor, which is provided inside the vehicle. In second mode m2, controller 32 causes air to be blown out from second outlet 222 in the normal air volume when a person is seated in a rear seat, and causes air to be blown out from second outlet 222 in the maximum air volume greater than the normal air volume when no person is seated in the rear seat.

For example, controller 32 may control the amount of air drawn in from inlets 20 and the amount of air blown out from outlets by controlling blower 31, based on at least one of the temperature in a cabin in which seat 10 is disposed, the temperature of a person present in the cabin, or a control command given to an air-conditioning device provided in the vehicle. Controller 32 may obtain, from a sensor provided in the cabin, the temperature in the cabin and the temperature of a person present in the cabin, and control blower 31. Controller 32 may estimate the temperature in the cabin and the temperature of a person present in the cabin by obtaining an operation period from when the operation of the air-conditioning device provided in the vehicle starts, and control blower 31.

In this manner, vehicle seat air-conditioning device 201 includes: blower 31; inlet ventilation path 40 that leads air inside the vehicle, which is drawn in from inlets 20, to blower 31 by the operation of blower 31; first duct 251 that leads air sent out from blower 31 to first outlets 221 located in at least one of the front surface or the upper surface of seat backrest 13; second duct 252 that leads air sent out from blower 31 to second outlet 222 located rearward than the back surface of seat backrest 13 or seating portion 11; and switch 70 that switches the destination of air blown out from blower 31 between first duct 251 and second duct 252. First duct 251 blows out air sent out from blower 31 via switch 70 in at least one of a forward direction or an obliquely forward direction of seat 10 from first outlets 221. Second duct 252 blows out air sent out from blower 31 via switch 70 from second outlet 222 in a direction different from a rearward direction of seat 10.

Since vehicle seat air-conditioning device 201 includes switch 70 as stated above, the direction in which air is blown out can be switched according to the environment inside the vehicle. Accordingly, for example, air warmed by passing through the inside of seat 10 in an initial operation stage in which cooling is insufficient can be blown out from second outlet 222 located in the back surface of seat backrest 13 in a direction different from the rearward direction of seat 10. Accordingly, it is possible to reduce discomfort given to a person in a front seat of the vehicle and to a person in a rear seat thereof.

Note that the above has shown an example in which inlet ventilation path 40 is connected to inlets 20, first duct 251 is connected to first outlets 221, and second duct 252 is connected to second outlet 222, but the embodiment is not limited thereto and the inlets (or outlets) and the ventilation path may be integrated. For example, the openings of inlet ventilation path 40 at the tips may be inlets 20, the openings of first duct 251 at the tips may be first outlets 221, or the opening of second duct 252 at the tip may be second outlet 222. The same also applies to the following.

### (Variation 1)

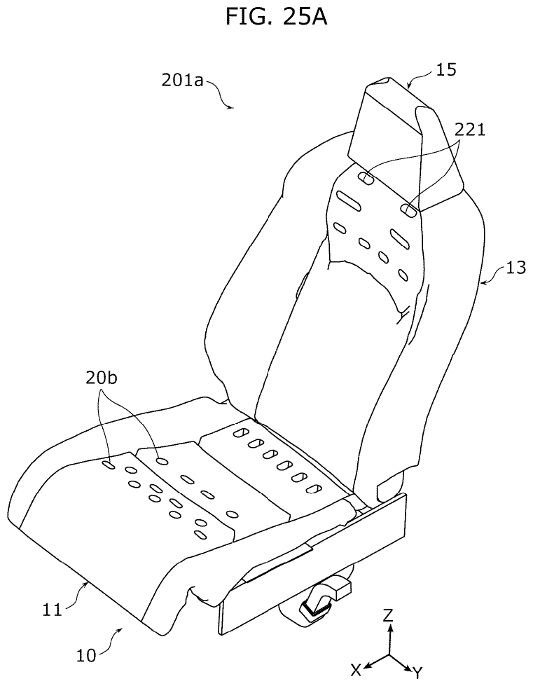

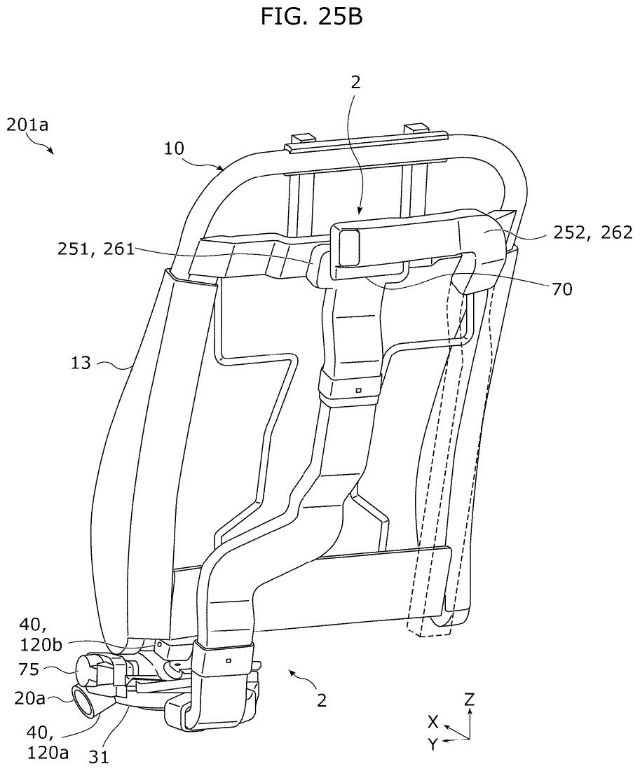

First, vehicle seat air-conditioning device 201a according to Variation 1 of the embodiment is described with reference to FIG. 25A to FIG. 28. In Variation 1, an example in which inlet 20 and blower 31 are provided in seating portion 11 is described.

FIG. 25A is a perspective view illustrating an appearance of vehicle seat air-conditioning device 201a according to Variation 1 of Embodiment 2. FIG. 25B illustrates a view illustrating vehicle seat air-conditioning device 201a according to Variation 1 from obliquely behind.

Vehicle seat air-conditioning device 201a illustrated in FIG. 25A and FIG. 25B includes seat 10 and ventilation path selection switch device 2 that selects a ventilation path through which air passes.

Seat 10 includes seating portion 11 for a person to sit, seat backrest 13, and headrest 15. Note that illustration of seating portion 11 and headrest 15 is omitted from FIG. 25B. FIG. 25B illustrates an example in which switch 70 having an external shape different from that in Embodiment 2 is used.

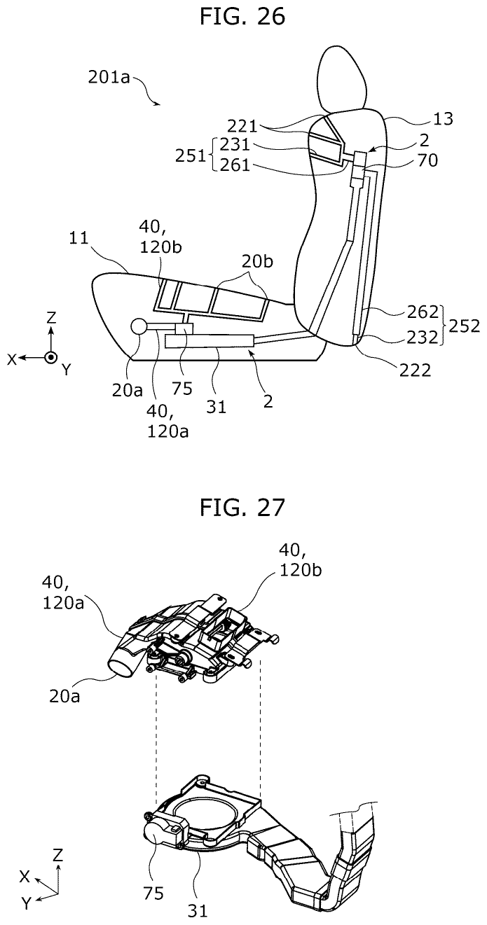

FIG. 26 is a schematic diagram illustrating ventilation paths, for instance, of vehicle seat air-conditioning device 201a.

As illustrated in FIG. 26, the vehicle is provided with inlets 20, first outlets 221, and second outlet 222. Inlets 20 of Variation 1 include first inlet 20a and second inlets 20b.

First inlet 20a is an inlet for an air conditioner. First inlet 20a is provided below first outlets 221, or stated differently, provided below first outlets 221 in the vertical direction. First inlet 20a is provided in a lower portion of seating portion 11 inside the vehicle. Air can be taken in from the inside of the vehicle through first inlet 20a.

First inlet 20a may be provided, facing an outlet (e.g., a duct in a center console) of a heating ventilation and air conditioning (HVAC) device provided in the vehicle. Thus, cool air or warm air sent from the HVAC device may be able to be drawn in through first inlet 20a.

Second inlets 20b are openings through which air in the vehicle is drawn in. Second inlets 20b are provided below first outlets 221, or stated differently, provided below first outlets 221 in the vertical direction. Second inlets 20b are provided in a region for the buttocks and thighs of a person seated in seat 10, which is a center portion of seating portion 11. Second inlets 20b in this example are provided in the upper surface of seating portion 11 in the vehicle.

First outlets 221 are outlets through which air is blown out onto a person seated in seat 10 to cool and warm the body of the person. First outlets 221 are provided in an upper portion of seat backrest 13, similarly to the present embodiment.

Second outlet 222 is an outlet through which air warmed while passing through the inside of seat 10 in an initial operation stage in which cooling is insufficient is blown out without giving discomfort to a person in a front seat and a person in a rear seat, for example. Second outlet 222 is provided more rearward than the back surface of seat backrest 13 or seating portion 11, similarly to the present embodiment. Second outlet 222 is provided in a lower position than first outlets 221. Second outlet 222 in this example is provided in a back surface of seat backrest 13, in a lower position than the upper surface of seating portion 11.

As illustrated in FIG. 25B and FIG. 26, ventilation path selection switch device 2 is provided in seating portion 11 of seat 10. Ventilation path selection switch device 2 is housed in a recessed portion on a bottom surface side of seating portion 11.

As illustrated in FIG. 26, vehicle seat air-conditioning device 201a includes first inlet ventilation path 120a connected to first inlet 20a, second inlet ventilation path 120b connected to second inlets 20b, first seat ventilation path 231 connected to first outlets 221, and second seat ventilation path 232 connected to second outlet 222.

First inlet ventilation path 120a is a flow path from first inlet 20a up to ventilation path selection switch device 2. Second inlet ventilation path 120b is a flow path from second inlets 20b up to ventilation path selection switch device 2. First seat ventilation path 231 is a flow path from first outlets 221 to ventilation path selection switch device 2. Second seat ventilation path 232 is a flow path from second outlet 222 up to ventilation path selection switch device 2.

FIG. 27 is a perspective view illustrating blower 31 of vehicle seat air-conditioning device 201a. FIG. 27 illustrates a state in which a portion of blower 31 is separated and shown above.

As illustrated in FIG. 26 and FIG. 27, ventilation path selection switch device 2 includes blower 31, switching valve 75 connected to an intake port of blower 31, switch 70 connected to an exhaust port of blower 31, and first duct ventilation path 261 and second duct ventilation path 262 that are connected to switch 70.

As illustrated in FIG. 26, switching valve 75 is connected to first inlet ventilation path 120a and second inlet ventilation path 120b described above, first duct ventilation path 261 is connected to first seat ventilation path 231 described above, and second duct ventilation path 262 is connected to second seat ventilation path 232 described above.

In the following, a ventilation path that includes first inlet ventilation path 120a and second inlet ventilation path 120b is referred to as inlet ventilation path 40. A ventilation path that includes first seat ventilation path 231 and first duct ventilation path 261 is referred to as first duct 251, and a ventilation path that includes second seat ventilation path 232 and second duct ventilation path 262 is referred to as second duct 252. Note that when second duct 252 includes only second duct ventilation path 262 without second seat ventilation path 232 being provided, the tip of second duct ventilation path 262 may be directly connected to second outlet 222.

Inlet ventilation path 40 is an airway that connects first inlet 20a and switching valve 75 and is an airway that connects second inlets 20b and switching valve 75. Inlet ventilation path 40 is provided between first inlet 20a located in a lower portion of seating portion 11 and between second inlets 20b in an upper surface of seating portion 11 and switching valve 75. With the operation of blower 31, inlet ventilation path 40 leads air in the vehicle drawn in from inlets 20 to blower 31 via switching valve 75.

Switching valve 75 is a valve that switches the flow path for air to be drawn in by blower 31 to first inlet ventilation path 120a or to second inlet ventilation path 120b. Switching valve 75 is provided between a suction port of blower 31 and first inlet ventilation path 120a and between the suction port of blower 31 and second inlet ventilation path 120b. Controller 32 controls the opening and closing of switching valve 75 by controlling a driver (not illustrated) different from driver 34.

Blower 31 is for intake and emission of air. The intake port of blower 31 is connected to switching valve 75, and the exhaust port of blower 31 is connected to switch 70. Blower 31 draws in air via inlet ventilation path 40 and switching valve 75, and sends out the air drawn in to switch 70.

Note that blower 31 and switch 70 are not necessarily directly connected to each other, and another duct-shaped ventilation path may be provided between blower 31 and switch 70.

Switch 70 switches the destination of air sent out from blower 31 to first duct 251 or to second duct 252. Switch 70 is provided between the exhaust port of blower 31 and first duct 251 and between the exhaust port of blower 31 and second duct 252. In vehicle seat air-conditioning device 201a, controller 32 causes driver 34 of switch 70 to operate to switch the destination of air sent out by blower 31 between first duct 251 and second duct 252.

First duct 251 is an airway that connects switch 70 and first outlets 221. First duct 251 leads air sent out from blower 31 via switch 70 to first outlets 221, similarly to the present embodiment. Air sent out from blower 31 is blown out through first duct 251 in at least one of a forward direction or an obliquely forward direction of seat 10 from first outlets 221.

Second duct 252 is an airway that connects switch 70 and second outlet 222. Second duct 252 leads air sent out from blower 31 via switch 70 to second outlet 222, similarly to the present embodiment. Air sent out from blower 31 via switch 70 is blown out through second duct 252 from second outlet 222 in a direction different from a rearward direction of seat 10. Second duct 252 in this example extends from the upper portion to the lower portion, and air introduced to second duct 252 is blown out from second outlet 222 downward.

Next, operation of vehicle seat air-conditioning device 201a according to Variation 1 is described.

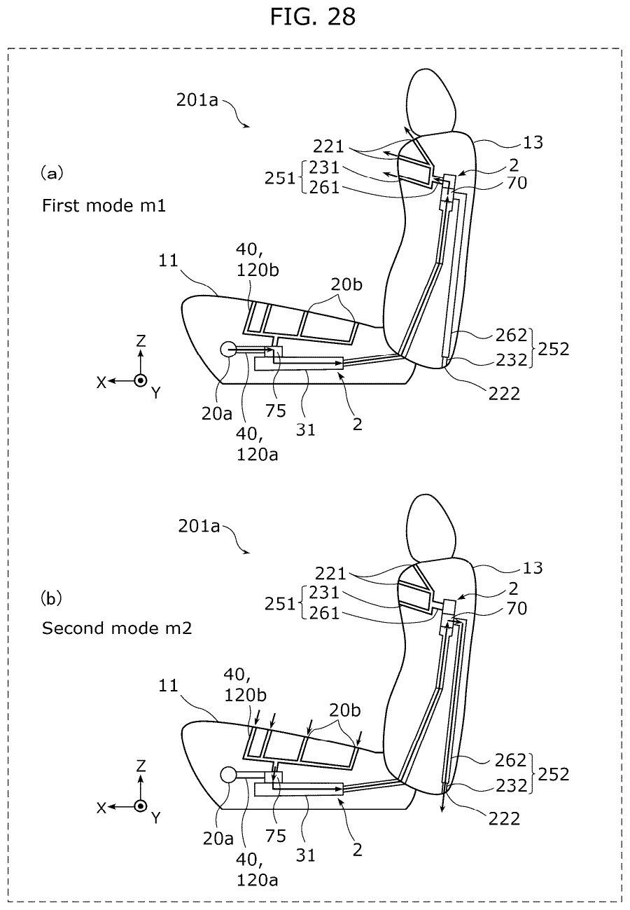

FIG. 28 illustrates flows of air in vehicle seat air-conditioning device 201a in first mode m1 and flows of air therein in second mode m2.

In first mode m1 illustrated in (a) of FIG. 28 is a mode in which air is blown out from first outlets 221 via first duct 251. In first mode m1, vehicle seat air-conditioning device 201a takes air drawn in from first inlet 20a into blower 31 via inlet ventilation path 40 and switching valve 75, and blows out air sent out from blower 31 from first outlets 221 via switch 70 and first duct 251.

Second mode m2 illustrated in (b) of FIG. 28 is a mode in which air is blown out from second outlet 222 via second duct 252. In second mode m2, vehicle seat air-conditioning device 201a takes air drawn in from second inlets 20b into blower 31 via inlet ventilation path 40 and switching valve 75, and blows out air sent out from blower 31 from second outlet 222 via switch 70 and second duct 252.

Vehicle seat air-conditioning device 201a has such first mode m1 and second mode m2. Controller 32 controls switch 70 and switching valve 75 to switch between first mode m1 and second mode m2. For example, controller 32 moves movable plate 71 and a movable plate (not illustrated) of switching valve 75 of switch 70 to switch between first mode m1 and second mode m2.

Also in the variation described below, an example is described in which second mode m2 is executed when the ignition of the vehicle is turned on, and thereafter first mode m1 is executed. When controller 32 executes second mode m2 and a predetermined condition is satisfied, controller 32 switches from second mode m2 to first mode m1 and executes first mode m1.

When the predetermined condition is satisfied is when a predetermined time has elapsed, for example. Controller 32 sets the mode to second mode m2 when operation of blower 31 starts, and sets the mode to first mode m1 after the predetermined time has elapsed after the start of operation of blower 31. Controller 32 may control blower 31 to make the air volume in second mode m2 greater than the air volume in first mode m1.

Specifically, vehicle seat air-conditioning device 201a draws in air from second inlets 20b and blows out the air drawn in from second outlet 222 in the maximum air volume in the initial cooling stage in which the ignition of the vehicle is turned on and execution of second mode m2 has started. When the predetermined time has elapsed and the temperature in the vehicle decreases, controller 32 switches second mode m2 to first mode m1. In switched first mode m1, controller 32 causes air to be drawn in from first inlet 20a and the air drawn in to be blown out in the normal air volume from first outlets 221.

When the predetermined condition is satisfied is when the temperature in the vehicle has reached a predetermined temperature. Controller 32 sets the mode to second mode m2 when operation of blower 31 starts, and when the temperature inside the vehicle has reached the predetermined temperature after setting the mode to second mode m2, changes second mode m2 to first mode m1. For example, controller 32 sets the mode to second mode m2 when the temperature inside the vehicle is higher than a first temperature, and changes second mode m2 to first mode m1 when the temperature inside the vehicle has become a second temperature, which is lower than the first temperature, or lower after setting the mode to second mode m2. Controller 32 may control blower 31 to make the air volume in second mode m2 greater than the air volume in first mode m1.

Specifically, vehicle seat air-conditioning device 201a draws in air from second inlets 20b and blows out the air drawn in from second outlet 222 in the maximum air volume in the initial cooling stage in which the ignition of the vehicle is turned on and execution of second mode m2 has started. When a decrease in temperature is detected, controller 32 switches from second mode m2 to first mode m1. In switched first mode m1, controller 32 causes air to be drawn in from first inlet 20a and the air drawn in to be blown out in the normal air volume from first outlets 221.

As described above, vehicle seat air-conditioning device 201a includes switching valve 75, blower 31, inlet ventilation path 40, first duct 251, second duct 252, and switch 70. Air sent out from blower 31 through switching valve 75 via switch 70 is blown out through first duct 251 in at least one of a forward direction or an obliquely forward direction of seat 10 from first outlets 221. Air sent out from blower 31 through switching valve 75 via switch 70 is blown out through second duct 252 from second outlet 222 in a direction different from a rearward direction of seat 10.

Since vehicle seat air-conditioning device 201a includes switch 70 as stated above, the direction in which air is blown out can be switched according to the environment inside the vehicle. Accordingly, for example, air warmed by passing through the inside of seat 10 in an initial operation stage in which cooling is insufficient can be blown out from second outlet 222 located in the back surface of seat backrest 13 in a direction different from the rearward direction of seat 10. Accordingly, it is possible to reduce discomfort given to a person in a front seat of the vehicle and to a person in a rear seat thereof. After cooling has been stabilized, blower 31 draws in conditioned air in the cabin or air conditioned by an HVAC device and blows out the air in at least one of a forward direction or an obliquely forward direction of seat 10 from first outlets 221. Thus, comfortability for a person seated in seat 10 can be improved when cooling is stabilized.

### (Variation 2)

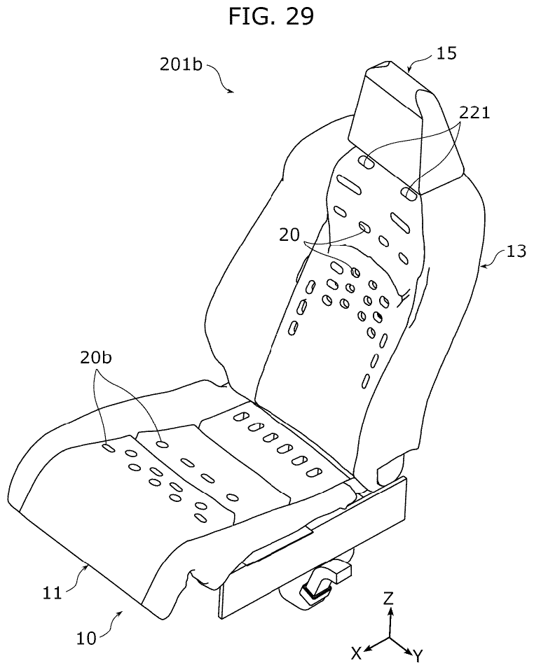

Vehicle seat air-conditioning device 201b according to Variation 2 of Embodiment 2 is to be described with reference to FIG. 29 to FIG. 31. In Variation 2, an example in which blower 31 includes first blower 31a provided in seating portion 11 and second blower 31b provided in seat backrest 13 is described.

FIG. 29 is a perspective view illustrating an appearance of vehicle seat air-conditioning device 201b according to Variation 2 of Embodiment 2.

Vehicle seat air-conditioning device 201b illustrated in FIG. 29 includes seat 10 and ventilation path selection switch device 2 that selects a ventilation path through which air passes.

Vehicle seat air-conditioning device 201b includes first blower 31a, second blower 31b, controller 32, power supply 33, and driver 34, as illustrated in FIG. 12B. First blower 31a, second blower 31b, driver 34, and power supply 33 are connected to controller 32.

Seat 10 includes seating portion 11 for a person to sit, seat backrest 13, and headrest 15.

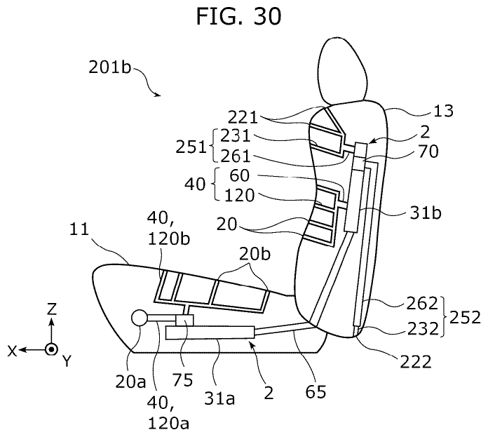

FIG. 30 is a schematic diagram illustrating ventilation paths, for instance, of vehicle seat air-conditioning device 201b. As illustrated in FIG. 30, the vehicle is provided with inlets 20a and 20b in seating portion 11, inlets 20 in seat backrest 13, first outlets 221, and second outlet 222.

The inlets of seating portion 11 are the same as inlets 20 in Variation 1, that is, first inlet 20a and second inlets 20b. Inlets 20 in seat backrest 13 are the same as inlets 20 in the present embodiment. In addition, first outlets 221 and second outlet 222 are configured in the same manner as those in Variation 1.

In the following, a ventilation path that includes first inlet ventilation path 120a, second inlet ventilation path 120b, inlet seat ventilation path 120, and inlet duct ventilation path 60 is referred to as inlet ventilation path 40. A ventilation path that includes first seat ventilation path 231 and first duct ventilation path 261 is referred to as first duct 251, and a ventilation path that includes second seat ventilation path 232 and second duct ventilation path 262 is referred to as second duct 252.

Inlet ventilation path 40 is an airway that connects first inlet 20a and switching valve 75 in seating portion 11, is an airway that connects second inlets 20b and switching valve 75 in seating portion 11, and is an airway that connects inlets 20 and second blower 31b in seat backrest 13. Inlet ventilation path 40 is provided between first inlet 20a in a lower portion of seating portion 11 and switching valve 75, between second inlets 20b in the upper surface of seating portion 11 and switching valve 75, and between inlets 20 in the front surface of seat backrest 13 and the intake port of second blower 31b. With the operation of blower 31, inlet ventilation path 40 leads air in the vehicle drawn in from inlets 20 to blower 31 via switching valve 75.

Switching valve 75 is a valve that switches the flow path for air to be drawn in by first blower 31a to first inlet ventilation path 120a or to second inlet ventilation path 120b. Switching valve 75 is provided between a suction port of first blower 31a and first inlet ventilation path 120a and between the suction port of first blower 31a and second inlet ventilation path 120b. Controller 32 controls the opening and closing of switching valve 75 by controlling a driver (not illustrated) different from driver 34.

First blower 31a is for intake and emission of air. First blower 31a is provided in seating portion 11. The intake port of first blower 31a is connected to switching valve 75, and the exhaust port of first blower 31a is connected to the intake port of second blower 31b via relay duct 65 provided along seating portion 11 and seat backrest 13. First blower 31a draws in air via inlet ventilation path 40 in seating portion 11 and sends out the air drawn in to second blower 31b.

Second blower 31b is for intake and emission of air. Second blower 31b is provided in seat backrest 13. The intake port of second blower 31b is connected to the exhaust port of first blower 31a via relay duct 65, and the exhaust port of second blower 31b is connected to switch 70. Second blower 31b draws in air sent out from first blower 31a via relay duct 65, draws in air via inlet ventilation path 40 in seat backrest 13, and blows out such air drawn in to switch 70.

Switch 70 switches the destination of air sent out from second blower 31b to first duct 251 or to second duct 252. Switch 70 is provided between the exhaust port of second blower 31b and first duct 251 and between the exhaust port of second blower 31b and second duct 252.

In vehicle seat air-conditioning device 201b, controller 32 causes driver 34 of switch 70 to operate to switch the destination of air sent out by second blower 31b between first duct 251 and second duct 252.

First duct 251 is an airway that connects switch 70 and first outlet 221. First duct 251 leads air sent out from second blower 31b via switch 70 to first outlet 221. First duct 251 blows out air sent out from second blower 31b in at least one of a forward direction or a diagonally forward direction of seat 10 from first outlets 221.

Second duct 252 is an airway that connects switch 70 and second outlet 222. Second duct 252 leads air sent out from second blower 31b via switch 70 to second outlet 222. Second duct 252 blows out air sent out from second blower 31b via switch 70 from second outlet 222 in a direction different from a rearward direction of seat 10. Second duct 252 in this example extends from the upper portion to the lower portion, and causes air introduced to second duct 252 to be blown out downward from second outlet 222.

Next, operation of vehicle seat air-conditioning device 201b according to Variation 2 is described.

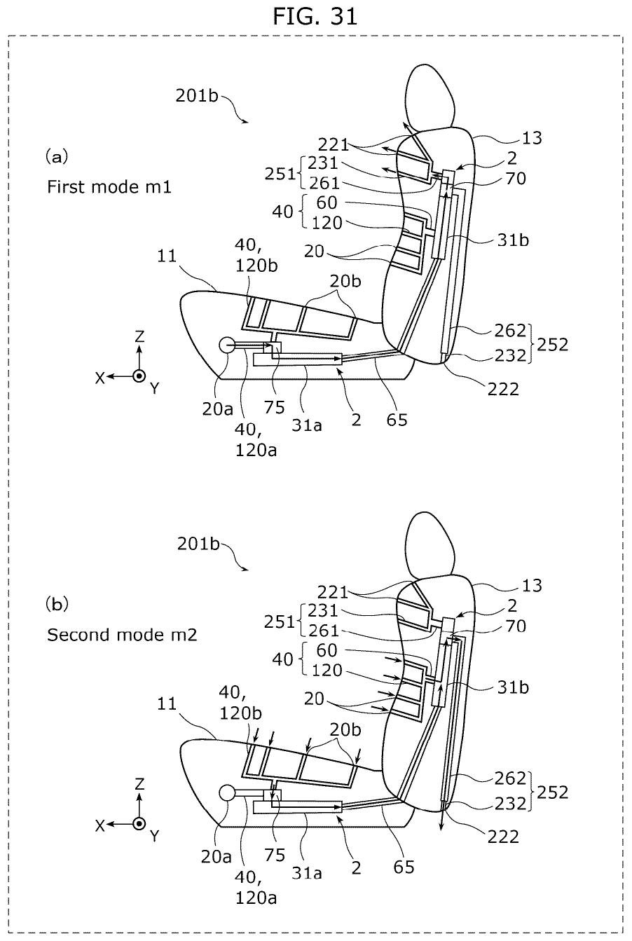

FIG. 31 illustrates flows of air in vehicle seat air-conditioning device 201b in first mode m1 of and flows of air therein in second mode m2.

First mode m1 illustrated in (a) of FIG. 31 is a mode in which air is blown out from first outlets 221 via first duct 251. In first mode m1, vehicle seat air-conditioning device 201b takes air drawn in from first inlet 20a in seating portion 11 into first blower 31a via inlet ventilation path 40, and blows out the air sent out from first blower 31a from first outlets 221 via second blower 31b, switch 70, and first duct 251.

Second mode m2 illustrated in (b) of FIG. 31 is a mode in which air is blown out from second outlet 222 via second duct 252. Vehicle seat air-conditioning device 201b takes, into first blower 31a via inlet ventilation path 40 in seating portion 11, air drawn in from second inlets 20b in seating portion 11 in second mode m2, and sends out the air to second blower 31b. Vehicle seat air-conditioning device 201b takes, into second blower 31b via inlet ventilation path 40 in seat backrest 13, air drawn in from inlets 20 in seat backrest 13. Air sent out from first blower 31a and second blower 31b is blown out from second outlet 222 via switch 70 and second duct 252.

Vehicle seat air-conditioning device 201b has such first mode m1 and second mode m2. Controller 32 controls switch 70 and switching valve 75 to switch between first mode m1 and second mode m2. For example, controller 32 moves movable plate 71 and a movable plate of switching valve 75 of switch 70 to switch between first mode m1 and second mode m2.

When controller 32 executes second mode m2 and a predetermined condition is satisfied, controller 32 switches from second mode m2 to first mode m1 and executes first mode m1.

When the predetermined condition is satisfied is when a predetermined time has elapsed, for example. Controller 32 sets the mode to second mode m2 when operation of first blower 31a and second blower 31b starts, and sets the mode to first mode m1 after the predetermined time has elapsed after the start of operation of first blower 31a and second blower 31b. Controller 32 may control first blower 31a and second blower 31b to make the air volume in second mode m2 greater than the air volume in first mode m1.

Specifically, vehicle seat air-conditioning device 201b draws in air from second inlets 20b in seating portion 11 using first blower 31a and draws in air from inlets 20 in seat backrest 13 using second blower 31b, and blows out such air drawn in from second outlet 222 in the maximum air volume in the initial cooling stage in which the ignition of the vehicle is turned on and execution of second mode m2 has started. When the predetermined time has elapsed and the temperature in the vehicle decreases, controller 32 switches second mode m2 to first mode m1. In switched first mode m1, controller 32 causes air to be drawn in from first inlet 20a in seating portion 11 and the air drawn in to be blown out in the normal air volume from first outlets 221 via second blower 31b, for instance.

When the predetermined condition is satisfied is when the temperature in the vehicle has reached a predetermined temperature. Controller 32 sets the mode to second mode m2 when operation of blower 31 starts, and when the temperature inside the vehicle has reached the predetermined temperature after setting the mode to second mode m2, changes second mode m2 to first mode m1. For example, controller 32 sets the mode to second mode m2 when the temperature inside the vehicle is higher than a first temperature, and changes second mode m2 to first mode m1 when the temperature inside the vehicle has become a second temperature, which is lower than the first temperature, or lower after setting the mode to second mode m2. Controller 32 may control first blower 31a and second blower 31b to make the air volume in second mode m2 greater than the air volume in first mode m1.

Specifically, vehicle seat air-conditioning device 201b draws in air from second inlets 20b using first blower 31a and draws in air from inlets 20 in seat backrest 13 using second blower 31b, and blows out such air drawn in from second outlet 222 in the maximum air volume in the initial cooling stage in which the ignition of the vehicle is turned on and execution of second mode m2 has started. When a decrease in temperature is detected, controller 32 switches from second mode m2 to first mode m1. In switched first mode m1, controller 32 causes air to be drawn in from first inlet 20a in seating portion 11 and the air drawn in to be blown out in the normal air volume from first outlets 221 via second blower 31b, for instance.

As described above, vehicle seat air-conditioning device 201b includes switching valve 75, blower 31 that includes first blower 31a and second blower 31b, inlet ventilation path 40, first duct 251, second duct 252, and switch 70. Through first duct 251, air sent out from blower 31 through switching valve 75 via switch 70 is blown out in at least one of a forward direction or an obliquely forward direction of seat 10 from first outlets 221. Through second duct 252, air sent out from blower 31 through switching valve 75 via switch 70 is blown out from second outlet 222 in a direction different from a rearward direction of seat 10.

Since vehicle seat air-conditioning device 201b includes switch 70 as described above, the direction in which air is blown out can be switched according to the environment inside the vehicle. Accordingly, for example, air warmed by passing through the inside of seat 10 in an initial operation stage in which cooling is insufficient can be blown out from second outlet 222 located in the back surface of seat backrest 13 in a direction different from the rearward direction of seat 10. Accordingly, it is possible to reduce discomfort given to a person in a front seat of the vehicle and to a person in a rear seat thereof. After cooling has been stabilized, blower 31 draws in conditioned air in the cabin or air conditioned by an HVAC device and blows out the air in at least one of a forward direction or an obliquely forward direction of seat 10 from first outlets 221. Thus, comfortability for a person seated in seat 10 can be improved when cooling is stabilized.

### (Variation 3)

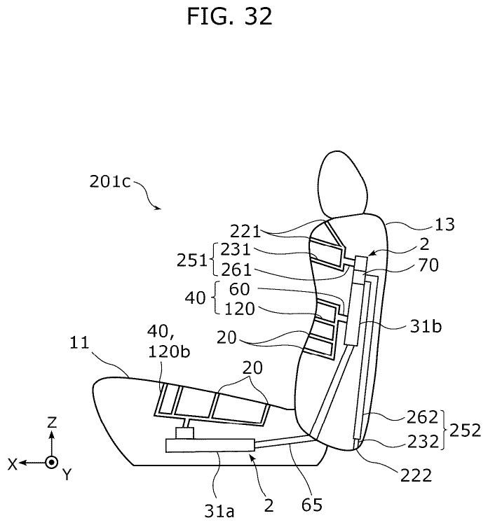

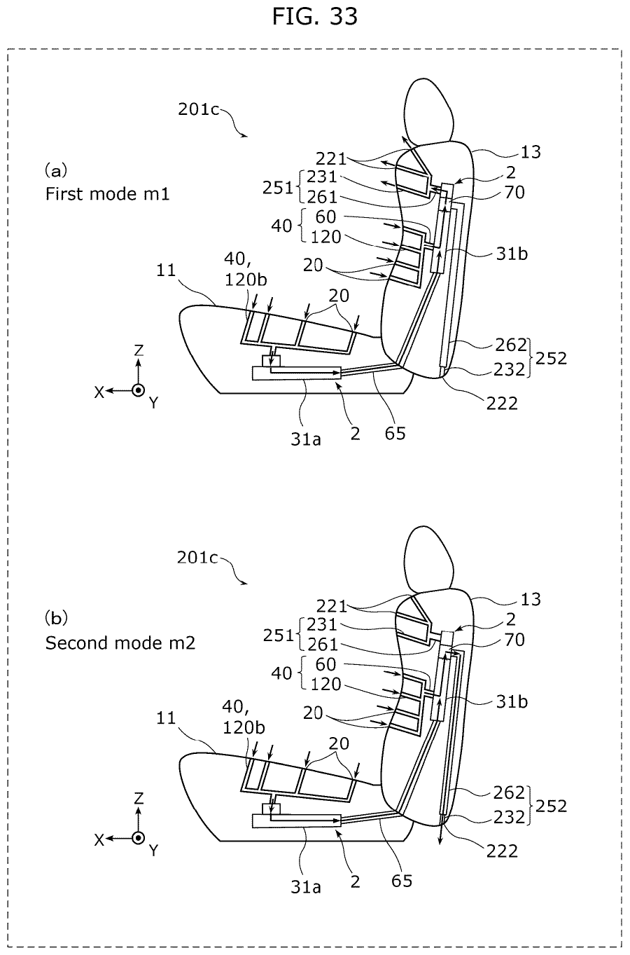

Vehicle seat air-conditioning device 201c according to Variation 3 of Embodiment 2 is described with reference to FIG. 32 to FIG. 33. In Variation 3, an example in which blower 31 includes first blower 31a and second blower 31b is described.

Vehicle seat air-conditioning device 201c includes seat 10 and ventilation path selection switch device 2 that selects a ventilation path through which air passes. Vehicle seat air-conditioning device 201c includes first blower 31a, second blower 31b, controller 32, power supply 33, and driver 34.

FIG. 32 is a schematic diagram illustrating ventilation paths, for instance, of vehicle seat air-conditioning device 201c.

As illustrated in FIG. 32, the vehicle is provided with inlets 20 in seat backrest 13, inlets 20 in seating portion 11, first outlets 221, and second outlet 222.

Inlets 20 in seat backrest 13 are the same as inlets 20 in the present embodiment. Inlets 20 in seating portion 11 are the same as second inlets 20b in seating portion 11. In addition, first outlets 221 and second outlet 222 are configured in the same manner as those in Variation 1.

In the following, a ventilation path that includes second inlet ventilation path 120b, inlet seat ventilation path 120, and inlet duct ventilation path 60 is referred to as inlet ventilation path 40. A ventilation path that includes first seat ventilation path 231 and first duct ventilation path 261 is referred to as first duct 251, and a ventilation path that includes second seat ventilation path 232 and second duct ventilation path 262 is referred to as second duct 252.

Inlet ventilation path 40 is an airway that connects inlets 20 and first blower 31a in seating portion 11, and is an airway that connects inlets 20 and second blower 31b in seat backrest 13. Inlet ventilation path 40 is provided between inlets 20 in the upper surface of seating portion 11 and an intake port of first blower 31a and between inlets 20 in the front surface of seat backrest 13 and an intake port of second blower 31b. With the operation of blower 31, inlet ventilation path 40 leads air drawn in from such inlets 20 to blower 31.

First blower 31a is a device for intake and emission of air. First blower 31a is provided in seating portion 11. The intake port of first blower 31a is connected to inlet ventilation path 40 in seating portion 11, and an exhaust port of first blower 31a is connected to the intake port of second blower 31b via relay duct 65. First blower 31a draws in air via inlet ventilation path 40 from inlets 20 in seating portion 11 and sends out the air drawn in to second blower 31b.

Second blower 31b is for intake and emission of air. Second blower 31b is provided in seat backrest 13. The intake port of second blower 31b is connected to inlet ventilation path 40 and relay duct 65 in seat backrest 13, and an exhaust port of second blower 31b is connected to switch 70. Second blower 31b draws in air sent out from first blower 31a via relay duct 65, draws in air via inlet ventilation path 40 in seat backrest 13, and sends out such air drawn in to switch 70.

Switch 70 switches the destination of air sent out from blower 31 to first duct 251 or to second duct 252. Switch 70 is provided between the exhaust port of second blower 31b and first duct 251 and between the exhaust port of second blower 31b and second duct 252.

In vehicle seat air-conditioning device 201c, controller 32 causes driver 34 of switch 70 to operate to switch the destination of air sent out by second blower 31b between first duct 251 and second duct 252. First duct 251 and second duct 252 are configured in the same manner as those in Variation 2.

Next, operation of vehicle seat air-conditioning device 201c according to Variation 3 is described.

FIG. 33 illustrates flows of air in vehicle seat air-conditioning device 201c in first mode m1 and flows of air therein in second mode m2.

First mode m1 illustrated in (a) of FIG. 33 is a mode in which air is blown out from first outlets 221 via first duct 251. In first mode m1, vehicle seat air-conditioning device 201c takes, into first blower 31a via inlet ventilation path 40 in seating portion 11, air drawn in from second inlets 20b (inlets 20) in seating portion 11 and sends out the air from first blower 31a. Vehicle seat air-conditioning device 201c takes, into second blower 31b via inlet ventilation path 40 in seat backrest 13, air drawn in from inlets 20 in seat backrest 13, and sends out the air from second blower 31b. Air sent out from first blower 31a and second blower 31b is blown out from first outlets 221 via switch 70 and first duct 251.

Second mode m2 illustrated in (b) of FIG. 33 is a mode in which air is blown out from second outlet 222 via second duct 252. In second mode m2, vehicle seat air-conditioning device 201c takes, into first blower 31a via inlet ventilation path 40 in seating portion 11, air drawn in from second inlets 20b (inlets 20) in seating portion 11 and sends out the air from first blower 31a. Vehicle seat air-conditioning device 201c takes, into second blower 31b via inlet ventilation path 40 in seat backrest 13, air drawn in from inlets 20 in seat backrest 13, and sends out the air from second blower 31b. Air sent out from first blower 31a and second blower 31b is blown out from second outlet 222 via switch 70 and second duct 252.

Vehicle seat air-conditioning device 201c has such first mode m1 and second mode m2. Controller 32 controls switch 70 to switch between first mode m1 and second mode m2. For example, controller 32 moves movable plate 71 of switch 70 to switch between first mode m1 and second mode m2.

When controller 32 executes second mode m2 and a predetermined condition is satisfied, controller 32 can switch from second mode m2 to first mode m1 and executes first mode m1.

When the predetermined condition is satisfied is when a predetermined time has elapsed, for example. Controller 32 sets the mode to second mode m2 when operation of blower 31 (first blower 31a and second blower 31b) starts, and sets the mode to first mode m1 after the predetermined time has elapsed after the start of operation of blower 31. Controller 32 may control first blower 31a and second blower 31b to make the air volume in second mode m2 greater than the air volume in first mode m1.

Specifically, vehicle seat air-conditioning device 201c draws in air from second inlets 20b in seating portion 11 using first blower 31a and draws in air from inlets 20 in seat backrest 13 using second blower 31b, and blows out such air drawn in from second outlet 222 in the maximum air volume in the initial cooling stage in which the ignition of the vehicle is turned on and execution of second mode m2 has started. When the predetermined time has elapsed and the temperature in the vehicle decreases, controller 32 switches from second mode m2 to first mode m1. In switched first mode m1, controller 32 causes air drawn in from second inlets 20b in seating portion 11 and air drawn in from inlets 20 in seat backrest 13 from first outlets 221 in the normal air volume.

When the predetermined condition is satisfied is when the temperature in the vehicle has reached a predetermined temperature. Controller 32 sets the mode to second mode m2 when operation of first blower 31a and second blower 31b starts, and when the temperature inside the vehicle has reached the predetermined temperature after setting the mode to second mode m2, changes second mode m2 to first mode m1. For example, controller 32 sets the mode to second mode m2 when the temperature inside the vehicle is higher than a first temperature, and changes second mode m2 to first mode m1 when the temperature inside the vehicle has become a second temperature, which is lower than the first temperature, or lower after setting the mode to second mode m2. Controller 32 may control first blower 31a and second blower 31b to make the air volume in second mode m2 greater than the air volume in first mode m1.

Specifically, vehicle seat air-conditioning device 201c draws in air from second inlets 20b (inlets 20) using first blower 31a and draws in air from inlets 20 in seat backrest 13 using second blower 31b, and blows out such air drawn in from second outlet 222 in the maximum air volume in the initial cooling stage in which the ignition of the vehicle is turned on and execution of second mode m2 has started. When a decrease in temperature is detected, controller 32 switches from second mode m2 to first mode m1. In switched first mode m1, controller 32 causes air drawn in from second inlets 20b in seating portion 11 and air drawn in from inlets 20 in seat backrest 13 to be blown out from first outlets 221 in the normal air volume.

As described above, vehicle seat air-conditioning device 201c includes blower 31 that includes first blower 31a and second blower 31b, inlet ventilation path 40, first duct 251, second duct 252, and switch 70. First duct 251 blows out air sent out from blower 31 via switch 70 in at least one of a forward direction or an obliquely forward direction of seat 10 from first outlets 221. Through second duct 252, air sent out from blower 31 via switch 70 is blown out from second outlet 222 in a direction different from a rearward direction of seat 10.

Since vehicle seat air-conditioning device 201c includes switch 70 as stated above, the direction in which air is blown out can be switched according to the environment inside the vehicle. Accordingly, for example, air warmed by passing through the inside of seat 10 in an initial operation stage in which cooling is insufficient can be blown out from second outlet 222 located in the back surface of seat backrest 13 in a direction different from the rearward direction of seat 10. Accordingly, it is possible to reduce discomfort given to a person in a front seat of the vehicle and to a person in a rear seat thereof. In second mode m2, first blower 31a can draw in air from seating portion 11 and separately, second blower 31b can draw in air from seat backrest 13. Thus, air warmed inside seat 10 can be blown out more quickly.

### (Variation 4)

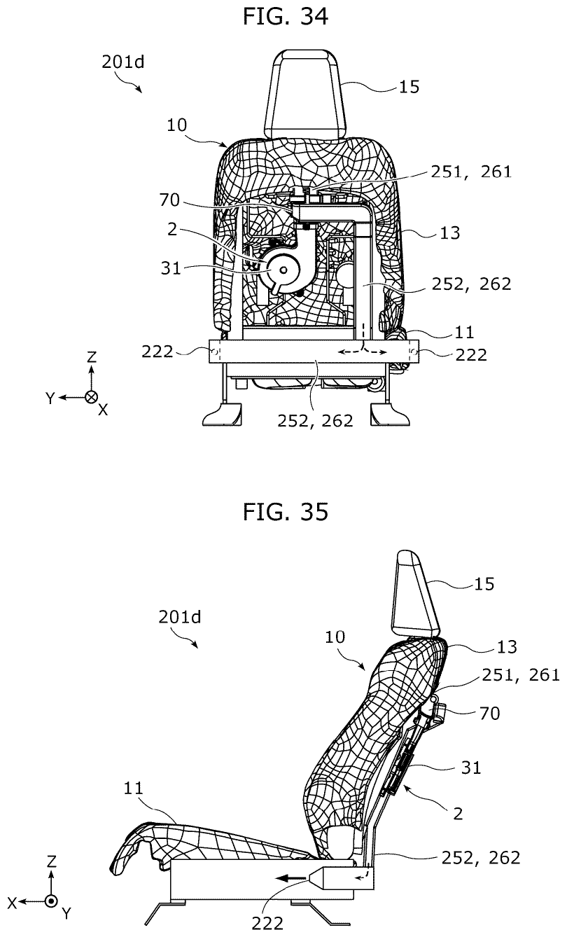

Vehicle seat air-conditioning device 201d according to Variation 4 of Embodiment 2 is described with reference to FIG. 34 and FIG. 35. In Variation 4, an example in which second outlets 222 are provided in the lateral sides of seating portion 11 and air is blown out forward from second outlets 222 is described.

Vehicle seat air-conditioning device 201d includes seat 10 and ventilation path selection switch device 2 that selects a ventilation path through which air passes. Vehicle seat air-conditioning device 201d includes blower 31, controller 32, power supply 33, and driver 34.

FIG. 34 is a view from the back of vehicle seat air-conditioning device 201d. FIG. 35 is a view from the side of vehicle seat air-conditioning device 201d.

Inlets 20, first outlets 221, and second outlet 222 are provided in seat 10.

Inlets 20 are suction ports in seat backrest 13 and are the same as those in the present embodiment. First outlets 221 are the same as those in the present embodiment. Second outlets 222 are provided in the two lateral sides of seating portion 11 (refer to FIG. 34).

Inlet ventilation path 40 is an airway that connects inlets 20 in seat backrest 13 and blower 31. Inlet ventilation path 40 is provided between inlets 20 in the front surface of seat backrest 13 and the intake port of blower 31. With the operation of blower 31, inlet ventilation path 40 leads air drawn in from inlets 20 in the vehicle to blower 31.

Blower 31 is a device for intake and emission of air. Blower 31 is provided in seat backrest 13. An intake port of blower 31 is connected to inlet ventilation path 40, and an exhaust port of blower 31 is connected to switch 70. Blower 31 draws in air via inlet ventilation path 40, and sends out the air drawn in to switch 70.

Switch 70 is a switching valve that switches the destination of air sent out from blower 31 to first duct 251 or to second duct 252. Switch 70 is provided between the exhaust port of blower 31 and first duct 251 and between the exhaust port of blower 31 and second duct 252.

In vehicle seat air-conditioning device 201d, controller 32 causes driver 34 of switch 70 to operate to switch the destination of air sent out by blower 31 between first duct 251 and second duct 252.

First duct 251 is the same as that in the present embodiment.

Second duct 252 is an airway that connects switch 70 and second outlet 222. One end of second duct 252 that is the root is connected to switch 70 and other ends thereof that are the tips are connected to second outlets 222. Second duct 252 extends along a side surface closer to the outside of the vehicle among two side surfaces of seat backrest 13, from the upper portion of seat backrest 13 to the lower portion thereof and branches at a point, and branched portions of second duct 252 extend along the two lateral surfaces of seat 10. Second duct 252 is formed of a tubular pipe so that seat backrest 13 can recline. Second duct 252 leads air sent out from blower 31 via switch 70 to second outlets 222. Second outlets 222 include ends in a nozzle shape. Second outlets 222 are provided in such a manner that the ends of the nozzles are flush with the front surface of seat backrest 13 or are in positions further rearward than the front surface of seat backrest 13.

Through second duct 252, air sent out from blower 31 via switch 70 is blown out from each second outlet 222 in a direction different from a rearward direction of seat 10. Through second duct 252 in this example, air sent out from blower 31 via switch 70 is blown out from second outlets 222 forward. The air blown out forward from the two lateral sides of seating portion 11 pass by the two lateral sides of seating portion 11 to avoid the air being blown directly onto legs of a person in a front seat.

As described above, vehicle seat air-conditioning device 201d includes blower 31, inlet ventilation path 40, first duct 251, second duct 252, and switch 70. Through first duct 251, air sent out from blower 31 via switch 70 is blown out in at least one of a forward direction or an obliquely forward direction of seat 10 from first outlets 221. Through second duct 252, air sent out from blower 31 via switch 70 is blown out from each second outlet 222 in a direction different from a rearward direction of seat 10.

Since vehicle seat air-conditioning device 201d includes switch 70 as described above, the direction in which air is blown out can be switched according to the environment inside the vehicle. Accordingly, for example, air warmed by passing through the inside of seat 10 in an initial operation stage in which cooling is insufficient can be blown out from second outlets 222 located on the lateral sides of seating portion 11 in directions different from the rearward direction of seat 10. Accordingly, it is possible to reduce discomfort given to a person in a front seat of the vehicle and to a person in a rear seat thereof.

Furthermore, since second outlets 222 are in a nozzle shape and provided in directions toward the two lateral surfaces of seating portion 11, air blown out from second outlets 222 can be blown into spaces between a door/a center console and the lateral sides of the seat. Accordingly, dust and dirt that have accumulated in the spaces can be pushed out toward the front portion of the vehicle. Since second outlets 222 are in a nozzle shape, the air volume can be increased due to the ejector effect so that dust and dirt can be pushed out efficiently. Air may be periodically blown in from second outlets 222 not only in the initial cooling stage but also in a stable cooling stage, or air may be blown in from second outlets 222 during heating.

### [Operational Effects]

Next, operational effects yielded by vehicle seat air-conditioning devices 1, 1a, 1b, 1c, 1d, 1e, and 1f according to an embodiment of the present application are described.

However, the vehicle seat air-conditioning device according to PTL 1 merely switches between two patterns of blowing cool air from the air-conditioning control system (Heating, Ventilation and Air Conditioning (HVAC) system) onto the neck and therearound and onto the back of a person seated in a seat. In this case, it is necessary to always provide cool air from the air-conditioning control system through a duct, for instance, which results in problems that the vehicle seat air-conditioning device becomes more complicated and the cost for manufacturing vehicle seat air-conditioning devices rises.

In view of this, as described above, vehicle seat air-conditioning devices 1, 1a, 1b, 1c, 1d, 1e, and 1f of technique 1 according to the embodiment of the present application are each to be disposed in a vehicle, for use in seat 10 that includes seat backrest 13 and seating portion 11, vehicle seat air-conditioning devices 1, 1a, 1b, 1c, 1d, 1e, and if each including: blower 31; first ventilation path 51a to be connected to first vent hole 21 provided in a front surface of seat backrest 13 that faces a person seated in seat 10; second ventilation path 52a to be connected to second vent hole 22 provided in a front surface of seat 10 that faces a person seated in seat 10, second ventilation path 52a being different from first ventilation path 51a; and a ventilation path switch that selects, from among the first ventilation path and the second ventilation path, a ventilation path through which air led by blower 31 is drawn in and a ventilation path through which air is blown out. The ventilation path switch has: a first mode in which air drawn in by blower 31 from first vent hole 21 is led to first ventilation path 51a; and a second mode in which air drawn in by blower 31 from second vent hole 22 is led to second ventilation path 52a, and when a mode is selected between the first mode and the second mode, the ventilation path switch performs switching to the mode selected.

According to this, air can be drawn in from the front surface of seat 10 by providing first vent holes 21 and second vent holes 22. Accordingly, according to the embodiment of the present application, it is unnecessary to supply air from an air-conditioning control system of the vehicle through a duct, for instance, or unnecessary to dispose a duct or to provide a vehicle seat air-conditioning device with a structure for connecting to the duct, which are required with conventional technology.

Thus, according to such vehicle seat air-conditioning devices 1, 1a, 1b, 1c, 1d, 1e, and 1f, structural complexity can be reduced and an increase in manufacturing cost can be reduced.

Note that since air drawn in is blown out from at least one of first vent hole 21 or second vent hole 22, the air can be blown out onto a person, so that the body of the person can be expected to be cooled.

Vehicle seat air-conditioning devices 1, 1a, 1b, 1c, 1d, 1e, and 1f of technique 2 according to an embodiment of the present application are vehicle seat air-conditioning devices 1, 1a, 1b, 1c, 1d, 1e, and 1f stated in technique 1. In this case, first vent hole 21 to be connected to first ventilation path 51a and second vent hole 22 to be connected to second ventilation path 52a are provided in seat 10, and second vent hole 22 is provided below first vent hole 21 in a vertical direction.

According to this, for example, first vent hole 21 can be provided in a position close to the upper body of a person seated in seat 10, and second vent hole 22 can be provided in a position close to the back of a person seated in seat 10. Accordingly, air flows can be created for the upper body of a person and the back of the person. As a result, the body of the person can be cooled.

According to the embodiment of the present application, first vent hole 21 is provided for the upper body of a person and second vent hole 22 is provided for the back of a person, and thus, for example, the size of the vehicle seat air-conditioning device is less likely to increase since such an increase is caused by ducts being connected to the first vent hole and the second vent hole and the lengths of the flow paths up to the upper body and the back of a person increasing.

Vehicle seat air-conditioning devices 1, 1a, 1b, 1c, 1d, 1e, and 1f of technique 3 according to an embodiment of the present application are vehicle seat air-conditioning devices 1, 1a, 1b, 1c, 1d, 1e, and 1f stated in technique 2. In this case, seat backrest 13 included in seat 10 is a backrest against which a person seated in seat 10 leans, and first vent hole 21 is provided in an upper portion of seat backrest 13.

According to this, for example, first vent hole 21 can be provided in a position in particular for the area from the shoulder(s) to the neck of the upper body of a person seated in seat 10, and second vent hole 22 can be provided in a position close to the back of a person seated in seat 10. Accordingly, flows of air can be created for the area from the shoulder(s) to the neck of a person and the back of the person that are sensitive to a change in temperature. As a result, the body of a person can be more efficiency cooled.

Vehicle seat air-conditioning devices 1a, 1c, 1e, and 1f of technique 4 according to an embodiment of the present application are vehicle seat air-conditioning devices 1a, 1c, 1e, and 1f stated in technique 2. In this case, seat backrest 13 included in seat 10 is a backrest against which a person seated in seat 10 leans, and seating portion 11 included in seat 10 is a portion on which a person sits, first vent hole 21 is provided in an upper portion of seat backrest 13, and a plurality of second vent holes 22 are provided in seat backrest 13 and seating portion 11, the plurality of second vent holes 22 each being second vent hole 22.

According to this, for example, first vent hole 21 can be provided in a position for the upper body of a person seated in seat 10, and second vent hole 22 can be provided in a position for the back, the buttocks, and the thighs of a person seated in seat 10. Accordingly, flows of air can be created for the upper body, the back, the buttocks, and the thighs of a person. As a result, the body of a person can be cooled.

Vehicle seat air-conditioning devices 1, 1a, 1b, and 1c of technique 5 according to an embodiment of the present application are vehicle seat air-conditioning devices 1, 1a, 1b, and 1c stated in any one of techniques 1 to 4. In this case, in the first mode, air drawn in by blower 31 from first vent hole 21 is led to first ventilation path 51a and blown out from second vent hole 22 via second ventilation path 52a, and in the second mode, air drawn in by blower 31 from second vent hole 22 is led to second ventilation path 52a and blown out from first vent hole 21 via first ventilation path 51a.

According to this, the first mode and the second mode can be executed using a simple structure in which first movable plate 61 and second movable plate 62 are used. Accordingly, complexity of vehicle seat air-conditioning devices 1, 1a, 1b, and 1c can be reduced.

Vehicle seat air-conditioning devices 1b and 1c of technique 6 according to an embodiment of the present application are vehicle seat air-conditioning devices 1b and 1c stated in any one of techniques 1 to 5 that each further include: valve 36, and in which blower 31 includes first blower 31a and second blower 31b, a plurality of second vent holes 22 include front-surface vent hole 22a provided in the front surface of seat 10 and other-surface vent hole 22b provided in a surface of seat 10 other than the front surface, the plurality of second vent holes 22 each being second vent hole 22, valve 36 is switched between a first connected state in which air passes through front-surface vent hole 22a, a second connected state in which air is drawn in from other-surface vent hole 22b, and a third connected state in which air is drawn in from front-surface vent hole 22a and other-surface vent hole 22b, in the first mode, air drawn in by first blower 31a from first vent hole 21 is led to first ventilation path 51a and blown out from second vent hole 22 via second ventilation path 52a, and in the second mode, when valve 36 is in the first connected state, air drawn in by first blower 31a from front-surface vent hole 22a is led to second ventilation path 52a, and the air led to second ventilation path 52a is blown out by first blower 31a from first vent hole 21 via first ventilation path 51a, when valve 36 is in the second connected state, air drawn in by second blower 31b from other-surface vent hole 22b is led to second ventilation path 52a, and the air led to second ventilation path 52a is blown out by first blower 31a from first vent hole 21 via first ventilation path 51a, and when valve 36 is in the third connected state, air drawn in by second blower 31b from other-surface vent hole 22b is led to second ventilation path 52a while air drawn in by first blower 31a from front-surface vent hole 22a is being led to second ventilation path 52a, and the air led to second ventilation path 52a is blown out by first blower 31a from first vent hole 21 via first ventilation path 51a.

According to this, first vent hole 21 can be provided in a position close to the upper body of a person seated in seat 10, and second vent hole 22 (front-surface vent hole 22a) can be provided in a position close to the back of a person seated in seat 10.

For example, in the first mode, a person can feel a flow of air drawn into first vent hole 21 on the upper body of the person, and at the same time, can feel a flow of air blown out from second vent hole 22 on the back of the person. In the second mode, a person can feel, on the back of the person, a flow of air being drawn in from front-surface vent hole 22a, from other-surface vent hole 22b, or from both the holes and blown out from first vent hole 21. As a result, the body of a person can be cooled by switching between the air volumes according to the temperature in the cabin and the elapsed time, for example.

When second vent hole 22 (front-surface vent hole 22a) is provided in seating portion 11 of vehicle seat air-conditioning device 1c, first vent hole 21 can be provided in a position close to the upper body of a person seated in seat 10, and front-surface vent holes 22a can be provided in positions close to the back, the buttocks, the thighs of the person seated in seat 10. In this case, in the second mode, a person can feel, on the back, the buttocks, and the thighs, flows of air being drawn in from front-surface vent hole 22a, from other-surface vent hole 22b, or from both the holes and blown out from first vent hole 21. As a result, the body of a person and also seating portion 11 can be cooled by switching between the air volumes according to the temperature in the cabin and the elapsed time, for example.

Vehicle seat air-conditioning device 1d of technique 7 according to an embodiment of the present application is vehicle seat air-conditioning device 1d stated in any one of techniques 1 to 4. In this case, a plurality of second vent holes 22 include front-surface vent hole 22a provided in the front surface of seat 10 and other-surface vent hole 22b provided in a surface of seat 10 other than the front surface, the plurality of second vent holes 22 each being second vent hole 22. Second ventilation path 52a includes front-surface side ventilation path 122a to be connected to front-surface vent hole 22a and other-surface side ventilation path 122b to be connected to other-surface vent hole 22b. In the first mode, air drawn in by blower 31 from first vent hole 21 is led to first ventilation path 51a and blown out from front-surface vent hole 22a via front-surface side ventilation path 122a, and in the second mode, air drawn in by blower 31 from other-surface vent hole 22b is led to other-surface side ventilation path 122b, and the air led to other-surface side ventilation path 122b is blown out by blower 31 from front-surface vent hole 22a via front-surface side ventilation path 122a while being blown out by blower 31 from first vent hole 21 via first ventilation path 51a.

According to this, first vent hole 21 can be provided in a position close to the upper body of a person seated in seat 10, and second vent hole 22 can be provided in a position close to the back of a person seated in seat 10.

For example, in the first mode, a person can feel a flow of air drawn into first vent hole 21 on the upper body of the person, and at the same time, can feel a flow of air blown out from second vent hole 22 on the back of the person. In the second mode, a person can feel flows of air being blown out from first vent hole 21 and second vent hole 22 onto the upper body and the back of the person. As a result, the body of the person can be cooled.

Vehicle seat air-conditioning device 1e of technique 8 according to an embodiment of the present application is vehicle seat air-conditioning device 1e stated in any one of techniques 1 to 4. In this case, blower 31 includes first blower 31a and second blower 31b, a plurality of second vent holes 22 include front-surface vent hole 22a provided in the front surface of seat 10 and other-surface vent hole 22b provided in a surface of seat 10 other than the front surface, the plurality of second vent holes 22 each being second vent hole 22, and second ventilation path 52a includes front-surface side ventilation path 122a to be connected to front-surface vent hole 22a and other-surface side ventilation path 122b to be connected to other-surface vent hole 22b. In the first mode, air drawn in by first blower 31a from first vent hole 21 is led to first ventilation path 51a and blown out from front-surface vent hole 22a via front-surface side ventilation path 122a, and in the second mode, air drawn in by second blower 31b from other-surface vent hole 22b is led to other-surface side ventilation path 122b, and the air led to other-surface side ventilation path 122b is blown out by first blower 31a from front-surface vent hole 22a via front-surface side ventilation path 122a while being blown out by first blower 31a from first vent hole 21 via first ventilation path 51a.

According to this, first vent hole 21 can be provided in a position close to the upper body of a person seated in seat 10, and second vent holes 22 can be provided in positions close to the back, the buttocks, and the thighs of the person seated in seat 10.

For example, in the first mode, a person can feel a flow of air drawn into first vent hole 21 on the upper body of the person, and at the same time, can feel a flow of air blown out from second vent hole 22 on the upper body of the person. In the second mode, a person can feel air being blown out from first vent hole 21 and second vent holes 22 onto the upper body, the back, the buttocks, and the thighs of the person. As a result, the body of the person can be cooled.

Vehicle seat air-conditioning device 1f of technique 9 according to an embodiment of the present application is vehicle seat air-conditioning device 1f stated in any one of techniques 1 to 4. In this case, valve 36 is provided. Blower 31 includes first blower 31a and second blower 31b, a plurality of second vent holes 22 include backrest vent hole 22a1 provided in the front surface of seat backrest 13, seating-surface vent hole 22a2 provided in a front surface of seating portion 11, and other-surface vent hole 22b provided in a surface of seat 10 other than the front surface, the plurality of second vent holes 22 each being second vent hole 22. Second ventilation path 52a includes backrest ventilation path 122a1 to be connected to backrest vent hole 22a1, seating-portion ventilation path 122a2 to be connected to seating-surface vent hole 22a2, and other-surface side ventilation path 122b to be connected to other-surface vent hole 22b. Valve 36 is switched between a fourth connected state in which air is drawn in from first vent hole 21, a fifth connected state in which air is drawn in from seating-surface vent hole 22a2, a sixth connected state in which air is drawn in from other-surface vent hole 22b, and a seventh connected state in which air is drawn in from seating-surface vent hole 22a2 and other-surface vent hole 22b. In the first mode, when valve 36 is in the fourth connected state, air drawn in by first blower 31a from first vent hole 21 is led to first ventilation path 51a and blown out from backrest vent hole 22a1 via backrest ventilation path 122a1, and in the second mode, when valve 36 is in the fifth connected state, air drawn in by first blower 31a from seating-surface vent hole 22a2 is led to seating-portion ventilation path 122a2, and the air led to seating-portion ventilation path 122a2 is blown out by first blower 31a from backrest vent hole 22a1 via backrest ventilation path 122a1 while being blown out by first blower 31a from first vent hole 21 via first ventilation path 51a, when valve 36 is in the sixth connected state, air drawn in by second blower 31b from other-surface vent hole 22b is led to other-surface side ventilation path 122b, and the air led to other-surface side ventilation path 122b is blown out by first blower 31a from backrest vent hole 22a1 via backrest ventilation path 122a1 while being blown out by first blower 31a from first vent hole 21 via first ventilation path 51a, and when valve 36 is in the seventh connected state, air drawn in by second blower 31b from other-surface vent hole 22b is led to other-surface side ventilation path 122b while air drawn in by first blower 31a from seating-surface vent hole 22a2 is being led to seating-portion ventilation path 122a2, and the air led to seating-portion ventilation path 122a2 and the air led to other-surface side ventilation path 122b are blown out by first blower 31a from backrest vent hole 22a1 via backrest ventilation path 122a1 while being blown out by first blower 31a from first vent hole 21 via first ventilation path 51a.

According to this, first vent hole 21 can be provided in a position close to the upper body of a person seated in seat 10, backrest vent hole 22a1 can be provided in a position close to the back of a person seated in seat 10, and seating-surface vent holes 22a2 can be provided in positions close to the buttocks and the thighs of the person.

For example, in the first mode, a person can feel a flow of air drawn into first vent hole 21 on the upper body of the person, and at the same time, can feel a flow of air blown out from second vent hole 22 on the upper body of the person.

When air is drawn in from other-surface vent hole 22b, in the second mode, a person can feel air blown out from first vent hole 21 and backrest vent hole 22a1 and blown onto the upper body and the back of a person.

When air is sucked in from seating-surface vent holes 22a2, in the second mode, a person can feel flows of air drawn into seating-surface vent holes 22a2 on the buttocks and the thighs, and can feel flows of air being blown out from first vent hole 21 and backrest vent hole 22a1 onto the upper body and the back of the person. As a result, the body of the person can be cooled.

Vehicle seat air-conditioning devices 1, 1a, 1b, 1c, 1d, 1e, and 1f of technique 10 according to an embodiment of the present application are vehicle seat air-conditioning devices 1, 1a, 1b, 1c, 1d, 1e, and 1f stated in any one of techniques 1 to 9. In this case, controller 32 that controls blower 31 and the ventilation path switch is further provided. When controller 32 executes the first mode and a predetermined condition is satisfied, controller 32 switches from the first mode to the second mode and executes the second mode.

According to this, the mode can be automatically switched from the first mode to the second mode by merely setting a predetermined condition. Accordingly, a person does not need to perform any operation on vehicle seat air-conditioning devices 1, 1a, 1b, 1c, 1d, 1e, and 1f, and thus an increase in the amount of processing that vehicle seat air-conditioning devices 1, 1a, 1b, 1c, 1d, 1e, and 1f receive from the person and an increase in the amount of communication in the vehicle can be reduced, and at the same time, the person is less likely to feel troublesome.

Vehicle seat air-conditioning devices 1, 1a, 1b, 1c, 1d, 1e, and 1f of technique 11 according to an embodiment of the present application are vehicle seat air-conditioning devices 1, 1a, 1b, 1c, 1d, 1e, and 1f stated in technique 10. In this case, when the predetermined condition is satisfied is when a predetermined time has elapsed.

According to this, the mode can be automatically switched from the first mode to the second mode by merely setting a predetermined time. Accordingly, a person does not need to perform any operation on vehicle seat air-conditioning devices 1, 1a, 1b, 1c, 1d, 1e, and 1f, and thus an increase in the amount of processing that vehicle seat air-conditioning devices 1, 1a, 1b, 1c, 1d, 1e, and 1f receive from a person and an increase in the amount of communication in the vehicle can be reduced, and at the same time, the person is less likely to feel troublesome.

Vehicle seat air-conditioning devices 1, 1a, 1b, 1c, 1d, 1e, and 1f of technique 12 according to an embodiment of the present application are vehicle seat air-conditioning devices 1, 1a, 1b, 1c, 1d, 1e, and 1f stated in technique 10. In this case, when the predetermined condition is satisfied is when a temperature in a cabin of the vehicle has decreased.

According to this, the mode can be automatically switched from the first mode to the second mode by merely setting a predetermined time. Accordingly, a person does not need to perform any operation on vehicle seat air-conditioning devices 1, 1a, 1b, 1c, 1d, 1e, and 1f, and thus an increase in the amount of processing that vehicle seat air-conditioning devices 1, 1a, 1b, 1c, 1d, 1e, and 1f receive from a person and an increase in the amount of communication in the vehicle can be reduced, and at the same time, the person is less likely to feel troublesome.

With conventional technology, when a blow-out side switch door and a draw-in side switch door are in a first mode position, a seat blow-out opening and a conditioned air draw-in opening are closed. Thus, a flow path downstream of the seat blow-out opening in the blow-out side switch door is not used, and a flow path downstream of the conditioned air draw-in opening in the draw-in side switch door is not used either. When the doors are in a second mode position, a blow-out opening and a seat draw-in opening are closed. Thus, a flow path downstream of the blow-out opening in the blow-out side switch door is not used, and a flow downstream of the seat draw-in opening in the draw-in side switch door is not used either. Accordingly, flow paths that are not used are included due to switching of the modes in the seat air-conditioning device according to PTL 1. Furthermore, the seat blow-out opening, the seat draw-in opening, the conditioned air draw-in opening, and the blow-out opening are provided below a second case, but ducts connected to the openings are disposed all together. When such a seat air-conditioning device is applied to a seat of a vehicle, a problem arises that it is hard to apply the seat air-conditioning device to the seat of the vehicle since the size of the seat increases.

In view of this, ventilation path selection switch device 2 of technique 13 according to an embodiment of the present application is ventilation path selection switch device 2 provided in vehicle seat air-conditioning device 1 disposed in a vehicle, for use in seat 10, and includes: inlet ventilation path 53a to which air drawn by blower 31 is led; outlet ventilation path 54a through which the air drawn in by blower 31 and led through inlet ventilation path 53a is blown out; first ventilation path 51a connected to inlet ventilation path 53a and outlet ventilation path 54a; second ventilation path 52a different from first ventilation path 51a and connected to inlet ventilation path 53a and outlet ventilation path 54a; and a ventilation path switch. The ventilation path switch has: a first mode in which air drawn in by blower 31 through first ventilation path 51a is led to inlet ventilation path 53a and the air led to outlet ventilation path 54a by blower 31 is led to second ventilation path 52a; and a second mode in which air drawn in through second ventilation path 52a by blower 31 is led to inlet ventilation path 53a, and air led to outlet ventilation path 54a by blower 31 is led to first ventilation path 51a. When a mode is selected between the first mode and the second mode, the ventilation path switch performs switching to the mode selected.

According to this, air always passes through first ventilation path 51a and second ventilation path 52a both in the first mode and the second mode. Furthermore, air always passes through inlet ventilation path 53a and outlet ventilation path 54a both in the first mode and the second mode. All the ventilation paths are always used in ventilation path selection switch device 2 no matter which mode is executed, and thus usage efficiency of the ventilation paths is high. As compared to a conventional seat air-conditioning device in which ventilation paths that are not used are present so that more ventilation paths are provided, no matter which mode is executed, ventilation paths that are not used are less in the embodiment of the present application.

Thus, according to such ventilation path selection switch device 2, an increase in size can be reduced.

In particular, as compared with a case in which ducts are provided in four openings as with the conventional example, in the embodiment of the present application, air is drawn in and blown out merely through first ventilation path 51a and second ventilation path 52a, and thus ventilation path selection switch device 2 can be highly readily provided in seat 10 for a vehicle.

Ventilation path selection switch device 2 of technique 14 according to an embodiment of the present application is ventilation path selection switch device 2 of technique 13. In this case, the ventilation path switch includes first movable plate 61 and second movable plate 62, first movable plate 61 is disposed to close and open a flow path that connects outlet ventilation path 54a and first ventilation path 51a, and second movable plate 62 is disposed to close and open a flow path that connects inlet ventilation path 53a and second ventilation path 52a.

According to this, flow paths can be switched using first movable plate 61 and second movable plate 62, and thus all the ventilation paths can be always used in ventilation path selection switch device 2 no matter which mode is executed. Since an increase in the number of ventilation paths can be reduced, ventilation path selection switch device 2 according to the embodiment of the present application can be reduced.

The first mode and the second mode can be switched using a simple structure in which first movable plate 61 and second movable plate 62 are used. Accordingly, complexity of ventilation path selection switch device 2 can be reduced.

Ventilation path selection switch device 2 of technique 15 according to an embodiment of the present application is ventilation path selection switch device 2 of technique 14. In this case, in the first mode, second movable plate 62 opens a flow path from first ventilation path 51a to inlet ventilation path 53a while closing the flow path from second ventilation path 52a to inlet ventilation path 53a, and first movable plate 61 opens a flow path from outlet ventilation path 54a to second ventilation path 52a while closing the flow path from outlet ventilation path 54a to first ventilation path 51a.

According to this, the first mode can be executed using a simple structure in which first movable plate 61 and second movable plate 62 are used. Accordingly, complexity of ventilation path selection switch device 2 can be reduced.

Ventilation path selection switch device 2 of technique 16 according to an embodiment of the present application is ventilation path selection switch device 2 of technique 14 or 15. In this case, in the second mode, second movable plate 62 opens the flow path from second ventilation path 52a to inlet ventilation path 53a while closing a flow path from first ventilation path 51a to inlet ventilation path 53a, and first movable plate 61 opens the flow path from outlet ventilation path 54a to first ventilation path 51a while closing a flow path from outlet ventilation path 54a to second ventilation path 52a.

According to this, the second mode can be executed using a simple structure in which first movable plate 61 and second movable plate 62 are used. Accordingly, complexity of ventilation path selection switch device 2 can be reduced.

Ventilation path selection switch device 2 of technique 17 according to an embodiment of the present application is ventilation path selection switch device 2 of any one of techniques 14 to 16. In this case, a drive mechanism is further provided, the drive mechanism including: first gear 61c that rotates first movable plate 61; second gear 62c that rotates second movable plate 62 by meshing with first gear 61c; and driver 34 that rotates first gear 61c and second gear 62c in conjunction with each other.

According to this, first movable plate 61 and second movable plate 62 rotate in conjunction with each other, and thus the first mode and the second mode can be readily switched.

Furthermore, a motor for driving first movable plate 61 and a motor for driving second movable plate 62 do not need to be separately provided, and thus an increase in the size of ventilation path selection switch device 2 can be reduced.

Ventilation path selection switch device 2 of technique 18 according to an embodiment of the present application is ventilation path selection switch device 2 of technique 17. In this case, first gear 61c and second gear 62c are disposed in space S between inlet ventilation path 53a and outlet ventilation path 54a, and on a peripheral side of first gear 61c or second gear 62c, inlet ventilation path 53a expands into space S, inlet ventilation path 53a approaching outlet ventilation path 54a, or outlet ventilation path 54a expands into space S, outlet ventilation path 54a approaching inlet ventilation path 53a.

According to this, space S between inlet ventilation path 53a and outlet ventilation path 54a can be reduced, and thus an object such as dust can be prevented from entering space S from behind seat 10. As a result, a decrease in reliability in ventilation path selection switch device 2 can be reduced.

Ventilation path selection switch device 2 of technique 19 according to an embodiment of the present application is ventilation path selection switch device 2 of any one of techniques 13 to 18. In this case, seat 10 includes first opening 41 connected to first ventilation path 51a and second opening 42 connected to second ventilation path 52a, and second opening 42 is provided below first opening 41 in the vertical direction.

According to this, for example, first opening 41 can be provided in a position close to the upper body of a person seated in seat 10, and second opening 42 can be provided in a position close to the back of a person seated in seat 10. Accordingly, flows of air can be created for the upper body and the back of a person. As a result, the body of the person can be cooled.

According to the present disclosure, first opening 41 is provided for the upper body of a person and second opening 42 is provided for the back of a person, and thus, for example, the size of ventilation path selection switch device 2 is less likely to increase due to the lengths of the flow paths through ducts up to the upper body and the back of a person being elongated when the ducts are connected to first opening 41 and second opening 42.

Ventilation path selection switch device 2 of technique 20 according to an embodiment of the present application is ventilation path selection switch device 2 of technique 19. In this case, seat backrest 13 included in seat 10 is a backrest against which a person seated in seat 10 leans, and first opening 41 is provided in an upper portion of seat backrest 13.

According to this, for example, first opening 41 can be provided in a position for the upper body of a person seated in seat 10, and second opening 42 can be provided in a position close to the back of a person seated in seat 10. Accordingly, flows of air can be created for the upper body and the back of a person. As a result, the body of the person can be cooled.

Ventilation path selection switch device 2 of technique 21 according to an embodiment of the present application is ventilation path selection switch device 2 of technique 19. In this case, seat 10 includes seat backrest 13 against which a person seated in seat 10 leans, and seating portion 11 that is a portion on which a person seated in seat 10 sits, first opening 41 is provided in an upper portion of seat backrest 13, and second opening 42 is provided in seat backrest 13 and seating portion 11. Note that in the embodiments, as illustrated in FIG. 1B, for example, second opening 42 reaches seating portion 11 via second seat ventilation path 122, but also in the case of such a configuration, second opening 42 is defined to be provided in seating portion 11.

According to this, for example, first opening 41 can be provided in a position for the upper body of a person seated in seat 10, and second opening 42 can be provided in a position for the back, the buttocks, and the thighs of a person seated in seat 10. Accordingly, flows of air can be created for the upper body, the back, the buttocks, and the thighs of a person. As a result, the body of the person can be cooled.

Vehicle seat air-conditioning devices 1 to 1f of technique 22 according to an embodiment of the present application each include ventilation path selection switch device 2 stated in any one of techniques 13 to 21, blower 31, controller 32 that controls operation of blower 31 and controls operation of the ventilation path switch, and seat 10 that includes ventilation path selection switch device 2 and blower 31.

Such vehicle seat air-conditioning devices 1 to 1f yield similar operational effects as described above.

A conventional seat air-conditioning device may blow out air warmed by passing through the inside of a seat in an initial operation stage when cooling is not sufficient and give discomfort to a person seated in the seat. In order to address this, by blowing out air from behind the seat, for example, it is possible to reduce discomfort given to a person seated in a front seat. However, since warmed air is blown out to the back side of the seat, discomfort may be given to a person seated in a rear seat.

Vehicle seat air-conditioning device 201, 201a, 201b, 201c, and 201d according to Example 1 are vehicle seat air-conditioning devices each disposed in a vehicle for use in seat 10 that includes seat backrest 13 and seating portion 11, and each include: blower 31; inlet ventilation path 40 that leads air inside the vehicle drawn in from inlets 20 to blower 31 by the operation of blower 31; first duct 251 that leads air sent out from blower 31 to first outlets 221 located at least one of the front surface or the upper surface of seat backrest 13; second duct 252 that leads air sent out from blower 31 to second outlet 222 located rearward than the back surface of seat backrest 13 or seating portion 11 or the lateral side of seating portion 11; and switch 70 that switches the destination of air blown out from blower 31 between first duct 251 and second duct 252. Through first duct 251, air sent out from blower 31 via switch 70 is blown out in at least one of a forward direction or an obliquely forward direction of seat 10 from first outlets 221. Through second duct 252, air sent out from blower 31 via switch 70 is blown out from second outlet 222 in a direction different from a rearward direction of seat 10.

As described above, since the vehicle seat air-conditioning devices each include switch 70 as stated above, the direction in which air is blown out can be switched according to the environment inside the vehicle. Accordingly, for example, air warmed by passing through the inside of seat 10 in an initial operation stage in which cooling is insufficient can be blown out from second outlets 222 in a direction in which nobody is present. Accordingly, it is possible to reduce discomfort given to a person in a front seat of the vehicle and to a person in a rear seat thereof.

Vehicle seat air-conditioning devices 201, 201a, 201b, and 201c according to Example 2 are the vehicle seat air-conditioning devices stated in Example 1, and second outlet 222 may be located rearward than the back surface of seat backrest 13 or seating portion 11, and air may be blown out downward through second duct 252 from second outlet(s) 222.

According to this, for example, air warmed by passing through the inside of seat 10 in an initial operation stage in which cooling is insufficient can be blown out downward from second outlet(s) 222. Accordingly, it is possible to reduce discomfort given to a person in a front seat of the vehicle and to a person in a rear seat thereof.

A vehicle seat air-conditioning device according to Example 3 is the vehicle seat air-conditioning device according to Example 1 or 2, and first outlet 221 may be provided in an upper portion of seat backrest 13, and second outlet 222 may be provided in a lower position than first outlet 221.

According to this, for example, air warmed by passing through the inside of seat 10 in an initial operation stage in which cooling is insufficient can be blown out from second outlet 222 provided in a lower position than first outlet 221. Accordingly, it is possible to reduce discomfort given to a person in a front seat of the vehicle and to a person in a rear seat thereof.

A vehicle seat air-conditioning device according to Example 4 is the vehicle seat air-conditioning device according to any one of Examples 1 to 3, and first outlet 221 may be provided in an upper portion of seat backrest 13, and second outlet 222 may be provided in a position lower than the upper surface of seating portion 11.

According to this, for example, air warmed by passing through the inside of seat 10 in an initial operation stage in which cooling is insufficient can be blown out from second outlet 222 provided in a position lower than the upper surface of seating portion 11. Accordingly, it is possible to reduce discomfort given to a person in a front seat of the vehicle and to a person in a rear seat thereof.

A vehicle seat air-conditioning devices according to Example 5 are the vehicle seat air-conditioning devices according to any one of Examples 1 to 4, and inlet 20 may be located lower than first outlet 221 in at least one of seat backrest 13 or seating portion 11.

According to this, air in the vehicle can be drawn in from inlet 20, and the air drawn in can be blown out from first outlet 221 provided above inlet 20 via first duct 251. Accordingly, seat 10 can be cooled immediately, and air can be prevented from being warmed by passing through the inside of seat 10. Accordingly, it is possible to reduce discomfort given to a person in a front seat of the vehicle and to a person in a rear seat thereof.

A vehicle seat air-conditioning device according to Example 6 is the vehicle seat air-conditioning device according to any one of Examples 1 to 5, and each further include controller 32 that controls switch 70 and blower 31. The vehicle seat air-conditioning devices each have first mode m1 in which air is blown out from first outlet 221 via first duct 251 and second mode m2 in which air is blown out from second outlet 222 via second duct 252. Controller 32 may control switch 70 to switch between first mode m1 and second mode m2.

According to this, first mode m1 and second mode m2 can be switched according to the environment in the vehicle. Accordingly, in second mode m2, air warmed by passing through the inside of seat 10 in an initial operation stage in which cooling is insufficient can be blown out from second outlet 222 in a direction in which nobody is present. Accordingly, it is possible to reduce discomfort given to a person in a front seat of the vehicle and to a person in a rear seat thereof.

A vehicle seat air-conditioning device according to Example 7 is the vehicle seat air-conditioning device according to Example 6, and switch 70 may include movable plate 71 that opens and closes first duct 251 and second duct 252, and controller 32 may switch between first mode m1 and second mode m2 by moving movable plate 71.

According to this, first mode m1 and second mode m2 can be reliably switched. Accordingly, air warmed by passing through the inside of seat 10 in an initial operation stage in which cooling is insufficient can be blown out from second outlet 222 in a direction in which nobody is present. Accordingly, it is possible to reduce discomfort given to a person in a front seat of the vehicle and to a person in a rear seat thereof.

A vehicle seat air-conditioning device according to Example 8 is the vehicle seat air-conditioning device according to Example 6 or 7, and controller 32 may retract movable plate 71 from the air-sending route along first duct 251 in first mode m1.

According to this, blocking of an air flow in first duct 251 can be reduced. Accordingly, air can be appropriately blown out from first outlet 221. Accordingly, it is possible to reduce discomfort given to a person in a front seat of the vehicle.

A vehicle seat air-conditioning device according to Example 9 is the vehicle seat air-conditioning device according to any one of Examples 6 to 8, and controller 32 may set the mode to second mode m2 when operation of blower 31 starts, and change second mode m2 to first mode m1 after a predetermined time has elapsed from the start of operation of blower 31.

According to this, air passing through the inside of seat 10 in an initial operation stage in which air-conditioning is insufficient can be blown out from second outlet 222 in a direction in which nobody is present. When air-conditioning is sufficient after the elapse of a predetermined time, air sufficiently conditioned can be blown out from first outlet 221. Accordingly, it is possible to reduce discomfort given to a person in a front seat of the vehicle and to a person in a rear seat thereof.

A vehicle seat air-conditioning device according to Example 10 is the vehicle seat air-conditioning device according to any one of Examples 6 to 8, and controller 32 may set the mode to second mode m2 when operation of blower 31 starts, and change second mode m2 to first mode m1 when the temperature inside the vehicle has reached a predetermined temperature after setting the mode to second mode m2.

Accordingly, air passing through the inside of seat 10 in an initial operation stage in which air-conditioning is insufficient can be blown out from second outlet 222 in a direction in which nobody is present. When the temperature reaches the predetermined temperature by sufficient air-conditioning, air sufficiently conditioned can be blown out from first outlet 221. Accordingly, it is possible to reduce discomfort given to a person in a front seat of the vehicle and to a person in a rear seat thereof.

A vehicle seat air-conditioning device according to Example 11 is the vehicle seat air-conditioning device according to any one of Examples 6 to 8, and controller 32 may set the mode to second mode m2 when the temperature inside the vehicle is higher than a first temperature, and change second mode m2 to first mode m1 when the temperature inside the vehicle has become a second temperature, which is lower than the first temperature, or lower after setting the mode to second mode m2.

According to this, air warmed by passing through the inside of seat 10 in an initial operation stage in which cooling is insufficient can be blown out from second outlet 222 in a direction in which nobody is present. When the temperature decreases to the second temperature or lower, air sufficiently conditioned can be blown out from first outlet 221. Accordingly, it is possible to reduce discomfort given to a person in a front seat of the vehicle and to a person in a rear seat thereof.

A vehicle seat air-conditioning device according to Example 12 is the vehicle seat air-conditioning device according to any one of Examples 6 to 11, and controller 32 may control blower 31 to make the air volume in second mode m2 greater than the air volume in first mode m1.

According to this, seat 10 can be cooled immediately. Thus, it is possible to stop, at an early timing, air from being warmed by passing through the inside of seat 10. Accordingly, it is possible to reduce discomfort given to a person in a front seat of the vehicle and to a person in a rear seat thereof.

A vehicle seat air-conditioning device according to Example 13 are the vehicle seat air-conditioning devices according to any one of Examples 6 to 8, and when a person is present in a rear seat behind seat 10, controller 32 may control blower 31 to decrease the amount of air to be blown out from second outlet 222, as compared to the case where no person is present in a rear seat.

As described above, when a person is in a rear seat behind seat 10, it is possible to reduce discomfort given to a person seated in the rear seat of the vehicle by decreasing the amount of air blown out from second outlet 222.

Vehicle seat air-conditioning device 201d according to Example 14 is one of the vehicle seat air-conditioning devices stated in Example 1, and second outlet 222 may be provided in the lateral side of seating portion 11, and air may be blown out forward from second outlet 222 through second duct 252.

According to this, for example, air warmed by passing through the inside of seat 10 in an initial operation stage in which cooling is insufficient can be blown out forward from second outlet 222 in the lateral side of seating portion 11. Accordingly, it is possible to reduce discomfort given to a person in a front seat of the vehicle and to a person in a rear seat thereof. Furthermore, the lateral side of seat 10 can be cleaned.

Vehicle seat air-conditioning device 201d according to Example 15 is one of the vehicle seat air-conditioning devices stated in Example 1, and second outlets 222 may be provided in the two lateral sides of seating portion 11, second duct 252 may lead air sent from blower 31 to second outlets 222 located in the two lateral sides of seating portion 11, and the air may be blown out forward from second outlets 222.

According to this, for example, air warmed by passing through the inside of seat 10 in an initial operation stage in which cooling is insufficient can be blown out forward from second outlets 222 in the lateral sides of seating portion 11. Accordingly, it is possible to reduce discomfort given to a person in a front seat of the vehicle and to a person in a rear seat thereof. Furthermore, the two lateral sides of seat 10 can be cleaned.

### OTHER VARIATIONS, ETC.

The above has described the vehicle seat air-conditioning devices according to the present disclosure based on the embodiments, yet the present disclosure is not limited to these embodiments. The scope of the present disclosure may also encompass embodiments resulting from applying, to the embodiments, various modifications that may be conceived by those skilled in the art, as long as the resultant embodiments do not depart from the scope of the present disclosure.

For example, in the vehicle seat air-conditioning devices according to the above embodiments, a configuration in which warm air inside seat 10 is blown out from second outlet(s) 222 in the initial cooling stage is described, yet a configuration in which cold air inside seat 10 is blown out from second outlet(s) 222 in an initial heating stage may be adopted. Also in this case, it is possible to reduce discomfort given to a person in a front seat of the vehicle and to a person in a rear seat thereof.

The controller included in each vehicle seat air-conditioning device according to the embodiments is implemented as a large scale integration (LSI) circuit that is typically an integrated circuit. These may be each provided as a single chip or may be formed as a single chip to include some or all of these.

Moreover, the way to achieve integration is not limited to LSI, and a dedicated circuit or a general purpose processor can also achieve the integration. A field programmable gate array (FPGA) that can be programmed after an LSI is manufactured or a reconfigurable processor that allows reconfiguration of the connections and settings of the circuit cells inside the LSI circuit may also be used.

Note that in the above embodiments, the controller may be implemented using dedicated hardware, or may be implemented by executing a software program suitable for the element. Each element may be implemented by a program executor such as a CPU or a processor reading and executing a software program recorded on a recording medium such as a hard disk or semiconductor memory.

Split of functional blocks in the block diagrams is an example, and thus a plurality of functional blocks may be implemented as one functional block, one functional block may be split into a plurality of blocks, or some functions may be transferred to another functional block. Single hardware or software may process similar functions of a plurality of functional blocks, in parallel or by time division.

The present disclosure also encompasses embodiments resulting from adding, to the embodiments, various modifications that those skilled in the art conceive, and embodiments implemented by combining elements and functions in the embodiments in any manner without departing from the scope of the present disclosure.

### FURTHER INFORMATION ABOUT TECHNICAL BACKGROUND TO THIS APPLICATION

The disclosures of the following patent applications including specification, drawings, and claims are incorporated herein by reference in their entirety: Japanese Patent Application No. 2024-057157 filed on Mar. 29, 2024, Japanese Patent Application No. 2024-057159 filed on Mar. 29, 2024, and Japanese Patent Application No. 2024-057355 filed on Mar. 29, 2024.

### INDUSTRIAL APPLICABILITY

The present disclosure is applicable to a vehicle seat and a vehicle sofa of a vehicle, for example.

1. A vehicle seat air-conditioning device that is to be disposed in a vehicle, for use in a seat that includes a seat backrest and a seating portion, the vehicle seat air-conditioning device comprising:
a blower;
a first ventilation path to be connected to a first vent hole provided in a front surface of the seat backrest that faces a person seated in the seat;
a second ventilation path to be connected to a second vent hole provided in a front surface of the seat that faces a person seated in the seat, the second ventilation path being different from the first ventilation path; and
a ventilation path switch that selects, from among the first ventilation path and the second ventilation path, a ventilation path through which air led by the blower is drawn in and a ventilation path through which air is blown out,
wherein the ventilation path switch has:
a first mode in which air drawn in by the blower from the first vent hole is led to the first ventilation path; and
a second mode in which air drawn in by the blower from the second vent hole is led to the second ventilation path, and
when a mode is selected between the first mode and the second mode, the ventilation path switch performs switching to the mode selected.

2. The vehicle seat air-conditioning device according to claim 1,
wherein the first vent hole to be connected to the first ventilation path and the second vent hole to be connected to the second ventilation path are provided in the seat, and
the second vent hole is provided below the first vent hole in a vertical direction.

3. The vehicle seat air-conditioning device according to claim 2,
wherein the seat backrest included in the seat is a backrest against which a person seated in the seat leans, and
the first vent hole is provided in an upper portion of the seat backrest.

4. The vehicle seat air-conditioning device according to claim 2,
wherein the seat backrest included in the seat is a backrest against which a person seated in the seat leans, and the seating portion included in the seat is a portion on which a person sits,
the first vent hole is provided in an upper portion of the seat backrest, and
a plurality of second vent holes are provided in the seat backrest and the seating portion, the plurality of second vent holes each being the second vent hole.

5. The vehicle seat air-conditioning device according to claim 1,
wherein in the first mode, air drawn in by the blower from the first vent hole is led to the first ventilation path and blown out from the second vent hole via the second ventilation path, and
in the second mode, air drawn in by the blower from the second vent hole is led to the second ventilation path and blown out from the first vent hole via the first ventilation path.

6. The vehicle seat air-conditioning device according to claim 1, further comprising:
a valve,
wherein the blower includes a first blower and a second blower,
a plurality of second vent holes include a front-surface vent hole provided in the front surface of the seat and an other-surface vent hole provided in a surface of the seat other than the front surface, the plurality of second vent holes each being the second vent hole,
the valve is switched between a first connected state in which air passes through the front-surface vent hole, a second connected state in which air is drawn in from the other-surface vent hole, and a third connected state in which air is drawn in from the front-surface vent hole and the other-surface vent hole,
in the first mode, air drawn in by the first blower from the first vent hole is led to the first ventilation path and blown out from the second vent hole via the second ventilation path, and
in the second mode,
when the valve is in the first connected state, air drawn in by the first blower from the front-surface vent hole is led to the second ventilation path, and the air led to the second ventilation path is blown out by the first blower from the first vent hole via the first ventilation path,
when the valve is in the second connected state, air drawn in by the second blower from the other-surface vent hole is led to the second ventilation path, and the air led to the second ventilation path is blown out by the first blower from the first vent hole via the first ventilation path, and
when the valve is in the third connected state, air drawn in by the second blower from the other-surface vent hole is led to the second ventilation path while air drawn in by the first blower from the front-surface vent hole is being led to the second ventilation path, and the air led to the second ventilation path is blown out by the first blower from the first vent hole via the first ventilation path.

7. The vehicle seat air-conditioning device according to claim 1,
wherein a plurality of second vent holes include a front-surface vent hole provided in the front surface of the seat and an other-surface vent hole provided in a surface of the seat other than the front surface, the plurality of second vent holes each being the second vent hole,
the second ventilation path includes a front-surface side ventilation path to be connected to the front-surface vent hole and an other-surface side ventilation path to be connected to the other-surface vent hole,
in the first mode, air drawn in by the blower from the first vent hole is led to the first ventilation path and blown out from the front-surface vent hole via the front-surface side ventilation path, and
in the second mode, air drawn in by the blower from the other-surface vent hole is led to the other-surface side ventilation path, and the air led to the other-surface side ventilation path is blown out by the blower from the front-surface vent hole via the front-surface side ventilation path while being blown out by the blower from the first vent hole via the first ventilation path.

8. The vehicle seat air-conditioning device according to claim 1,
wherein the blower includes a first blower and a second blower,
a plurality of second vent holes include a front-surface vent hole provided in the front surface of the seat and an other-surface vent hole provided in a surface of the seat other than the front surface, the plurality of second vent holes each being the second vent hole,
the second ventilation path includes a front-surface side ventilation path to be connected to the front-surface vent hole and an other-surface side ventilation path to be connected to the other-surface vent hole,
in the first mode, air drawn in by the first blower from the first vent hole is led to the first ventilation path and blown out from the front-surface vent hole via the front-surface side ventilation path, and
in the second mode, air drawn in by the second blower from the other-surface vent hole is led to the other-surface side ventilation path, and the air led to the other-surface side ventilation path is blown out by the first blower from the front-surface vent hole via the front-surface side ventilation path while being blown out by the first blower from the first vent hole via the first ventilation path.

9. The vehicle seat air-conditioning device according to claim 1, further comprising:
a valve,
wherein the blower includes a first blower and a second blower,
a plurality of second vent holes include a backrest vent hole provided in the front surface of the seat backrest, a seating-surface vent hole provided in a front surface of the seating portion, and an other-surface vent hole provided in a surface of the seat other than the front surface, the plurality of second vent holes each being the second vent hole,
the second ventilation path includes a backrest ventilation path to be connected to the backrest vent hole, a seating-portion ventilation path to be connected to the seating-surface vent hole, and an other-surface side ventilation path to be connected to the other-surface vent hole,
the valve is switched between a fourth connected state in which air is drawn in from the first vent hole, a fifth connected state in which air is drawn in from the seating-surface vent hole, a sixth connected state in which air is drawn in from the other-surface vent hole, and a seventh connected state in which air is drawn in from the seating-surface vent hole and the other-surface vent hole,
in the first mode, when the valve is in the fourth connected state, air drawn in by the first blower from the first vent hole is led to the first ventilation path and blown out from the backrest vent hole via the backrest ventilation path, and
in the second mode,
when the valve is in the fifth connected state, air drawn in by the first blower from the seating-surface vent hole is led to the seating-portion ventilation path, and the air led to the seating-portion ventilation path is blown out by the first blower from the backrest vent hole via the backrest ventilation path while being blown out by the first blower from the first vent hole via the first ventilation path,
when the valve is in the sixth connected state, air drawn in by the second blower from the other-surface vent hole is led to the other-surface side ventilation path, and the air led to the other-surface side ventilation path is blown out by the first blower from the backrest vent hole via the backrest ventilation path while being blown out by the first blower from the first vent hole via the first ventilation path, and
when the valve is in the seventh connected state, air drawn in by the second blower from the other-surface vent hole is led to the other-surface side ventilation path while air drawn in by the first blower from the seating-surface vent hole is being led to the seating-portion ventilation path, and the air led to the seating-portion ventilation path and the air led to the other-surface side ventilation path are blown out by the first blower from the backrest vent hole via the backrest ventilation path while being blown out by the first blower from the first vent hole via the first ventilation path.

10. The vehicle seat air-conditioning device according to claim 1, further comprising:
a controller that controls the blower and the ventilation path switch,
wherein when the controller executes the first mode and a predetermined condition is satisfied, the controller switches from the first mode to the second mode and executes the second mode.

11. The vehicle seat air-conditioning device according to claim 10,
wherein when the predetermined condition is satisfied is when a predetermined time has elapsed.

12. The vehicle seat air-conditioning device according to claim 10,
wherein when the predetermined condition is satisfied is when a temperature in a cabin of the vehicle has decreased.

13. The vehicle seat air-conditioning device according to claim 1,
wherein in the first mode, air drawn in by the blower from a first duct is led to an inlet ventilation path, and air led to an outlet ventilation path is led to a second duct, the outlet ventilation path being a path through which air drawn in by the blower and led through the inlet ventilation path is blown out, and
in the second mode, air drawn in by the blower from the second duct is led to the inlet ventilation path, and air led to the outlet ventilation path by the blower is led to the first duct.

14. The vehicle seat air-conditioning device according to claim 13,
wherein the ventilation path switch includes a first movable plate and a second movable plate,
the first movable plate is disposed to close and open a flow path that connects the outlet ventilation path and the first duct, and
the second movable plate is disposed to close and open a flow path that connects the inlet ventilation path and the second duct.

15. The vehicle seat air-conditioning device according to claim 14,
wherein in the first mode, the second movable plate opens a flow path from the first duct to the inlet ventilation path while closing the flow path from the second duct to the inlet ventilation path, and the first movable plate opens a flow path from the outlet ventilation path to the second duct while closing the flow path from the outlet ventilation path to the first duct.

16. The vehicle seat air-conditioning device according to claim 14,
wherein in the second mode, the second movable plate opens the flow path from the second duct to the inlet ventilation path while closing a flow path from the first duct to the inlet ventilation path, and the first movable plate opens the flow path from the outlet ventilation path to the first duct while closing a flow path from the outlet ventilation path to the second duct.

17. The vehicle seat air-conditioning device according to claim 14, further comprising:
a drive mechanism that includes:
a first gear that rotates the first movable plate;
a second gear that rotates the second movable plate by meshing with the first gear; and
a driver that rotates the first gear and the second gear in conjunction with each other.

18. The vehicle seat air-conditioning device according to claim 15, further comprising:
a drive mechanism that includes:
a first gear that rotates the first movable plate;
a second gear that rotates the second movable plate by meshing with the first gear; and
a driver that rotates the first gear and the second gear in conjunction with each other.

19. The vehicle seat air-conditioning device according to claim 17,
wherein the first gear and the second gear are disposed in a space between the inlet ventilation path and the outlet ventilation path, and
on a peripheral side of the first gear or the second gear,
the inlet ventilation path expands into the space, the inlet ventilation path approaching the outlet ventilation path, or
the outlet ventilation path expands into the space, the outlet ventilation path approaching the inlet ventilation path.

20. The vehicle seat air-conditioning device according to claim 18,
wherein the first gear and the second gear are disposed in a space between the inlet ventilation path and the outlet ventilation path, and
on a peripheral side of the first gear or the second gear,
the inlet ventilation path expands into the space, the inlet ventilation path approaching the outlet ventilation path, or
the outlet ventilation path expands into the space, the outlet ventilation path approaching the inlet ventilation path.
